(19) United States
(12) Patent Application Publication
(10) Pub. No.: US 2006/0165233 A1
(43) Pub. Date: Jul. 27, 2006

(54) Methods and apparatuses for distributing system secret parameter group and encrypted intermediate key group for generating content encryption and decryption deys

(76) Inventors: Masao Nonaka, Neyagawa-shi (JP); Yuich Futa, Osaka-shi (JP); Motoji Ohmori, Hirakata-shi (JP); Shigeru Yamada, Mino-shi (JP); Tetsuya Inoue, Ibaraki-shi (JP); Yoji Kumazaki, Kasugai-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/547,376

(22) PCT Filed: Dec. 15, 2004
(86) PCT No.: PCT/JP04/19141

§ 371 Date: Aug. 29, 2005

(30) Foreign Application Priority Data
Dec. 17, 2003 (JP) 2003-419766

(51) Int. Cl. H04L 9/00

(52) U.S. Cl. 380/44

(57) ABSTRACT

A key issuing center (11) distributes a system secret parameter group that is information necessary for generating a content key used for encrypting a content to a server (12), and an encrypted intermediate key group set that is information necessary for generating a content key used for decrypting the content to output apparatuses (13a to 13n). The server (12) generates the content key based on the system secret parameter group and a time varying parameter group, encrypts the content based on the content key, and distributes the encrypted content and the time varying parameter group to the output apparatuses (13a to 13n). The output apparatuses (13a to 13n) generates a content key based on the encrypted intermediate key group set and the received time varying parameter group, decrypts the encrypted content based on the content key, and outputs to outside.

### TECHNICAL FIELD

This invention relates to a content distribution system for encrypting and distributing digital contents such as movies and music works to a plurality of content output apparatuses, in particular to a technology of assigning a unique key used for decrypting the encrypted content at the output unit to each content output apparatus so that, even if a key assigned to a content output apparatus is leaked, the content output apparatus which leaked the key can be traced.

### BACKGROUND ART

Following to the proliferation of a high-speed communication path, notably, Asymmetrical Digital Subscriber Line (ADSL), optical fiber and the like, service which provides digitalized contents such as music and video via a communication path has been actively introduced. With the introduction of such service, there has been a need of copyright protection method for preventing unauthorized use of contents such as an authorized copying. In general, an encryption technology is used for the copyright protection method for preventing the unauthorized use of contents. That is, a digital content is encrypted with a content encryption key and distributed through a communication path, and only an output apparatus having a content decryption key corresponding to the content encryption key decrypts the encrypted content and can reproduce the original digital content.

By the way, in general, the content decryption key assigned to each output apparatus is secretly stored. However, there is a possibility that an attacker may obtain a content decryption key commonly assigned to all output apparatuses. When a content decryption key assigned to an output apparatus is once leaked, there is a threat that an attacker may create an unauthorized output apparatus which decrypts digital content using a content decryption key of which it cannot trace the origin of leakage and perform unauthorized use of the content. As a means of preventing such unauthorized use of content, a system which can trace an output apparatus which is the origin of leakage by assigning a key separately to each output apparatus is suggested. In a broadcasting station type content distribution, as a method of preventing unauthorized use of content, there is, for example, a content distribution system disclosed in the non-patent literature 1 (The Institute of Image Formation and Television Engineers ed. “Mechanism of Digital Broadcasting Station System”, Ohmsha.)

FIG. 91 indicates a conventional content distribution system disclosed in the non-patent literature 1.

In FIG. 91, a communication path 90 is a communication path connecting a key issuing center 91, a server 92, and a plurality of output apparatuses 93a to 93n to each other and is embodied in a network such as the Internet. Also, all sets of the key issuing center 91 and the plurality of output apparatuses 93a to 93n previously share one of individual keys IKa . . . IKn in advance. For example, previously, the key issuing center 91 and the output apparatus 93a share the individual key IKa; the key issuing center 91 and the output apparatus 93b share the individual key IKb; and the key issuing center 91 and the output apparatus 93n share the individual key IKn.

First, a method of sharing an intermediate key MK among all output apparatuses 93a to 93n is explained. The key issuing center 91 generates an intermediate key MK and transmits the intermediate key MK to the server 92. Next, it encrypts the intermediate key MK based on the individual keys IKa, IKb, . . . , and IKn previously shared respectively with the output apparatuses 93a to 93n, and distributes the value which concatenated each of cipher texts Enc (IKa, MK), Enc (IKb, MK), . . . , and Enc (IKn, MK) to the plurality of output apparatuses 93a to 93n as an encrypted intermediate key group ENCMKG=Enc (IKa, MK)∥Enc (1Kb, MK) Enc (IKn, MK). Here, “∥” indicates a connective and Enc (K, P) indicates a cipher text that a plaintext P is encrypted with an encryption key K. Note that in the non-patent literature 1, the encrypted intermediate key group ENCMKG is called as Entitlement Management Message (EMM); the individual keys IKa to IKn are called as a master key (Km); and the intermediate key MK is called as a work key (Kw). Each of the plurality of output apparatuses 93a to 93n which received the encrypted intermediate key group ENCMKG takes out a cipher text corresponding to own individual key from the encrypted intermediate key ENCMKG, decrypts the cipher text based on the individual key and obtains the intermediate key MK. Accordingly, the common intermediate key MK can be shared among all output apparatuses 93a to 93n.

Next, it is explained about a method of sharing a content key CK used for decrypting content CNT in all output apparatuses 93a to 93n. The server 92 generates a content key CK, based on the intermediate key MK shared among the output apparatuses 93a to 93n, encrypts the content key CK, and distributes the cipher text Enc (MK, CK) to the plurality of output apparatuses 93a to 93n as an encrypted content key ENCCK. The plurality of output apparatuses 93a to 93n which received the encrypted content key ENCCK decrypts the encrypted content key ENCCK based on the intermediate key MK and obtains the content key CK. Accordingly, the common content key CK can be shared among all output apparatuses 93a to 93n.

Lastly, an operation of distributing content is explained. First, the server 92 receives the content CNT from outside, encrypts the content CNT based on the content key CK, and distributes the encrypted content ENCCNT=Enc (MKCNT) to the plurality of output apparatuses 93a to 93n. The plurality of output apparatuses 93a to 93n which received the encrypted content ENCCNT decrypt the encrypted content ENCCNT based on the content key CK and output the decrypted content DECCNT to the outside.

Here, the key issuing center 91 revokes the output apparatus having a specific individual key by updating the intermediate key MK so as not to decrypt the content CNT. Here, it is explained about a case where the output apparatus having the individual key of the output apparatus 93a is revoked. First, the key issuing center 91 newly generates the intermediate key MK and transmits the intermediate key MK to the server 92. After that, it encrypts the intermediate key MK using each of the individual keys IKb to IKn other than the output apparatus 93a and the individual key IKa which is previously shared, and distributes, to the plurality of the output apparatuses 93a to 93n, the value concatenated each of cipher texts Enc (IKb, MK), . . . , and Enc (IKn, MK) as an encrypted intermediate key group ENCMKG=Enc (IKb, MK)∥ . . . Enc (IKn, MK). Accordingly, the output apparatuses 93b to 93n other than the output apparatus 93a can obtain the intermediate key MK. Therefore, the content key CK is obtained so that the encrypted content ENCCNT=Enc (MKCNT) can be decrypted. However, the output apparatus 93a cannot obtain the intermediate key MK so that the content key CK is not obtained and the encrypted content ENCCNT=Enc (MKCNT) cannot be decrypted. Accordingly, the key issuing center 91 can revoke the output apparatus. Note that, also in the case where the output apparatuses 93b to 93n other than the output apparatus 93a are revoked, whereas the similar operations as in the output apparatus 93a are taken, an individual key used for encrypting the intermediate key MK differs.

Thus, such system allows, even if an attacker illegally obtains the individual key embedded in one of the output apparatuses 93a to 93n and creates an output apparatus using the individual key, to trace an output apparatus which is the origin of leakage from an individual key embedded in the output apparatus so that a strategy of revoking a targeted output apparatus can be established.

When the individual key embedded in any one of the output apparatuses 93a to 93n is obtained without authorizations, in addition to the method described in the above, it is presumed a case where the attacker obtains an intermediate key MK using the individual key and creates an unauthorized output apparatus in which the intermediate key MK is embedded. However, in the conventional structure, the intermediate key MK is a value common to all output apparatuses 93a to 93n. Therefore, there is a problem that the output apparatus which is the origin of the leakage cannot be traced from the intermediate key embedded in the unauthorized output apparatus.

### DISCLOSURE OF INVENTION

In order to solve the mentioned problem, the present invention aims to provide a content distribution system which can trace the leaked output apparatus even if the attacker creates the unauthorized output apparatus in which the intermediate key is embedded.

The present invention is a content output apparatus which decrypts an encrypted content based on an intermediate key group that is made up of at least one intermediate key, and outputs the decrypted content, the content output apparatus being connected, via a network, to a content distribution server which encrypts a content and distributes the encrypted content, the apparatus comprising: a content receiving unit operable to receive the encrypted content; an intermediate key group storage unit operable to hold the intermediate key group; a time varying parameter group receiving unit operable to receive, via the network, a time varying parameter group that is made up of at least one time varying parameter previously shared with the content distribution server; a content decryption key generation unit operable to generate a content decryption key based on the received time varying parameter group and the intermediate key group; and a content decryption unit operable to decrypt the encrypted content based on the content decryption key.

The content output apparatus according to the present invention further comprises: an individual key storage unit operable to hold an individual key which is previously given to each of content output apparatuses, each of which has functions included in the content output apparatus; an encrypted intermediate key group set receiving unit operable to receive, via the network, an encrypted intermediate key group set including encrypted intermediate key groups, each being obtained by encrypting the intermediate key group; and an intermediate key group decryption unit operable to decrypt, based on the individual key, one of the encrypted intermediate key groups in the encrypted intermediate key group set, and store the decrypted intermediate key group into the intermediate key group storage unit.

In the content output apparatus according to the present invention, the encrypted intermediate key group set includes a first encrypted intermediate key group and a second encrypted intermediate key group, and the intermediate key group decryption unit decrypts, based on the individual key, the first encrypted intermediate key group in the encrypted intermediate key group set, and obtains a first intermediate key.

In the content output apparatus according to the present invention, the intermediate key group decryption unit obtains a second intermediate key from the first intermediate key based on the time varying parameter group received by the time varying parameter group receiving unit, and the content decryption key generation unit, based on the second intermediate key, decrypts the second encrypted intermediate key group in the encrypted intermediate key group set, and generates the content decryption key.

In the content output apparatus according to the present invention, the first intermediate key is a value unique to each of the content output apparatuses and models of the content output apparatuses, and the second intermediate key is a value common to all of the content output apparatuses.

The content output apparatus according to the present invention further comprises: a time varying parameter group storage unit operable to hold the received time varying parameter group; and an intermediate key group receiving unit operable to store the received intermediate key group into the intermediate key group storage unit via the network.

In the content output apparatus according to the present invention, the content decryption key generation unit generates the content decryption key from the intermediate key group and the time varying parameter group according to at least one previously given content decryption key generation equation, and the content decryption key generation equation includes at least one of an addition, a subtraction, a multiplication, and a division.

In the content output apparatus according to the present invention, the time varying parameter group further includes an intermediate key group identifier for identifying one of the intermediate key groups, and the content decryption key generation unit i) determines one intermediate key group from among the intermediate key groups based on the intermediate key group identifier, and further ii) generates the content decryption key based on the determined intermediate key group, the time varying parameter group and the content decryption key generation equation.

In the content output apparatus according to the present invention, the encrypted intermediate key group set receiving unit obtains an encrypted table in which the encrypted intermediate key groups are described, the intermediate key group decryption unit decrypts the encrypted table based on the individual key, and obtains a decrypted table in which the intermediate key groups are described, and in the decrypted table, element identifiers for identifying elements and intermediate key groups are described, the elements constituting the decrypted table and the intermediate key groups being table elements respectively corresponding to the element identifiers.

In the content output apparatus according to the present invention, the content decryption key generation unit selects an intermediate key group that is one of the table elements based on the corresponding element identifier, and generates the content decryption key based on the intermediate key group.

In the content output apparatus according to the present invention, the element identifiers are time varying parameters and the table elements are intermediate key groups.

In the content output apparatus according to the present invention, the intermediate key groups are made up of an intermediate key group common to all of the content output apparatuses and an intermediate key group unique to each of the content output apparatuses.

In the content output apparatus according to the present invention, the content decryption key generation unit calculates the content decryption key using a shift register based on the intermediate key group and the time varying parameter group.

In the content output apparatus according to the present invention, the content decryption key generation unit performs a left shift operation using the shift register.

In the content output apparatus according to the intermediate key group decryption unit performs the left shift operation using the time varying parameter group and the first intermediate key so as to obtain a second intermediate key, and the content decryption key generation unit, based on the second intermediate key, decrypts one of the second encrypted intermediate key groups in the encrypted intermediate key group set and generates the content decryption key.

In the content output apparatus according to the present invention, the time varying parameter group is made up of at least two time varying parameters, and each of the time varying parameters is a random number value which varies according to every predetermined term or a value generated using time information.

In the content output apparatus according to the present invention, the time varying parameter group is a value common to all of the content output apparatuses.

The present invention is a content distribution server according to the present invention encrypts a content so as to generate an encrypted content, and distributes, via a network, the encrypted content to content output apparatuses, each of which decrypts and outputs the encrypted content, the server comprising: a system secret parameter group storage unit operable to hold a system secret parameter group made up of at least one previously given system secret parameter; a time varying parameter generation unit operable to generate a time varying parameter group made up of at least one time varying parameter based on the system secret parameter group; a time varying parameter group storage unit operable to hold the time varying parameter group; a content encryption key generation unit operable to generate a content encryption key that is an intermediate key group based on the time varying parameter group and the system secret parameter group; a content encryption unit operable to encrypt the content based on the content encryption key; and a content distribution unit operable to distribute the encrypted content to the content output apparatuses.

The content distribution server according to the present invention further comprises: a time varying parameter group distribution unit operable to distribute the time varying parameter group to the content output apparatuses; and a content encryption key distribution unit operable to distribute the content encryption key to the content output apparatuses.

In the content distribution server according to the present invention, the system secret parameter group is made up of at least three or more said system secret parameters.

In the content distribution server according to the present invention, the intermediate key group is made up of at least two or more intermediate keys generated based on the system secret parameter group and the time varying parameter group.

The present invention is a key issuing center that is connected to content output apparatuses and a content distribution server via a network and issues an intermediate key group for decrypting an encrypted content by each of the content output apparatuses, said each of the content output apparatuses decrypting and outputting the encrypted content and the content distribution server distributing the encrypted content to the content output apparatuses, the key issuing center comprising: a system secret parameter group generation unit operable to generate a system secret parameter group made up of at least one system secret parameter; a system secret parameter group transmission unit operable to transmit the system secret parameter group to the content distribution server; an intermediate key group generation unit operable to generate a plurality of the intermediate key groups based on the system secret parameter group; an intermediate key group encryption unit operable to encrypt one of the intermediate key groups based on an individual key given to each of the content output apparatuses; and an encrypted intermediate key group set distribution unit operable to distribute an encrypted intermediate key group set made up of the encrypted intermediate key groups.

In the key issuing center according to the present invention, the system secret parameter group is made up of at least three or more said system secret parameters.

The key issuing center according to the present invention further comprises: an intermediate key group distribution unit operable to distribute one of the encrypted intermediate key groups in the encrypted intermediate key group set to the content output apparatuses; a time varying parameter group generation unit operable to generate a time varying parameter group based on the system secret parameter group; and a time varying parameter group distribution unit operable to distribute the time varying parameter group to the content distribution server and the content output apparatuses.

In the key issuing center according to the present invention, the intermediate key group generation unit generates coefficients of a content decryption generation equation for decrypting the content as the intermediate key group.

The present invention is a content distribution system comprising: content output apparatuses, each of which decrypts an encrypted content based on an intermediate key group that is made up of at least one intermediate key, and outputs the decrypted content; and a content distribution server which encrypts a content so as to generate the encrypted content, and distributes the encrypted content to the content output apparatuses, wherein the content output apparatuses and the content distribution server are connected to each other via a network, the content output apparatus includes: a content receiving unit operable to receive the encrypted content; an intermediate key group storage unit operable to hold the intermediate key group; a time varying parameter group receiving unit operable to receive, via the network, a time varying parameter group that is made up of at least one time varying parameter previously shared with the content distribution server; a content decryption key generation unit operable to generate a content decryption key based on the received time varying parameter group and the intermediate key group; and a content decryption unit operable to decrypt the encrypted content based on the content decryption key, and the content distribution server includes: a system secret parameter group storage unit operable to hold a system secret parameter group made up of at least one previously given system secret parameter; a time varying parameter generation unit operable to generate a time varying parameter group made up of at least one time varying parameter; a time varying parameter group storage unit operable to hold the time varying parameter group; a content encryption key generation unit operable to generate a content encryption key that is an intermediate key group based on the time varying parameter group and the system secret parameter group; a content encryption unit operable to encrypt the content based on the content encryption key; and a content distribution unit operable to distribute the encrypted content to the content output apparatuses.

The present invention is a program used for a plurality of content output apparatuses, each of which decrypts an encrypted content based on an intermediate key group that is made up of at least one intermediate key, and outputs the decrypted content, the content output apparatuses being connected, via a network, to a content distribution server which distributes the encrypted content, the program comprising: receiving the encrypted content; storing the intermediate key group; receiving, via the network, a time varying parameter group that is made up of at least one time varying parameter previously shared with the content distribution server; generating a content decryption key based on the received time varying parameter group and the intermediate key group; and decrypting the encrypted content based on the content decryption key.

The present invention is a program used for a content distribution server which encrypts a content so as to generate an encrypted content and distributes, via a network, the encrypted content to content output apparatuses, each of which decrypts and outputs the encrypted content, the program including: storing a system secret parameter group that is made up of at least one previously given system secret parameter; generating a time varying parameter group that is made up of at least one previously given time varying parameter; storing the time varying parameter group; generating a content encryption key that is an intermediate key group based on the time varying parameter group and the system secret parameter group; encrypting the content based on the content encryption key; and distributing the encrypted content to the content output apparatuses.

The present invention is a program used for a key issuing center which is connected to content output apparatuses and a content distribution server via a network, and issues an intermediate key group for decrypting an encrypted content by each of the content output apparatuses, the program comprising: generating a system secret parameter group made up of at least one system secret parameter; transmitting the system secret parameter group to the content distribution server; generating a plurality of the intermediate key groups based on the system secret parameter group; encrypting one of the plurality of the intermediate key groups based on an individual key given to each of the content output apparatuses so as to generate a plurality of encrypted intermediate key groups; and distributing, to the content output apparatuses, an encrypted intermediate key group set that is made up of a plurality of the encrypted intermediate key groups.

The present invention is a computer readable recording medium on which a program according to one of the above mentioned programs is recorded.

The present invention is a content distribution method used for a plurality of content output apparatuses, each of which decrypts an encrypted content based on an intermediate key group that is made up of one or more intermediate keys and outputs the decrypted content, the content output apparatuses being connected, via a network, to a content distribution server which distributes the encrypted content, the method comprising: receiving the encrypted content; holding the intermediate key group; receiving the time varying parameter group that is made up of at least one time varying parameter shared previously with the server via the network; generating a content decryption key based on the received time varying parameter group and the intermediate key group; and decrypting the encrypted content based on the content decryption key.

The present invention is a content distribution method used for a content distribution server which encrypts a content so as to generate an encrypted content, and distributes, via a network, the encrypted content to content output apparatuses, each of which decrypts and outputs the encrypted content, the method comprising: holding a system secret parameter group made up of at least one previously given system secret parameter; generating a time varying parameter group made up of at least one previously given time varying parameter; holding the time varying parameter group; generating a content encryption key that is an intermediate key group based on the time varying parameter group and the system secret parameter group; encrypting the content based on the content encryption key; and distributing the encrypted content to the content output apparatuses.

The present invention is a content distribution method used for a key issuing center which is connected to content output apparatuses and a content distribution server via a network, and issues an intermediate key group for decrypting an encrypted content by each of the content output apparatuses, the method comprising: generating a system secret parameter group made up of at least one system secret parameter; transmitting the system secret parameter group to the content distribution server; generating a plurality of the intermediate key groups based on the system secret parameter group; encrypting one of the plurality of the intermediate key groups based on an individual key given to each of the content output apparatuses; and distributing an encrypted intermediate key group set that is made up of a plurality of the encrypted intermediate key groups to the content output apparatuses.

As further information about technical background to this application, the disclosure of Japanese Patent Application No. 2003-419766 filed on Dec. 17, 2003 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a schematic diagram showing a content distribution system 1 in a first embodiment of the present invention.

FIG. 2 is a diagram showing an example of a structure of a key issuing center 11 in the first embodiment of the present invention.

FIG. 3 is a diagram showing an example of a system secret parameter group SPG in the first embodiment of the present invention.

FIG. 4 is a diagram showing an example of a structure of an output apparatus correspondence information storage unit 114 in the first embodiment of the present invention.

FIG. 5 is a diagram showing an example of an intermediate key group MKGa in the first embodiment of the present invention.

FIG. 6 is a diagram showing an example of an encrypted intermediate key group set ENCMKGS in the first embodiment of the present invention.

FIG. 7 is a flowchart showing a process of the key issuing center 11 when receiving key information in the first embodiment of the present invention.

FIG. 8 is a flowchart showing a process of the key issuing center 11 when revoking an output apparatus 13a in the first embodiment of the present invention.

FIG. 9 is a diagram showing an example of a structure of a server 12 in the first embodiment of the present invention.

FIG. 10 is a diagram showing an example of a structure of a content key storage unit 123 in the first embodiment of the present invention.

FIG. 11 is a diagram showing an example of a structure of a time varying parameter group storage unit 125 in the first embodiment of the present invention.

FIG. 12 is a diagram showing an example of a structure of a system secret parameter group storage unit 127 in the first embodiment of the present invention.

FIG. 13 is a diagram showing an example of a time varying parameter group PRG in the first embodiment of the present invention.

FIG. 14 is a flowchart showing a process of the server 12 when distributing content in the first embodiment of the present invention.

FIG. 15 is a flowchart showing a process of the server 12 when receiving a system secret parameter group in the first embodiment of the present invention.

FIG. 16 is a flowchart showing a process of the server 12 when updating a time varying parameter group in the first embodiment of the present invention.

FIG. 17 is a diagram showing an example of a structure of the output apparatus 13a in the first embodiment of the present invention.

FIG. 18 is a diagram showing an example of a structure of a content key storage unit 133 in the first embodiment of the present invention.

FIG. 19 is a diagram showing an example of a structure of an intermediate key group storage unit 134a in the first embodiment of the present invention.

FIG. 20 is a diagram showing an example of a structure of an individual key storage unit 139a in the first embodiment of the present invention.

FIG. 21 is a flowchart showing a process of the server 12 when receiving encrypted content in the first embodiment of the present invention.

FIG. 22 is a flowchart showing a process of the server 12 when receiving a key in the first embodiment of the present invention.

FIG. 23 is a schematic diagram of a content distribution system 2 in a second embodiment of the present invention.

FIG. 24 is a diagram showing an example of a structure of a key issuing center 21 in the second embodiment of the present invention.

FIG. 25 is a diagram showing an example of a system secret parameter group SPG in the second embodiment of the present invention.

FIG. 26 is a diagram showing an example of an intermediate key group MKGa in the second embodiment of the present invention.

FIG. 27 is a flowchart showing a process of the key issuing center 21 when distributing a key in the second embodiment of the present invention.

FIG. 28 is a flowchart showing a process of the key issuing center 21 when revoking an output apparatus 23a in the second embodiment of the present invention.

FIG. 29 is a diagram showing an example of a structure of a server 22 in the second embodiment of the present invention.

FIG. 30 is a diagram showing an example of a time varying parameter group PRG in the second embodiment of the present invention.

FIG. 31 is a flowchart showing a process of the server 22 when updating the time varying parameter group in the second embodiment of the present invention.

FIG. 32 is a diagram showing an example of a structure of an output apparatus 23a in the second embodiment of the present invention.

FIG. 33 is a flowchart showing a process of the output apparatus 23a when receiving content in the second embodiment of the present invention.

FIG. 34 is a schematic diagram of a content distribution system 3 in a third embodiment of the present invention.

FIG. 35 is a diagram showing an example of a structure of a key issuing center 31 in the third embodiment of the present invention.

FIG. 36 is a diagram showing an example of a system secret parameter group SPG in the third embodiment of the present invention.

FIG. 37 is a diagram showing an example of an intermediate key group MKGa in the third embodiment of the present invention.

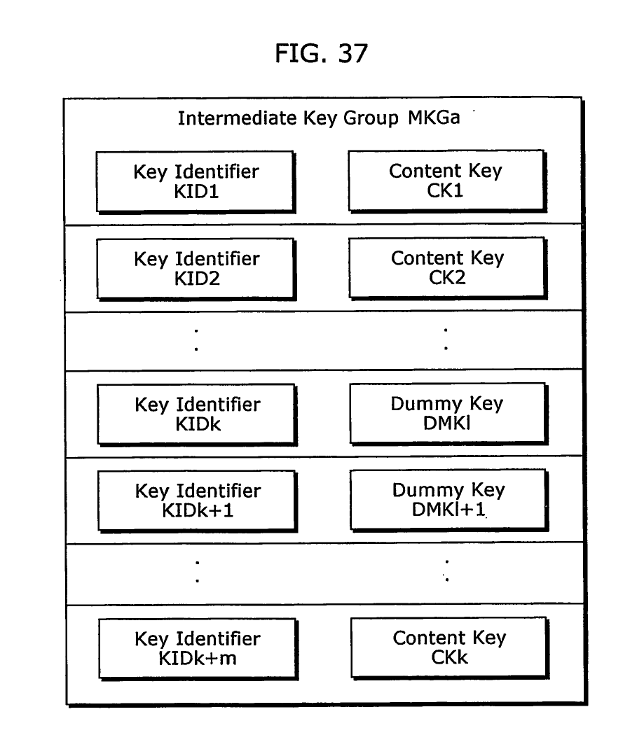

FIG. 38 is a flowchart showing a process of the key issuing center 31 at receiving a key in the third embodiment of the present invention.

FIG. 39 is a flowchart showing a process of the key issuing center 31 when revoking an output apparatus 33a in the third embodiment of the present invention.

FIG. 40 is a diagram showing an example of a structure of a server 32 in the third embodiment of the present invention.

FIG. 41 is a diagram showing an example of a time varying parameter group PRG in the third embodiment of the present invention.

FIG. 42 is a flowchart showing a process of the server 32a when updating the time varying parameter group in the third embodiment of the present invention.

FIG. 43 is a diagram showing an example of a structure of the output apparatus 33a in the third embodiment of the present invention.

FIG. 44 is a flowchart showing a process of the output apparatus 33a when receiving content in the third embodiment of the present invention.

FIG. 45 is a diagram showing an example of a system secret parameter group SPG in the third embodiment of the present invention.

FIG. 46 is a diagram showing an example of the intermediate key group MKGa in the third embodiment of the present invention.

FIG. 47 is a diagram showing an example of a system secret parameter group SPG in the third embodiment of the present invention.

FIG. 48 is a diagram showing an example of the intermediate key group MKGa in the third embodiment of the present invention.

FIG. 49 is a diagram showing an example of the time varying parameter group PRG in the third embodiment of the present invention.

FIG. 50 is a schematic diagram of a content distribution system 4 in a fourth embodiment of the present invention.

FIG. 51 is a diagram showing an example of a structure of a key issuing center 41 in the fourth embodiment of the present invention.

FIG. 52 is a diagram showing an example of an intermediate key group MKGa in the fourth embodiment of the present invention.

FIG. 53 is a flowchart showing a process of the key issuing center 41 when distributing a key in the fourth embodiment of the present invention.

FIG. 54 is a flowchart showing a process of the key issuing center 41 when revoking an output apparatus 43a in the fourth embodiment of the present invention.

FIG. 55 is a diagram showing an example of a structure of the output apparatus 43a in the fourth embodiment of the present invention.

FIG. 56 is a flowchart showing a process of the output apparatus 43a when receiving content in the fourth embodiment of the present invention.

FIG. 57 is a schematic diagram showing a content distribution system 5 in a fifth embodiment of the present invention.

FIG. 58 is a diagram showing an example of a shift register used in the fifth embodiment of the present invention.

FIG. 59 is a diagram showing an example of a performance of a right shift operation in the shift register used in the fifth embodiment of the present invention.

FIG. 60 is a diagram showing an example of a performance of a left shift operation in the shift register used in the fifth embodiment of the present invention.

FIG. 61 is a diagram showing an example of a structure of a key issuing center 51 in the fifth embodiment of the present invention.

FIG. 62 is a flowchart showing a process of the key issuing center 51 when distributing key information in the fifth embodiment of the present invention.

FIG. 63 is a flowchart showing a process of the key issuing center 51 when revoking an output apparatus 53a in the fifth embodiment of the present invention.

FIG. 64 is a diagram showing an example of a structure of a server 52 in the fifth embodiment of the present invention.

FIG. 65 is a diagram showing an example of a structure of an intermediate key group storage unit 527 in the fifth embodiment of the present invention.

FIG. 66 is a flowchart showing a process of the server 52 when updating a time varying parameter group PRG in the fifth embodiment of the present invention.

FIG. 67 is a diagram showing an example of a structure of the output apparatus 53a in the fifth embodiment of the present invention.

FIG. 68 is a flowchart showing a process of the output apparatus 53a when receiving content in the fifth embodiment of the present invention.

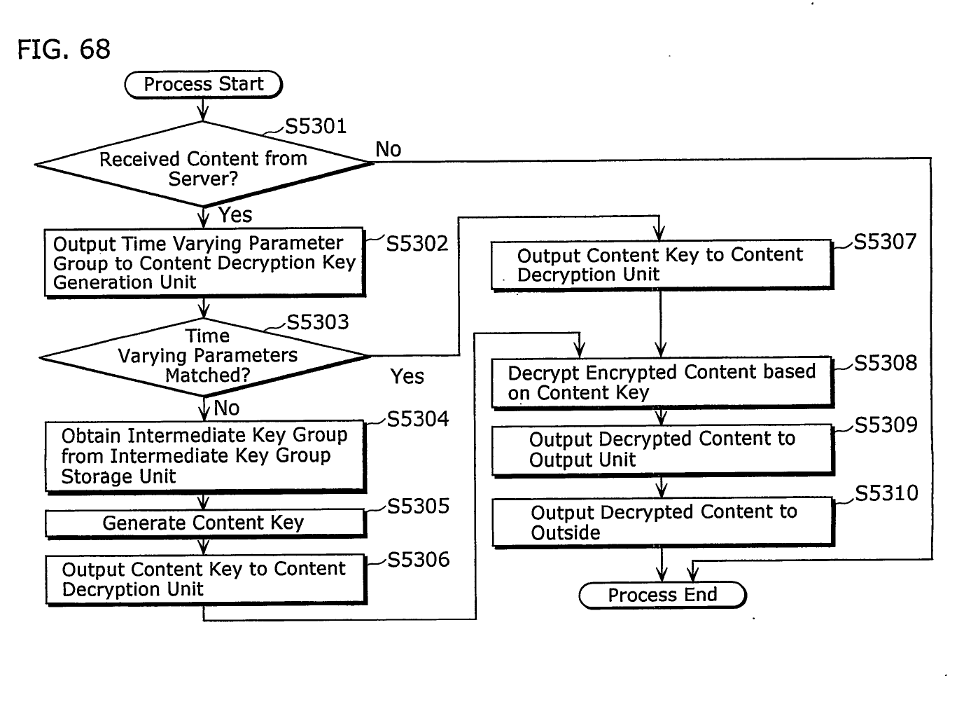

FIG. 69 is an example of generating an intermediate key group in the fifth embodiment of the present invention.

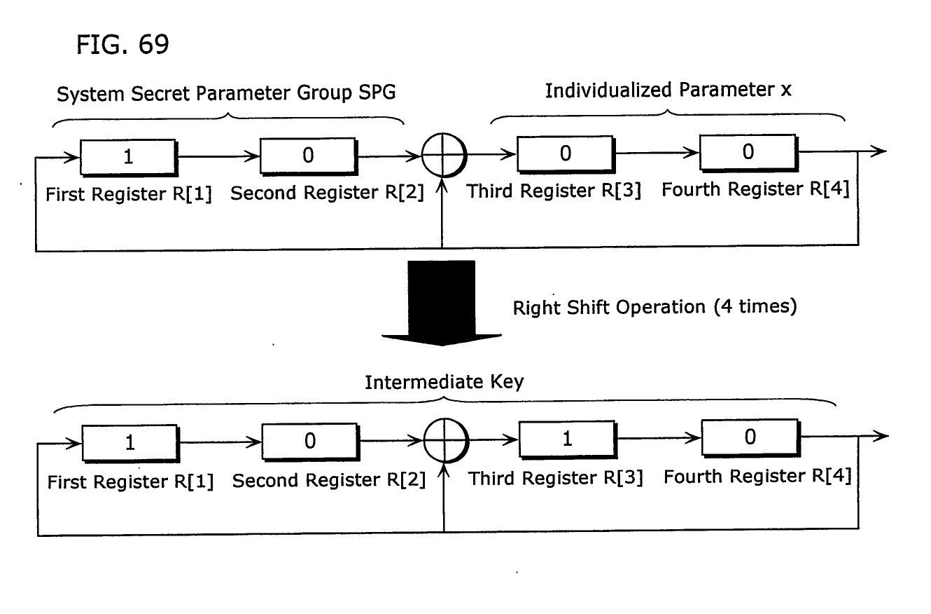

FIG. 70 is an example of generating a content key in the fifth embodiment of the present invention.

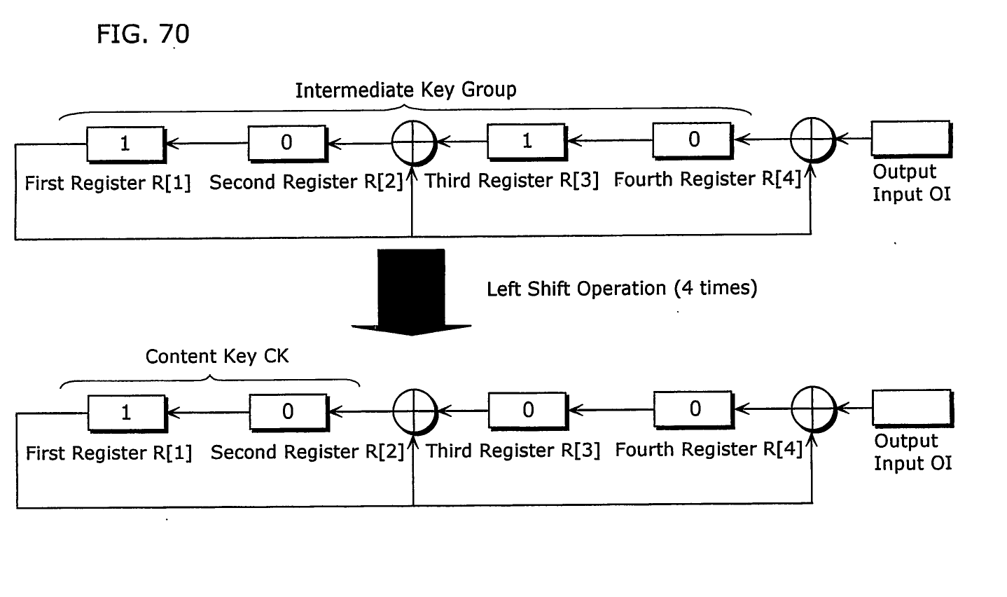

FIG. 71 is a schematic diagram of a content distribution system 6 in a sixth embodiment of the present invention.

FIG. 72 is a diagram showing an example of a structure of a key issuing center 61 in the sixth embodiment of the present invention.

FIG. 73 is a diagram showing an example of a system secret parameter group SPG in the sixth embodiment of the present invention.

FIG. 74 is a diagram showing an example of a structure of an output apparatus correspondence information storage unit 614 in the sixth embodiment of the present invention.

FIG. 75 is a diagram showing an example of an intermediate key group MKGa in the sixth embodiment of the present invention.

FIG. 76 is a diagram showing an example of an encrypted intermediate key group set ENCMKGS in the sixth embodiment of the present invention.

FIG. 77 is a flowchart showing a process of a key issuing center 61 when updating key information in the sixth embodiment of the present invention.

FIG. 78 is a diagram showing an example of a structure of a server 62 in the sixth embodiment of the present invention.

FIG. 79 is a diagram showing an example of a structure of a system secret parameter group storage unit 622 in the sixth embodiment of the present invention.

FIG. 80 is a diagram showing an example of a time varying parameter group PRG in the sixth embodiment of the present invention.

FIG. 81 is a diagram showing an example of a structure of a content key storage unit 623 in the sixth embodiment of the present invention.

FIG. 82 is a flowchart showing a process of the server 62 when receiving a system secret parameter group in the sixth embodiment of the present invention.

FIG. 83 is a flowchart showing a process of the server 62 when updating the time varying parameter group in the sixth embodiment of the present invention.

FIG. 84 is a flowchart showing a process of the server 62 when distributing content in the sixth embodiment of the present invention.

FIG. 85 is a diagram showing an example of a structure of an output apparatus 63a in the sixth embodiment of the present invention.

FIG. 86 is a diagram showing an example of a structure of an individual key storage unit 633a in the sixth embodiment of the present invention.

FIG. 87 is a diagram showing an example of a structure of an intermediate key group storage unit 634a in the sixth embodiment of the present invention.

FIG. 88 is a flowchart showing a process of a receiving apparatus 63a when receiving an encrypted intermediate key group set in the sixth embodiment of the present invention.

FIG. 89 is a flowchart showing a process of the receiving apparatus 63a when receiving the time varying parameter group in the sixth embodiment of the present invention.

FIG. 90 is a flowchart showing a process of the receiving apparatus 63a when receiving content in the sixth embodiment of the present invention.

FIG. 91 is a schematic diagram of a conventional content distribution system.

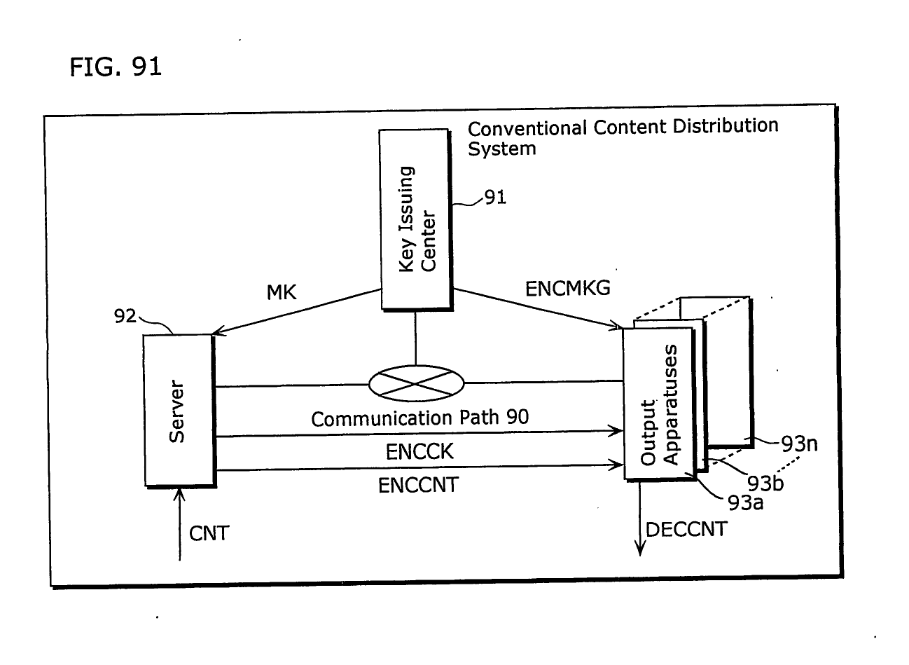

### BEST MODE FOR CARRYING OUT THE INVENTION

Hereafter, it is explained about embodiments of a content distribution system according to the present invention with reference to diagrams.

### First Embodiment

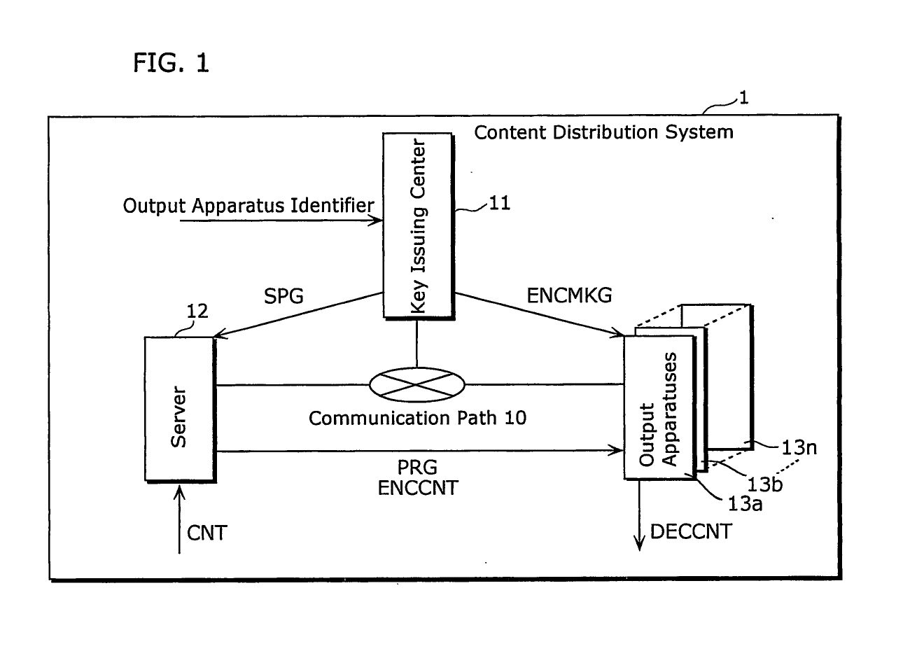

It is explained about a content distribution system 1 as an embodiment according to the present invention. First, an outline of the present invention is explained with reference to FIG. 1.

In FIG. 1, a communication path 10 is a communication path such as the Internet connecting a key issuing center 11, a server 12 and a plurality of output apparatuses 13a to 13n. Each of these constituents is explained later. The key issuing center 11 distributes information necessary for sharing a content key CK between the server 12 and the plurality of output apparatuses 13a to 13n. The server 12 encrypts and distributes content CNT. The plurality of output apparatuses 13a to 13n decrypt the received encrypted content ENCCNT and output the decrypted content DECCNT to the outside. Here, every sets of the key issuing center 11 with the plurality of output apparatuses 13a to 13n has respectively one individual key shared previously among pairs of each set. For example, the key issuing center 11 and the output apparatus 13a previously share an individual key IKa; the key issuing center 11 and the output apparatus 13b previously share an individual key IKb; . . . ; and the key issuing center 11 and the output apparatus 13n previously share an individual key IKn.

Here, it is explained more in detail about operations of each constituent. First, it is explained about a method of distributing the intermediate key groups MKGa to MKGn respectively to the output apparatuses 13a to 13n. At first, the key issuing center 11 generates, in accordance with previously given condition, a system secret parameter group SPG that is necessary for generating a content key CK and transmits it to the server 12. It then generates intermediate key groups MKGa to MKGn as many as the output apparatuses 13 based on the system secret parameter group SPG. Next, the key issuing center 11 associates respectively the intermediate key groups MKGa to MKGn with the output apparatuses 13a to 13n and encrypts each of the associated intermediate key groups MKGa to MKGn based on each of the individual keys IKa, IKb, . . . , and IKn respectively held by the output apparatuses 13a to 13n. After that, the value concatenated cipher texts, Enc (IKa, MKGa), Enc (IKb, MKGb), . . . , and Enc (IKn, MKGn) is transmitted to the plurality of output apparatuses 13a to 13n as an encrypted intermediate key group set ENCMKGS=Enc (IKa, MKGa)∥Enc (IKb, MKGb)∥ . . . Enc (IKn, MKGn). The output apparatus 13a which received the encrypted intermediate key group set ENCMKGS, using the assigned individual key IKa, decrypts the cipher text Enc (IKa, MKGa) corresponding to own individual key in the encrypted intermediate key group set ENCMKGS and obtains the intermediate key group MKGa associated with the output apparatus 13a. Here, similarly in the case of output apparatuses 13b to 13n other than the output apparatus 13a, an intermediate key associated with each of the output apparatuses is obtained using an individual key held by each of the output apparatuses.

Next, it is explained about operations when the server 12 distributes content. First, the server 12 generates a time varying parameter group PRG in accordance with pre-given condition and generates a content key CK used for encrypting the content CNT based on the time varying parameter group PRG and the system secret parameter group SPG. Then, the server 12, based on the content key CK, encrypts the content. CNT and distributes the encrypted content ENCCNT=Enc (CK, CNT) and the time varying parameter group PRG to the plurality of output apparatuses 13a to 13n. The plurality of output apparatuses 13a to 13n receive the encrypted content ENCCNT and the time varying parameter group PRG, and generate a content key CK used for decrypting the encrypted content ENCCNT based on the time varying parameter group PRG and each of the intermediate key groups MKGa to MKGn. Then, the plurality of output apparatuses 13a to 13n decrypt the encrypted content ENCCNT based on the content key CK and output the decrypted content DECCNT to the outside.

Next, it is explained about a case where the output apparatus 13a is not allowed to decrypt the content CNT. First, the key issuing center 11 receives an output apparatus identifier AIDa which identifies the output apparatus 13a from the outside, newly generates a system secret parameter group SPG, and transmits the generated SPG to the server 12. After that, based on the newly generated system parameter group SPG, it generates intermediate key groups MKGb to MKGn as many as the output apparatuses 13b to 13n other than the output apparatus 13a. Then, based on each of the individual keys IKb to IKn held respectively by the output apparatuses 13b to 13n other than the output apparatus 13a corresponding to the output apparatus identifier AIDa, the key issuing center 11 encrypts each of the intermediate key groups MKGb to MKGn and distributes, to the plurality of output apparatuses 13a to 13n, the value concatenated cipher texts, Enc (IKb, MKGb), . . . , and Enc (IKn, MKGn) as an encrypted intermediate key group set ENCMKGS=Enc (IKb, MKb)∥ . . . Enc (IKn, MKn). Accordingly, the output apparatus 13a cannot obtain the newly generated intermediate key group so that it cannot decrypt the encrypted content ENCCNT. Here, cases of the output apparatuses 13b to 13n other than the output apparatus 13a are similar to the case of the output apparatus 13a. However, they differ with the case of the output apparatus 13a in that an individual key used for encrypting each of the intermediate key group differs from each other.

This is the outline of the present embodiment. Hereafter, it is explained about details of the content distribution system 1 in the embodiment for the content distribution system of the present invention. Here, the details about the constituents are explained.

<Structure of Content Distribution System 1>

As shown in FIG. 1, the content distribution system 1 is made up of the communication path 10, the key issuing center 11, the server 12 and the plurality of output apparatuses 13a to 13n.

The key issuing center 11 distributes a system secret parameter group SPG which is information necessary for sharing a content key CK used for encrypting content to the server 12, and an encrypted intermediate key group set ENCMKGS which is information necessary for sharing a content key CK used for decrypting the encrypted content to the plurality of output apparatuses 13a to 13n. The server 12 generates a content key CK based on the system secret parameter group SPG and the time varying parameter group PRG, encrypts the content CNT with the content key CK, and distributes the encrypted content ENCCNT and the time varying parameter group PRG to the plurality of output apparatuses 13a to 13n. Each of the plurality of output apparatuses 13a to 13n generates a content key CK based on the encrypted intermediate key group set ENCMKGS and the received time varying parameter group PRG, decrypts the received encrypted content ENCCNT with the content key CK, and outputs the decrypted content DECCNT to the outside.

Hereafter, details about these constituents are explained. They are explained in the following orders with references to diagrams: i) structure of communication path 10, ii) structure and operations of key issuing center 11, iii) structure and operations of server 12, and iv) structure and operations of output apparatuses 13a to 13n.

<Structure of Communication Path 10>

The communication path is, for example, a network such as the Internet, a telephone line and a private line.

<Structure of Key Issuing Center 11>

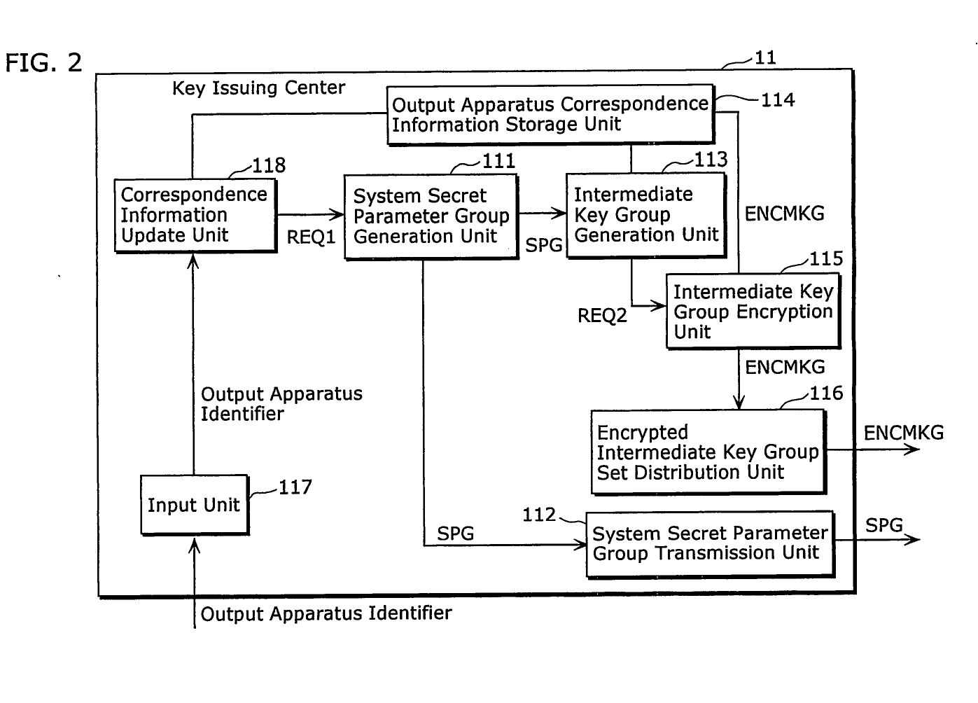

As shown in FIG. 2, the key issuing center 11 is made up of a system secret parameter group generation unit 111, a system secret parameter group transmission unit 112, an intermediate key group generation unit 113, an output apparatus correspondence information storage unit 114, an intermediate key group encryption unit 115, an encrypted intermediate key group set distribution unit 116, an input unit 117, and a correspondence information update unit 118.

(1) System Secret Parameter Group Generation Unit 111

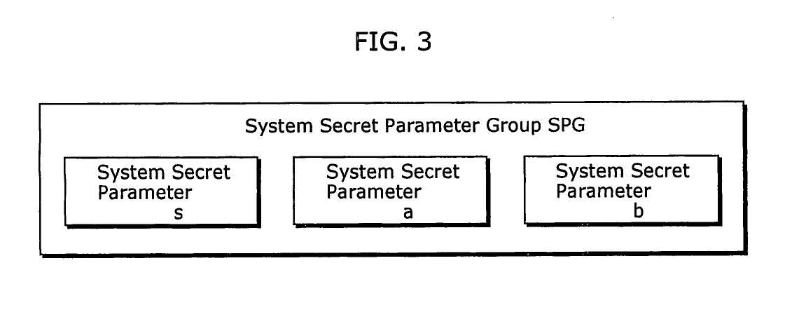

The system secret parameter group generation unit 111 generates a system secret parameter s when it receives a secret parameter group generation request REQ1 from the correspondence information update unit 118 which is described later. As a method of generating a system secret parameter s, for example, there is a method of randomly generating a system secret parameter s using random numbers. The method of generating random numbers is described in detail in the non-patent literature 3 (Knuth, Donald E., “The Art of Computer Programming Vol. 2˜Seminumerical Algorithms”, ISBN 0-2-1-03822-6). Also, the system secret parameter group generation unit 111 generates system secret parameters a and b so as to satisfy a pre-given system secret parameter generation equation “a*a−b*b=0 mod N”. Here, as a method of generating system secret parameters a and b, similarly to the case of the system secret parameter s, for example, there is a method of randomly generating the system secret parameters a and b using random numbers. The system secret parameters s, a and b, and a modulus N are, for example, natural number of 128 bits. Herein, the value of the modulus N is same as the modulus N in the intermediate key group generation unit 113 to be explained later, a time varying parameter group generation unit 128 and a content key encryption key generation unit 129 of the server 12, and a content decryption key generation unit 132 of the output apparatuses 13a to 13n. For example, the value is 2ˆ{128} and the like. Here, “ˆ” indicates a power operation. For example, 2ˆ{4} indicates 16. Hereafter, it is used for indicating the same. After that, the system secret parameter group generation unit 111 generates a system secret parameter group SPG formed of the system secret parameters s, a and b as explained in FIG. 3 and outputs the generated system secret parameter group SPG to the system secret parameter group transmission unit 112 and the intermediate key group generation unit 113. Note that when the key issuing center starts its operation, similar to the case where the system secret parameter group generation unit 111 receives the secret parameter group generation request REQ1, it generates the system secret parameter group SPG and outputs it to the system secret parameter group transmission unit 112 and the intermediate key group generation unit 113.

(2) System Secret Parameter Group Transmission Unit 112

The system secret parameter group transmission unit 112 transmits the system secret parameter group SPG received from the system secret parameter group generation unit 111 to the sever 12 via the communication path 10.

(3) Intermediate Key Group Generation Unit 113

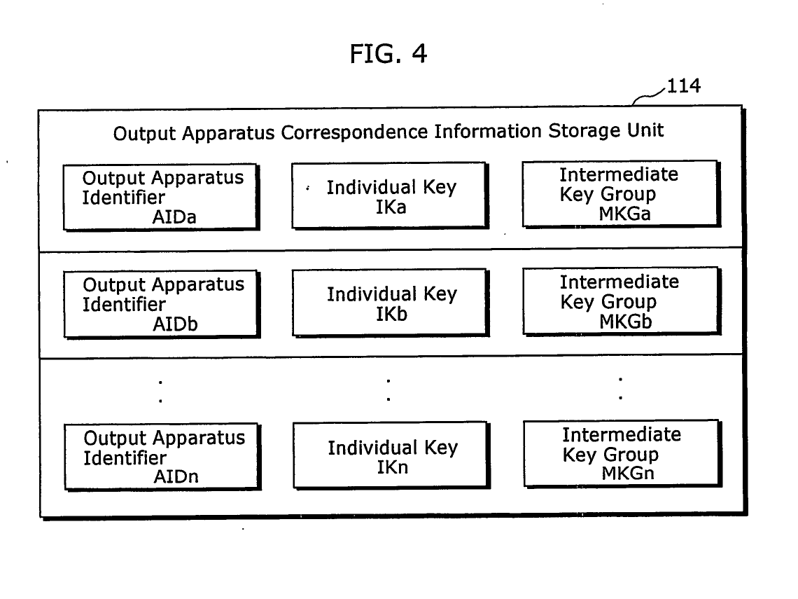

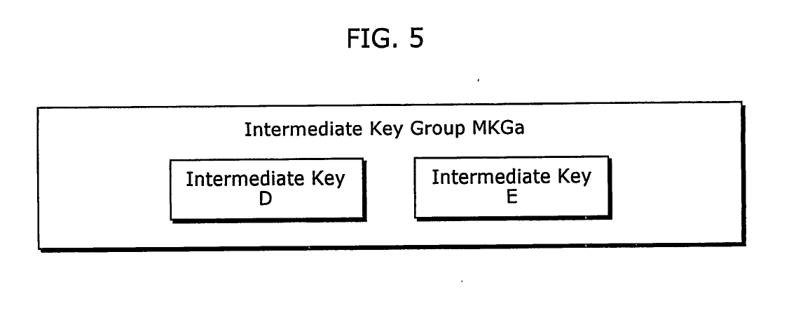

The intermediate key group generation unit 113 firstly deletes all of the intermediate key groups MKGa to MKGn stored in the output apparatus correspondence information storage unit 113 as shown in FIG. 4 when it receives a system secret parameter group SPG from the system secret parameter group generation unit 111. After that, it extracts secret parameters a and b from the received system secret parameter group SPG. Then, it generates individualized parameters x and y so as to satisfy a pre-given individualized parameter generation equation “x*a−y*b=1 mod N”. Here, as a method of generating individualized parameters x and y, for example, there is a method of randomly generating the individualized parameters using random numbers. The individualized parameters x and y are, for example, natural number of 128 bits. Also, “*” indicates power operation. For example, 2*5 is 10. Hereafter, it is used for indicating the same. As a method of obtaining the individualized parameters x and y, for example, there is a method of generating an individualized parameter x as a random natural number and generating the individualized parameter y by assigning the individualized parameter x into the individualized parameter generation equation “x*a−y*b=1 mod N”. If one random individualized parameter x is selected, there is definitely one individualized parameter y. After that, using the individualized parameters x and y, the intermediate key group generation unit 113 generates two intermediate keys D and E based on two pre-given intermediate key generation equations “D=s*x mod N” and “E=s*y mod N”. Here, “/” indicates division operation. For example, 10/2 indicates 5. Hereafter, it is used for indicating the same. Then, it associates the intermediate key group MKGa with the output apparatus identifier AIDa and stores it into the output apparatus correspondence information storage unit 114. Next, it generates similarly the intermediate key groups MKGb to MKGn respectively for the output apparatus identifiers AIDb to AIDn other than the output apparatus identifier AIDa stored in the output apparatus correspondence information storage unit 114. Here, the structures of the intermediate key groups MKGb to MKGn are same as the structure of the intermediate key group MKGa shown in FIG. 5. However, each of the intermediate key groups MKGa to MKGn should be respectively independent. Therefore, individualized parameters x and y used for generating each of the intermediate key groups MKGa to MKGn may be different values from each other. When the intermediate key group generation unit 113 assigns the intermediate key groups MKGa to MKGn respectively to all of the output apparatus identifiers AIDa to AIDn, it outputs the encrypted intermediate key group generation request REQ2 to the intermediate key group encryption unit 115.

(4) Output Apparatus Correspondence information Storage Unit 114

The output apparatus information storage unit 114 holds the output apparatus identifiers AIDa to AIDn for identifying the plurality of output apparatuses 13a to 13n as shown in FIG. 4, the individual keys IKa to IKn and intermediate key groups MKGa to MKGn that are previously given to each of the output apparatuses 13a to 13n. For example, in FIG. 4, the output apparatus 13a associated with the output apparatus identifier AIDa holds an individual key IKa and an intermediate key group MKGa. The output apparatus 13b associated with the output apparatus identifier AIDb holds the individual key IKb and the intermediate key group MKGb. The output apparatus 13n associated with the output apparatus identifier AIDn holds the individual key IKn and the intermediate key group MKGn. The intermediate key group generation unit 113, the intermediate key group encryption unit 115 and the correspondence information update unit 118 can access to the output apparatus correspondence information storage unit 114.

(5) Intermediate Key Group Encryption Unit 115

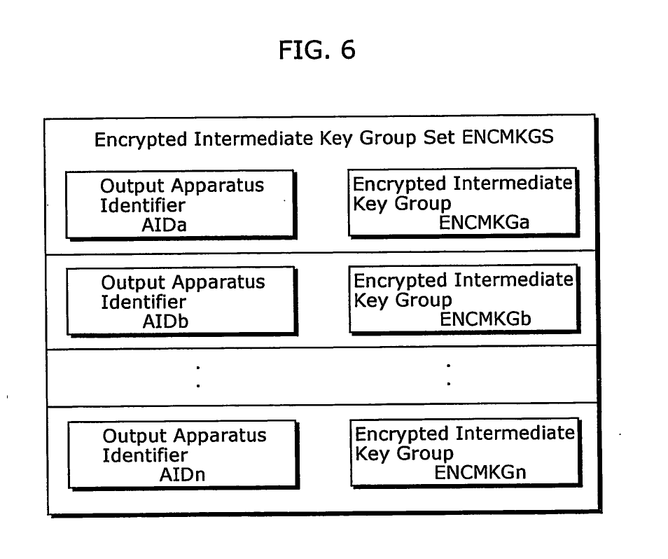

The intermediate key group encryption unit 115, when it receives the encrypted intermediate key group generation request REQ2 from the intermediate key group generation unit 113, accesses to the output apparatus correspondence information storage unit 114 and obtains all of the output apparatus identifiers AIDa to AIDn, the individual keys IKa to IKn and the intermediate key group MKGa to MKGn. Then, the intermediate key group encryption unit 115, firstly for the output apparatus identifier AIDa, encrypts the intermediate key group MKGa based on the corresponding individual key IKa, and associates the cipher text as an encrypted intermediate key group ENCMKGa=Enc (IKa, MKGa), with the output apparatus identifier AIDa. Then, similarly for other output apparatus identifiers AIDb to AIDn, it encrypts intermediate key groups based on corresponding individual keys and associates the cipher texts Enc (IKb, MKGb), . . . , and Enc (IKn, MKGn) as ENCMKGb, . . . , and ENCMKGn respectively with the output apparatus identifiers AIDb to AIDn. The intermediate key group encryption unit 115 then generates an encrypted intermediate key group set ENCMKGS={AIDa, ENCMKGa}∥{AIDb, ENCMKGb} . . . ∥ {AIDn, ENCMKGn}} which is made up of the apparatus identifiers AIDa to AIDn and the encrypted intermediate key group ENCMKGa to ENCMKGn as shown in FIG. 6 and outputs the encrypted intermediate key group set ENCMKGS to the encrypted intermediate key group set distribution unit 116. Here, an encryption algorithm used for encrypting the intermediate key group is for example a DES encryption method which is a block encryption disclosed in the non patent literature 2 and the like (Shinichi Ikeno and Kezo Koyama, The Institute of Electronics, Information and Communication Engineers ed., “Gendai Ango Riron (Modern Cryptography Theory)”). The same method of the decryption algorithm used in each of the encrypted intermediate key group decryption units 138 of the output apparatuses 13a to 13n is used.

(6) Encrypted Intermediate Key Group Set Distribution Unit 116

The encrypted intermediate key group set distribution unit 116, when it receives the encrypted intermediate key group set ENCMKGS from the intermediate key group encryption unit 115, distributes the received encrypted intermediate key group set ENCMKGS to the plurality of output apparatuses 13a to 13n via the communication path 10.

(7) Input Unit 117

The input unit 117 can input, from outside, one of the output apparatus identifiers AIDa to AIDn for respectively identifying the output apparatuses 13a to 13n. When it receives, from outside, one of the output apparatus identifiers AIDa to AIDn, it outputs the received output apparatus identifier to the correspondence information update unit 118. Note that, the input unit 117 is needed only for revoking one of the output apparatuses 13a to 13n. Therefore, when it does not revoke an output apparatus, the input unit 117 may be unnecessary.

(8) Correspondence Information Update Unit 118

The correspondence information update unit 118, when it receives one of the output apparatus identifiers AIDa to AIDn from the input unit 117, accesses to the output apparatus correspondence information storage unit 114 as shown in FIG. 4, and deletes, from the output apparatus correspondence information storage unit 114, the received output apparatus identifier, the individual key corresponding to the output apparatus identifier, and the intermediate key group. For example, in the output apparatus correspondence information storage unit 114 as shown in FIG. 4, when the correspondence information update unit 118 receives the output apparatus identifier AIDa, the corresponding output apparatus identifier AIDa, individual key IKa and intermediate key group MKGa are deleted from the output apparatus correspondence information storage unit 114. After the deletion, the correspondence information update unit 118 outputs the secret parameter group generation request REQ1 to the system secret parameter group generation unit 111. Here, the correspondence information update unit 118, similar to the input unit 117, is necessary only for revoking one of the output apparatuses 13a to 13n. Therefore, when an output apparatus is not revoked, the correspondence information update unit 118 may be unnecessary.

<Operations of Key Issuing Center 11>

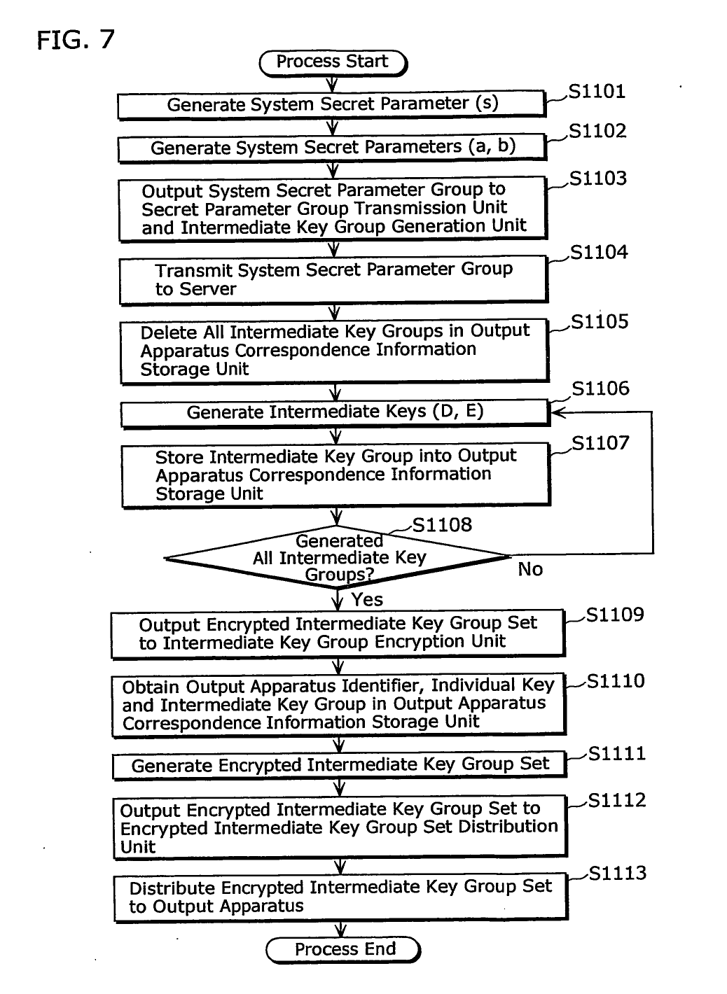

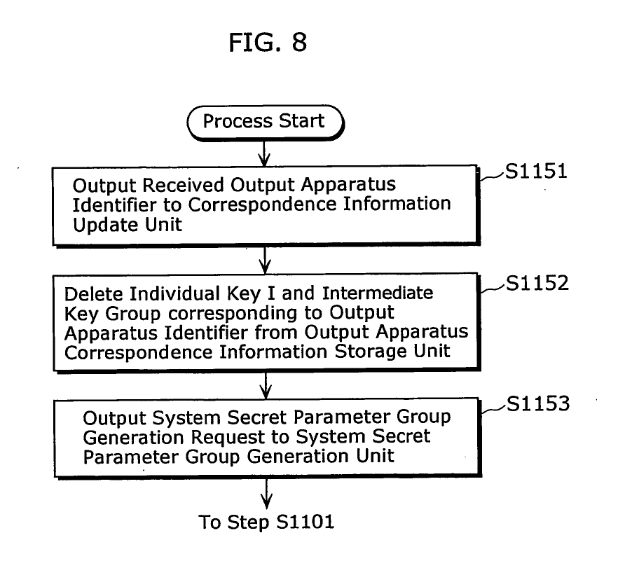

In the above, the structure of the key issuing center 11 is explained. Here, operations of the key issuing center 11 are explained. First, an operation of distributing key information necessary for sharing a content key to the server 12 and the plurality of output apparatuses 13a to 13n is explained using a flowchart shown in FIG. 7. After that, as an example of revoking an output apparatus, an operation of revoking the output apparatus 13a is explained using a flowchart shown in FIG. 8.

<<Operation at Distributing Key Information>>

The system secret parameter group generation unit 111 generates a secret parameter s (S1101).

The system secret parameter group generation unit 111 generates secret parameters a and b so as to satisfy a pre-given secret parameter generation equation “a*a−b*b=0 mod N” (S1102).

It generates a system secret parameter group SPG which is made up of the generated parameters s, a and b and outputs the system secret parameter group SPG to the system secret parameter group transmission unit 112 and the intermediate key group generation unit 113 (S1103).

The system secret parameter group transmission unit 112 transmits the received system secret parameter group SPG to the server 12 (S1104).

The intermediate key group generation unit 113 deletes all of the intermediate key groups MKGa to MKGn stored in the output apparatus correspondence information storage unit 114 (S1105).

The intermediate key group generation unit 113 generates individualized parameters x and y which satisfy a pre-given individualized parameter generation equation “x*a−y*b=1 mod N”. Herein, the generated individualized parameter x and y should not be the same value. For example, it can be embodied by storing the pre-generated individualized parameter and verifying that the pre-generated individualized parameter does not match with the newly generated individualized parameter.

Using the individualized parameters x and y, the intermediate key group generation unit 113 generates the intermediate keys D and E which respectively satisfy pre-given intermediate key generation equations “D=s*x mod N” and “E=s*y mod N” (S1106).

The intermediate key group generation unit 113 generates an intermediate key group which is made up of the intermediate keys D and E and stores the intermediate key group by associating with any one of the output apparatus identifiers AIDa to AIDn to which an intermediate key group has not assigned in the output apparatus correspondence information storage unit 114 (S107).

If the intermediate key groups MKGa to MKGn are respectively assigned to all of the output apparatus identifiers AIDa to AIDn stored in the output apparatus correspondence information storage unit 114, the operation moves on to a step S1109. If some of the output apparatus identifiers AIDa to AIDn remain unassigned, the operation returns to step S1106 (S1108).

The intermediate key group generation unit 113 outputs the encrypted intermediate key group set generation request REQ2 to the intermediate key group encryption unit 115 (S1109).

The intermediate key group encryption unit 115 which received the encrypted intermediate key group set generation request REQ2 accesses to the output apparatus correspondence information storage unit 114 and obtains all of the output apparatus identifiers AIDa to AIDn, individual keys IKa to IKn and intermediate key groups MKGa to MKGn (S1110).

The intermediate key group encryption unit 115 encrypts each of the intermediate key groups MKGa to MKGn based on each of the individual keys IKa to IKn and generates an encrypted intermediate key group set ENCMKGS made up of the encrypted intermediate key groups ENCMKGa to ENCMKGn and the output apparatus identifiers AIDa to AIDn respectively corresponding to the individual keys IKa to IKn used for the encryption (S1111).

The intermediate key group encryption unit 115 outputs the generated encrypted intermediate key group set ENCMKGS to the encrypted intermediate key group set distribution unit 116 (S1112).

The encrypted intermediate key group set distribution unit 116 receives the encrypted intermediate key group set ENCMKGS, distributes the received encrypted intermediate key group set ENCMKGS to the plurality of output apparatuses 13a to 13n, and terminates the operation (S1113).

<<Operation at Revoking Output Apparatus 13a>>

The input unit 117 outputs the received output apparatus identifier AIDa to the correspondence information update unit 118 (S1151).

The correspondence information update unit 118 deletes the output apparatus identifier AIDa received from the input unit 117, the individual key IKa corresponding to the output apparatus identifier AIDa and the intermediate key group MKGa from the output apparatus correspondence information storage unit 114 (S1152).

The correspondence information update unit 118 outputs the secret parameter group generation request REQ1 to the system secret parameter group generation unit 111 and moves on to the step S1101 (S1153).

Note that operations of revoking each of the output apparatuses 13b to 13n other than the output apparatus 13a are almost same as that of the output apparatus 13a. However, it differs in that, in the correspondence information update unit 118, an output apparatus identifier, individual key and intermediate key group to be deleted from the output apparatus correspondence information storage unit 114 change depending on the output apparatuses 13b to 13n to be revoked.

They are the explanations about the structure and operations of the key issuing center 11. Next, the structure and operations of the server 12 are explained.

<Structure of Server 12>

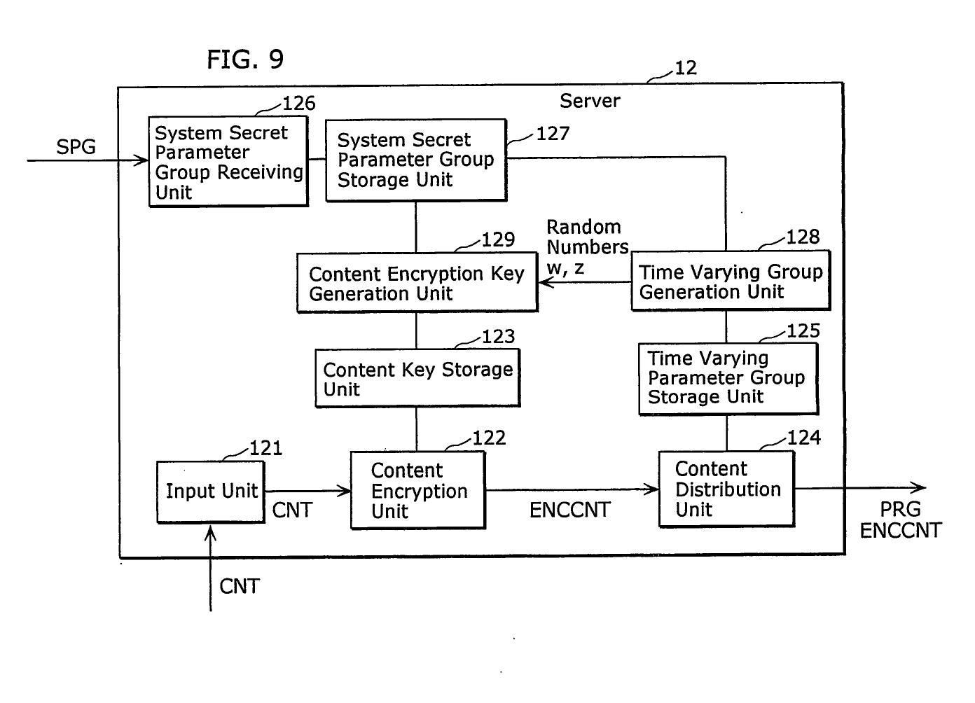

As shown in FIG. 9, the server 12 is made up of an input unit 12L, a content encryption unit 122, a content key storage unit 123, a content distribution unit 124, a time varying parameter group storage unit 125, a system secret parameter group receiving unit 126, a system secret parameter group storage unit 127, a time varying parameter group generation unit 128, and a content encryption key generation unit 129.

(1) Input Unit 121

The input unit 121 can input the content CNT from outside. The content CNT inputted from outside is in a format which can be outputted from the output apparatuses 13a to 13n. For example, it is video data in a MPEG format, audio data in a MP3 format and the like. The input unit 121 outputs the received content CNT to the content encryption unit 122 when it receives the content CNT from outside.

(2) Content Encryption Unit 122

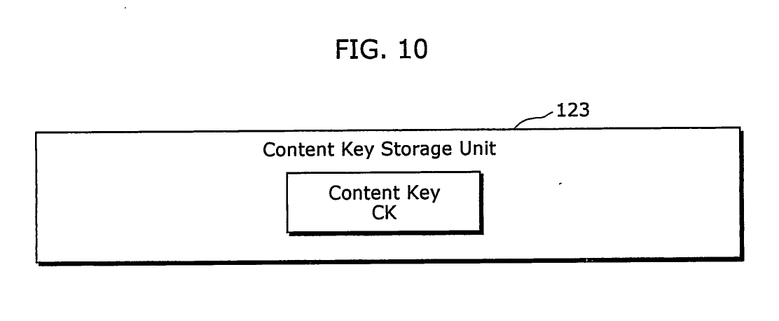

The content encryption unit 122, in the case of receiving the content CNT from the input unit 121, accesses to the content key storage unit 123 as shown in FIG. 10, obtains a content key CK and encrypts, in sequence, the content CNT inputted from the input unit 121 based on the obtained content key CK. Here, an encryption algorithm used for encrypting the content CNT is, for example, a DES encryption method of block encryption and the like and uses the same method as a decryption algorithm used for decrypting the encrypted content ENCCNT in the content decryption unit 135 of each of the output apparatuses 13a to 13n which are described later. After that, the content encryption unit 122 outputs the encrypted content ENCCNT to the content distribution unit 124.

(3) Content Key Storage Unit 123

The content key storage unit 123 holds the content key CK as shown in FIG. 10. The content key CK is an encryption key of the content CNT and an encryption key of the encryption algorithm used in the content encryption unit 122.

(4) Content Distribution Unit 124

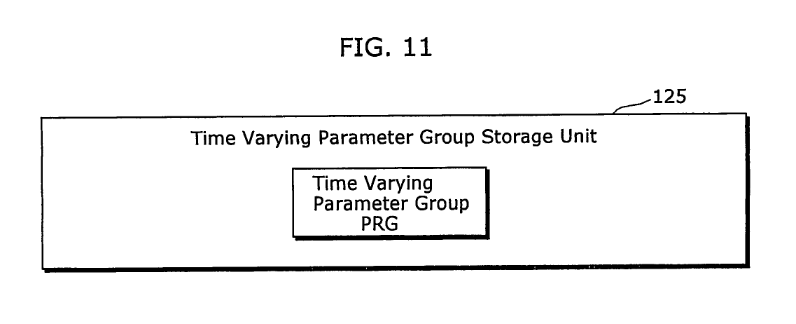

The content distribution unit 124 obtains in sequence a time varying parameter group PRG as shown in FIG. 11 stored in the time varying parameter group storage unit 125 which is described later, and distributes the encrypted content ENCCNT received from the content encryption unit 122 and the time varying parameter group PRG to the plurality of output apparatuses 13a to 13n through a communication path 10.

(5) Time Varying Parameter Group Storage Unit 125

The time varying parameter group storage unit 125 holds the time varying parameter group PRG as shown in FIG. 11

(6) System Secret Parameter Group Receiving Unit 126

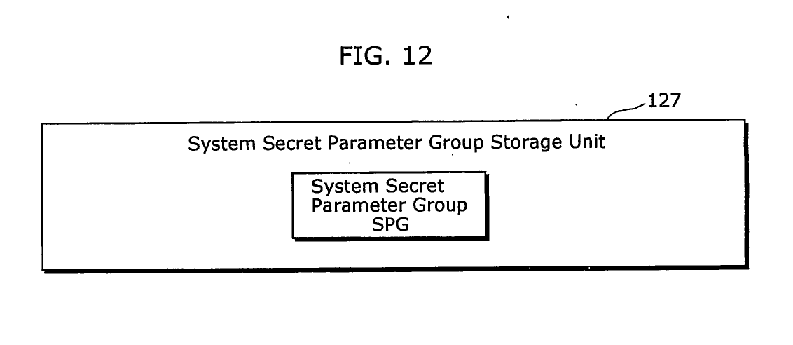

The system secret parameter group receiving unit 126, when it receives a system secret parameter group SPG from the key issuing center 11, stores the received system secret parameter group SPG into the system secret parameter group storage unit 127 as shown in FIG. 12.

(7) System Secret Parameter Group Storage Unit 127

The system secret parameter group storage unit 127 holds the system secret key group SPG as shown in FIG. 12. The system secret parameter group receiving unit 126, the time varying parameter group generation unit 128 and the content encryption key generation unit 129 can access to the system secret parameter storage unit 127.

(8) Time Varying Parameter Group Generation Unit 128

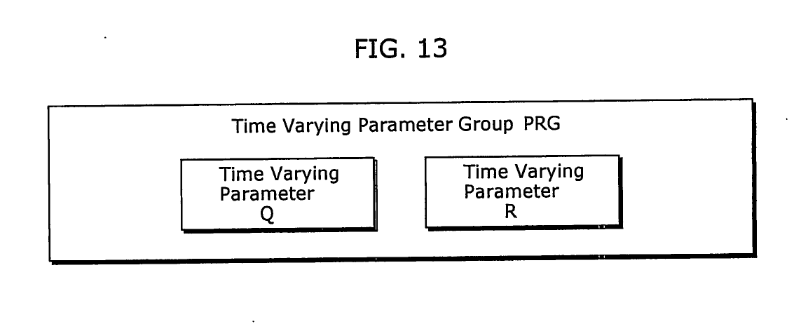

A time varying parameter group update condition is previously given to the time varying parameter group generation unit 128, and the time varying parameter group generation unit 128 generates two random numbers of z and w when the condition is satisfied. Here, the random numbers of z and w are, for example, respectively natural numbers of 128 bits. Also, the time varying parameter group generation unit 128 accesses to the system secret parameter group storage unit 127, obtains system secret parameter groups SPG, and extracts the secret parameters a and b from among them. It then generates two time varying parameters Q and R based on pre-given two time varying parameter generation equations of “Q=z*a+w*b mod N” and “R=z*b+w*a mod N”. After that, it generates a time varying parameter group PRG as shown in FIG. 13 and stores the time varying parameter group PRG into the time varying parameter group storage unit 125. Lastly, it outputs random numbers z and w to the content encryption key generation unit 129. For example, the time varying parameter group update condition is “every one hour”, “per day” and the like. This condition can be realized by setting a counter in the time varying parameter group generation unit 128 and the like. Here, the time varying parameter group generation unit 128 may receive a time varying parameter request signal from outside and generate the time varying parameter group PRG when the time parameter update request signal is received.

(9) Content Encryption Key Generation Unit 129

The content encryption key generation unit 129, in the case of receiving random numbers z and w from the time varying parameter group generation unit 128, firstly accesses to the system secret parameter group storage unit 127, obtains the system secret parameter group SPG and extracts a secret parameters therefrom. After that, it generates a content key CK based on a pre-given content encryption key generation equation “CK=s*z+s*w*a/b mod N” and stores the generated content key CK into the content key storage unit 123.

<Operations of Server 12>

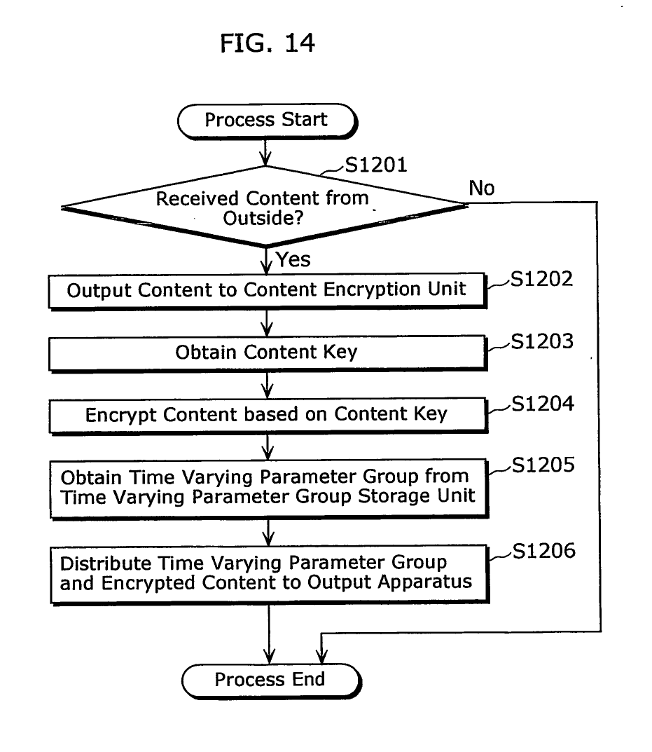

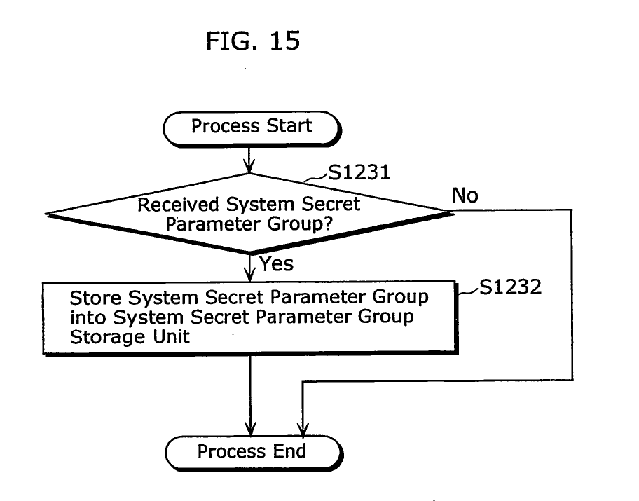

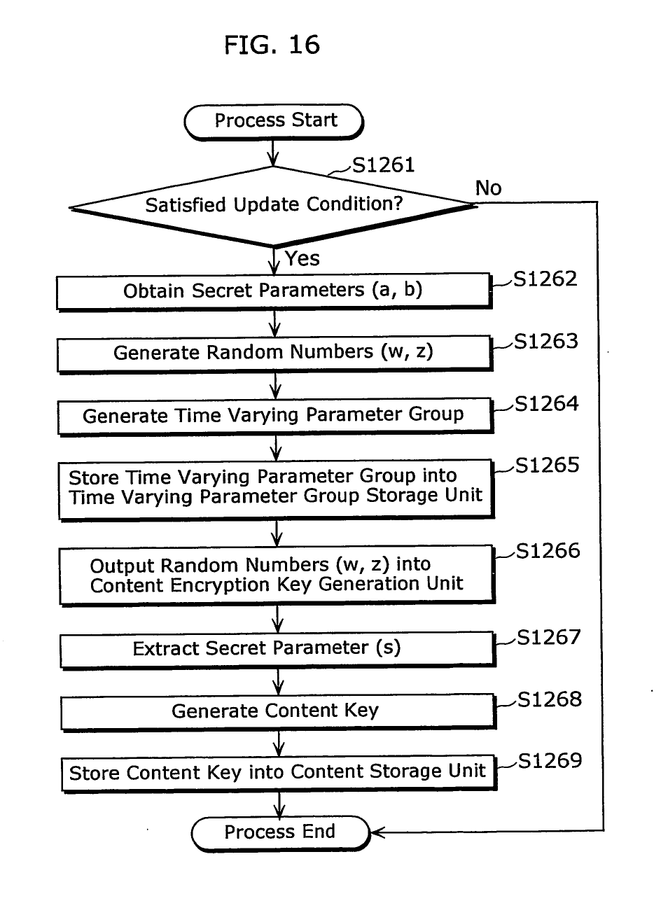

In the above, the structure of the server 12 is explained. Here, it is explained about operations of the server 12. First, it is explained about an operation at which the server 12 distributes the content CNT to the output apparatuses 13a to 13n using a flowchart shown in FIG. 14. Then, it is explained about an operation when the server 12 receives a system secret parameter group SPG used for sharing a content key CK from the key issuing center 11 using a flowchart shown in FIG. 15. Lastly, an operation of updating the time varying parameter group PRG is explained using a flowchart shown in FIG. 16.

<<Operation at Distributing Content to Output Apparatuses 13a to 13n>>

When the receiving unit 121 receives content CNT from outside, an operation moves on to step S1202. When it does not receive the content CNT, the operation is terminated (S1201).

The receiving unit 121 outputs the received content CNT to the content encryption unit 122 (S1202).

Next, the content encryption unit 122 which received the content CNT accesses to the encryption storage unit 113 and obtains the content key CK (S1203).

The content encryption unit 122 encrypts the content CNT based on the content key CK and outputs the encrypted content ENCCNT to the content distribution unit 124 (S1204).

The content distribution unit 124 which received the encrypted content ENCCNT accesses to the time varying parameter storage unit 125 and obtains the time varying parameter group PRG (S1205).

The content distribution unit 124 distributes the time varying parameter group PRG and the encrypted content ENCCNT to the output apparatuses 13a to 13n and terminates the operation (S1206).

<<Operation at Receiving System Secret Parameter Group SPG from Key Issuing Center 11>>

When the system secret parameter group receiving unit 126 receives the system secret parameter group SPG from the key issuing center 11, the operation moves on to step S1232. When it does not receive the system secret parameter group SPG, the operation is terminated (S1231).

The system secret parameter group receiving unit 126 stores the received system secret parameter group SPG into the system secret parameter group storage unit 127 and the operation is terminated (S1232).

<Operation at Updating Time Varying Parameter Group PRG>>

When the time varying parameter group generation unit 128 satisfies the pre-given time varying parameter group update condition, an operation moves on to step S1262. When it does not satisfy the time varying parameter group update condition, the operation is terminated (S1261).

The time varying parameter group generation unit 128 accesses to the system secret parameter group storage unit 127, obtains a system secret parameter group SPG and extracts a second secret parameter a and a third secret parameter b therefrom (S1262).

The time varying parameter group generation unit 128 generates random numbers z and w (S1263).

The time varying parameter group generation unit 128 generates time varying parameters Q and R respectively based on the pre-given time varying parameter generation equations “Q=a*z+b*w mod N” and “R=b*z+a*w mod N” and generates a time varying parameter group PRG which is made up of the generated time varying parameters Q and R (S1264).

The time varying parameter group generation unit 128 stores the time varying parameter group PRG into the time varying parameter group storage unit 125 (S1265).

The time varying parameter group generation unit 128 outputs random numbers z and w to the content encryption key generation unit 129 (S1266).

The content encryption key generation unit 129 which received the random numbers z and w firstly accesses to the system secret parameter group storage unit 127, obtains the system secret parameter group SPG and extracts a secret parameter s therefrom (S1267).

The content encryption key generation unit 129 generates a content key CK based on a pre-given content encryption key generation equation “CK=s*z+s*w*a/b mod N” (S1268).

The content encryption key generation unit 129 stores the obtained content key CK into the content key storage unit 123 and the operation is terminated (S1269).

The above is the structure and operations of the server 12 which is a constituent of the content distribution system 1. Following that, structures and operations of the output apparatuses 13a to 13n are explained. First, the structure and operations of the output apparatus 13a is explained followed by the explanation about differences between the output apparatus 13a and other output apparatuses 13b to 13n.

<Structure of Output Apparatus 13a>

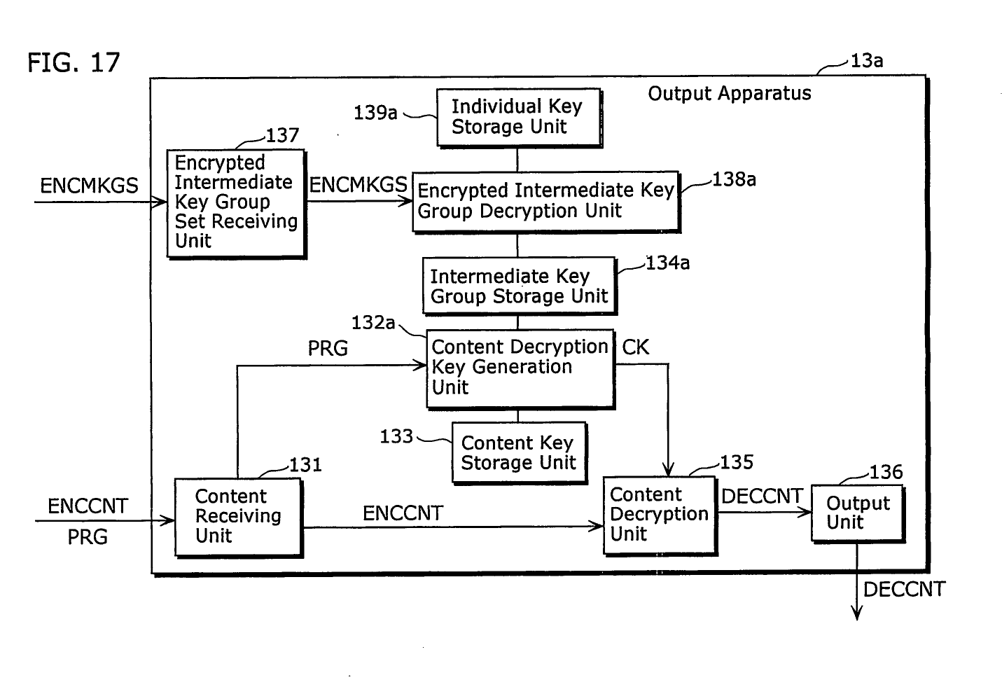

As shown in FIG. 17, the output apparatus 13a is made up of a content receiving unit 131, a content decryption key generation unit 132a, a content key storage unit 133, an intermediate key group storage unit 134a, a content decryption unit 135, an output unit 136, an encrypted intermediate key group set receiving unit 137, an encrypted intermediate key group decryption unit 138a, and an individual key storage unit 139a. Here, the content receiving unit 131, the content key storage unit 133, the content decryption unit 135, the output unit 136, and the encrypted intermediate key group set and the encrypted intermediate key group set receiving unit 137 are constituents common to the output apparatuses 13a to 13n. On the other hand, the content decryption key generation unit 132a, the intermediate key group storage unit 134a, the encrypted intermediate key group decryption unit 138a and the individual key storage unit 139a are constituents of the output apparatus 13a.

(1) Content Receiving Unit 131

In the case of receiving the encrypted content ENCCNT and the time varying parameter group PRG from the server 12, the content receiving unit 131 outputs the received time varying parameter group to the content decryption key generation unit 132a and then outputs the encrypted content ENCCNT to the content decryption unit 135.

(2) Content Decryption Key Generation Unit 132a

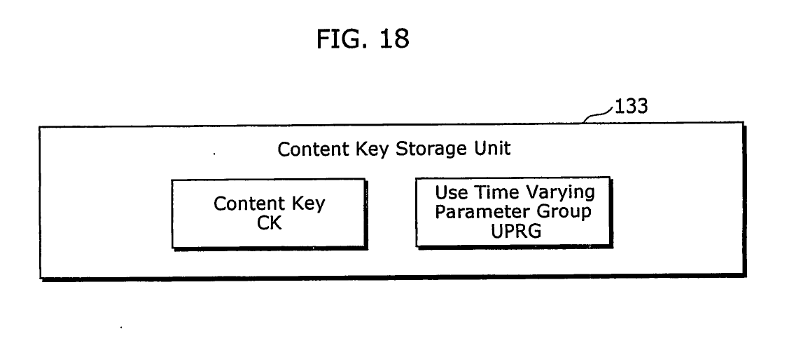

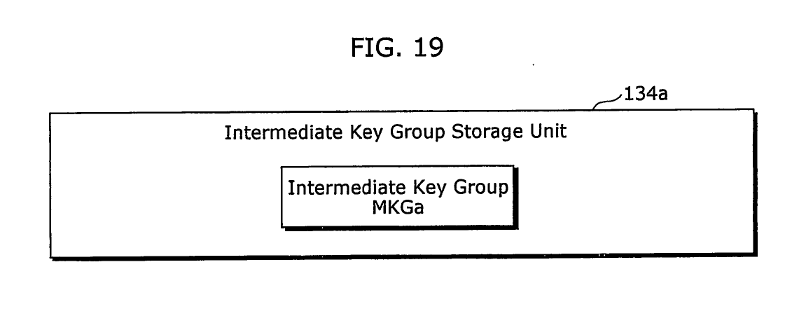

In the case of receiving the time varying parameter group PRG from the content receiving unit 131, the content decryption key generation unit 132a firstly accesses to the content key storage unit 133 as shown in FIG. 18 and verifies whether a use time varying parameter group UPRG stored in the content key storage unit 133 matches with the received time varying parameter group PRG. Here, if they match with each other, the content decryption key generation unit 132a accesses to the content key storage unit 133 and outputs the stored content key CK to the content decryption unit 135. If they do not match with each other, it accesses to the intermediate key group storage unit 134a as shown in FIG. 19 and obtains an intermediate key group MKGa. It then extracts intermediate keys D and E from the intermediate key group MKGa. After that, it generates a content key CK based on a pre-given content decryption key generation equation “CK=D*Q−E*R mod N”, stores the generated content key CK into the content key storage unit 133, stores the time varying parameter group PRG as the use time varying parameter UPR into the content key storage unit 133 and lastly outputs the content key CK to the content decryption unit 135.

(3) Content Key Storage Unit 133

The content key storage unit 133 holds the content key CK and the use time varying parameter group UPRG as shown in FIG. 18. The content decryption key generation unit 132a can access to the content key storage unit 133.

(4) Intermediate Key Group Storage Unit 134a

As shown in FIG. 19, the intermediate key group storage unit 134a holds the intermediate key group MKGa. The content decryption key generation unit 132a and the encrypted intermediate key group decryption unit 138a can access to the intermediate key group storage unit 134a.

(5) Content Decryption Unit 135

The content decryption unit 135 receives the encrypted content ENCCNT from the content receiving unit 131 and, in the case of receiving the content key CK from the content decryption key generation unit 132a, decrypts the encrypted content ENCCNT based on the content key CK. A decryption algorithm used for the decryption is, for example, a DES method of block encryption and the like and uses the same method as the encryption algorithm used in the content encryption unit 122 of the server 12. The content decryption unit 135 outputs the decrypted decryption content DECCNT=Dec (CK, ENCCNT) to the output unit 136. Here, Dec (K, C) is a decryption text when the cipher text C is decrypted based on the decryption key K.

(6) Output Unit 136

The output unit 136 outputs the received decrypted content DECCNT to the outside in the case of receiving the decrypted content DECCNT from the content decryption unit 135.

(7) Encrypted Intermediate Key Group Set Receiving Unit 137

The encrypted intermediate key group set receiving unit 137, in the case of receiving an encrypted intermediate key group set ENCMKGS={AIDa, ENCMKGa}∥ . . . ∥{AIDn, ENCMKGn} as shown in FIG. 6 from the server 12, outputs the received encrypted intermediate key group set ENCMKGS to the encrypted intermediate key group decryption unit 138a.

(8) Encrypted Intermediate Key Group Decryption Unit 138a

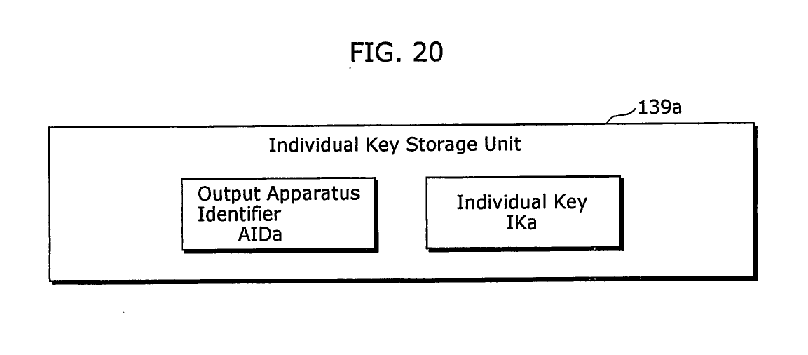

The encrypted intermediate key group decryption unit 138a, in the case of receiving an encrypted intermediate key group set ENCMKGS={AIDa, ENCMKGa}∥ . . . ∥{AIDn, ENCMKGn} from the encrypted intermediate key group set receiving unit 137, first obtains the output apparatus identifier AIDa and the individual key IKa from the individual key storage unit 139a as shown in FIG. 20 and obtains the encrypted intermediate key group ENCMKGa corresponding to the output apparatus identifier AIDa from the received encrypted intermediate key group set ENCMKGS. It then decrypts the corresponding encrypted intermediate key group ENCMKGa=Enc (IKa, MKGa) based on the individual key IKa stored in the individual key storage unit 139a. It stores the decrypted intermediate key group MKGa into the intermediate key group storage unit 134a.

(9) Individual Key Storage Unit 139a

As shown in FIG. 20, the individual key storage unit 139a holds the output apparatus identifier AIDa and an individual key IKa. The encrypted intermediate key group decryption unit 138a can access to the individual key storage unit 139.

<Operations of Output Apparatus 13a>

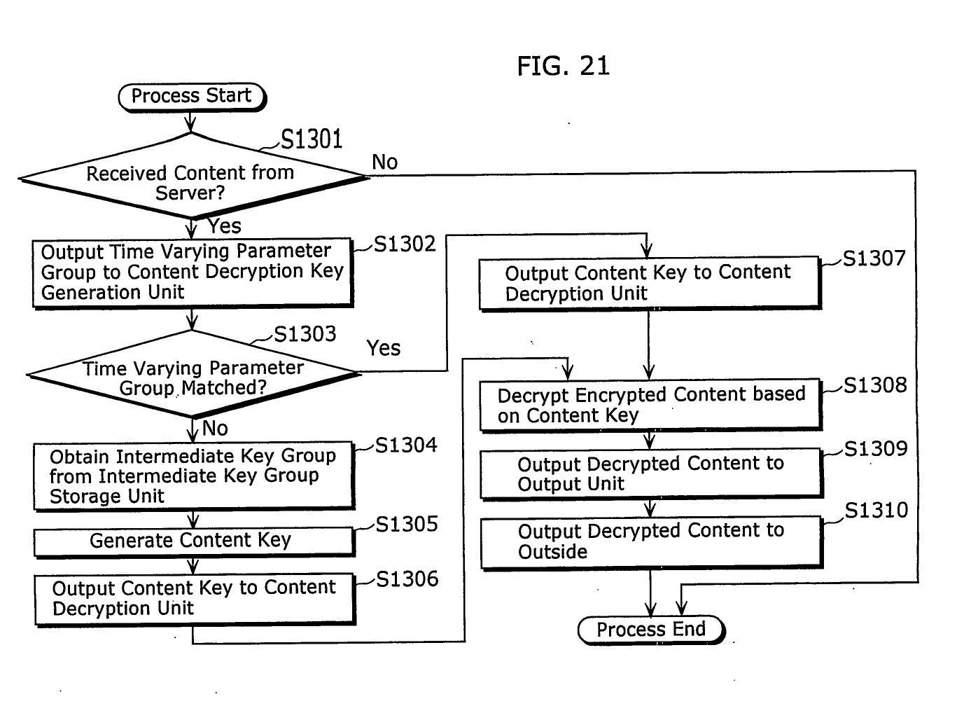

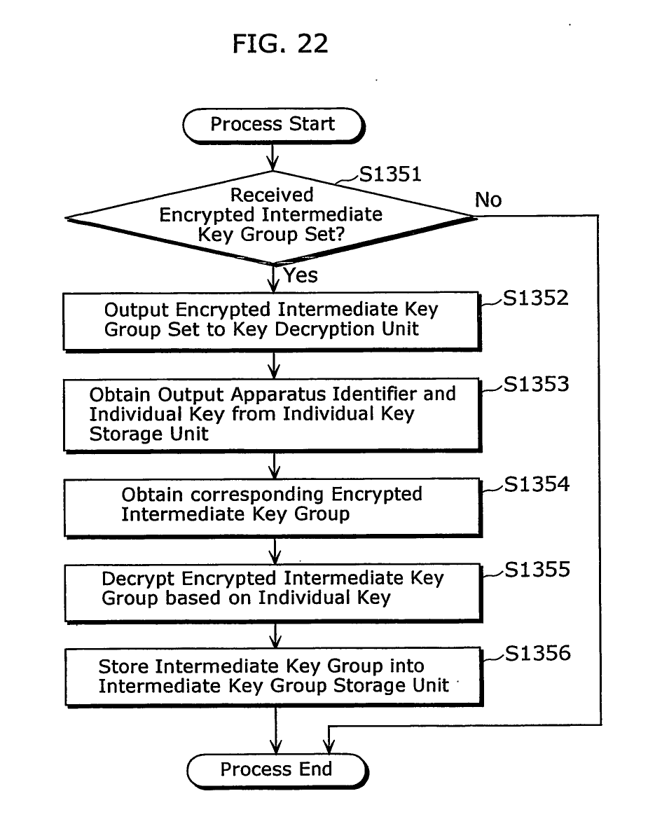

In the above, the structure of the output apparatus 13a is explained. Here, it is explained about the operation of the output apparatus 13a. First, an operation in the case where the output apparatus 13a receives an encrypted content ENCCNT from the server 12 is explained using a flowchart shown in FIG. 21. Next, an operation in the case where the output apparatus 13a receives an encrypted intermediate key group set ENCMKGS including information relating to the intermediate key group MKGa used for sharing a content key CK of an encrypted content ENCCNT is explained using a flowchart shown in FIG. 22.

<<Operation at Receiving Encrypted Content from Server 12>>

In the case where the content receiving unit 131 receives an encrypted content ENCCNT and a time varying parameter group PRG, an operation moves on to step S1302. When it does not receive them, the operation is terminated (S1301).

The content receiving unit 131 outputs the received time varying parameter group PRG to the content decryption key generation unit 132a (S1302).

The content decryption key generation unit 132a which received the time varying parameter group PRG accesses to the content key storage unit 133 and verifies whether the received time varying parameter group PRG and the use-time varying parameter group UPRG are the same value. If the values are the same, the operation moves on to step S1307. If they are different, the operation moves on to Step S1304 (S1303).

The content decryption key generation unit 132a accesses to the intermediate key group storage unit 134a and obtains the intermediate key group MKGa (S1304).

The content decryption key generation unit 132a extracts intermediate keys D and E from the intermediate key group MKGa, extracts time varying parameters Q and R from the time varying parameter group PRG and generates a content key CK based on a pre-given content decryption key generation equation “CK=(D*Q)−(E*R) mod N” (S1305).

The content decryption key generation unit 132a outputs the content key CK to the content decryption unit 135 and the operation moves on to step S1308 (S1306).

The content decryption key generation unit 132a accesses to the intermediate key group storage unit 134a, obtains a content key CK, and outputs the content key CK to the content decryption unit 135 (S1307).

The content decryption unit 135 decrypts the encrypted content ENCCNT based on the received content key CK and obtains the decrypted content DECCNT (S1308).

The content decryption unit 135 outputs the decrypted content DECCNT to the output unit 136 (S1309).

The output unit 136 receives the decrypted content DECCNT from the content decryption unit 135, outputs the received decrypted content DECCNT to the outside and terminates the operation (S1310).

<<Operation at Receiving Encrypted Intermediate Key Group Set ENCMKGS>>

In the case where the encrypted intermediate key group set receiving unit 137 receives the encrypted intermediate key group set ENCMKGS, an operation moves on to step S1352. When it does not receive the encrypted intermediate key group set ENCMKGS, the operation is terminated (S1351).

The encrypted intermediate key group set receiving unit 137 outputs the received encrypted intermediate key group set ENCMKGS to an encrypted intermediate key group decryption unit 138a (S1352).

The encrypted intermediate key group decryption unit 138a obtains an output apparatus identifier AIDa and an individual key IKa from the individual key storage unit 139a (S1353).

The encrypted intermediate key group decryption unit 138a obtains an encrypted intermediate key group ENCMKGa=Enc (IKa, MKGa) corresponding to the output apparatus identifier AIDa from the received encrypted intermediate key group set ENCMKGS (S1354).

The encrypted intermediate key group decryption unit 138a decrypts the encrypted intermediate key group ENCMKGa based on the individual key IKa and obtains the intermediate key group MKGa (S1355).

The encrypted intermediate key group decryption unit 138a stores the intermediate key group MKGa into the intermediate key group storage unit 134a and terminates the operation (S1356).

These are the structure and operations of the output apparatus 13a which is one of the constituents of the content distribution system 1. Here, the differences between the output apparatus 13a and other output apparatuses 13b to 13n are i) that intermediate key groups MKGa to MKGn respectively unique to the output apparatuses 13a to 13n are stored in the intermediate key group storage unit 134a, ii) that output apparatus identifiers AIDa to AIDn and individual keys IKa to IKn respectively unique to the output apparatuses 13a to 13n are stored in the individual key storage unit 139a, iii) that the content decryption key generation unit 132a uses intermediate key groups MKGa to MKGn respectively unique to the output apparatus 13a to 13n, and iv) that the encrypted intermediate key group decryption unit 138a uses individual keys IKa to IKn respectively unique to the output apparatuses 13a to 13n.

<Verification of Operations in First Embodiment>

In the first embodiment, it is explained about the reason why the same content key CK can be derived from all of the output apparatuses 13a to 13n in spite of the fact that different intermediate key groups MKGa to MKGn are respectively assigned to the output apparatuses 13a to 13n. First, each of the intermediate key groups MKGa to MKGn is made up of the intermediate keys D and E which respectively satisfy a pre-given intermediate key generation equations “D=s*x mod N” and “E=s*y mod N”. Also, the time varying parameter group PRG is generated so as to satisfy the time varying parameter generation equations “Q=a*z+b*w mod N” and “R=b*z+a*w mod N”. Accordingly, the content decryption key generation equation of “CK=(D*Q)−(E*R) mod N” is modified to:

$$\begin{matrix}CK = ( D * Q ) - ( E * R ) \\ = ( s * x ) * ( a * z + b * w ) - ( s * y ) * ( b * z + a * w ) \\ = s * z * ( x * a - y * b ) + s * w * ( x * b - y * a )\end{matrix}$$

Here, assigning a condition of “x*a−y*b=1” and an equation obtained from the condition “y=(x*a−1)/b”,

$$… = s * z * 1 + s * w * ( x * b - ( ( x * a - 1 ) / b ) * a ) \\ = s * z + s * w * ( x * ( b * b - a * a ) + a ) / b$$

Here, the secret parameters a and b are previously generated so as to satisfy a secret parameter generation equation “a*a−b*b=0 mod N”. Therefore,
. . . =s*z+s*w*a/b
This is composed of only the common parameter to all output apparatuses 13a to 13n. Therefore, all of the output apparatuses 13a to 13n derives a common value of the encryption key CK. Further, it matches with the content encryption key generation equation “CK=s*z+s*w*a/b”.

<Effect of First Embodiment>

In the first embodiment of the present invention, the content key CK used for decrypting the content CNT is generated from the intermediate key group and the time varying parameter group PRG. Accordingly, an unauthorized output apparatus in which only the content key CK is embedded cannot update to the next content key even if it receives the time varying parameter group PRG. Further, against an unauthorized output apparatus in which intermediate key group is embedded, based on correspondence information of the intermediate key group and output apparatus identifier included in the output apparatus correspondence information storage unit 114 of the key issuing center 11, it can be specified about which individual key among the individual keys KIa to KIn embedded in one of the output apparatuses 13a to 13n becomes the basis of generating the intermediate key group. In consequence with the two, an unauthorized output apparatus can be specified and revoked.

<Variations of First Embodiment>

The embodiment explained in the above is an example of embodiments of the present invention. The present invention is not restricted to the embodiment so that it can be embodied in main condition in a range within the context. The present invention also includes following cases.

(1) The communication path 10 may be a terrestrial wave or a broadcasting network such as a satellite.

(2) Whereas each of the intermediate keys MKGa to MKGn is made up of two intermediate keys D and E, they may be made up of three or more different kinds.

(3) Whereas the time varying parameter group PRG is made up of two time varying parameters Q and R, it may be made up of three or more different kinds.

(4) In the system secret parameter group generation unit 111, following may be applied: that secret parameters s, a, b and c are generated, for example, as natural numbers of 128 bits; further that a pre-given individualized parameter generation equation in the intermediate key group generation unit 113 is defined as “x*a+y*b=1 mod N”; that three intermediate key generation equations are defined as “D=s−x mod N”, “E=s−y mod N” and “F=b*x+a*y+c”; that the intermediate key group is made up of D, E and F; that two time varying parameter generation equations previously given to the time varying parameter group generation unit 128 is defined as “Q=a*z+b mod N” and “R=b*z+a mod N”; that a content encryption key generation equation previously given to the time varying parameter group generation unit 129 is defined as “CK=s*(z+1)*(a+b)−z+c mod N”; and that a content decryption key generation equation previously given to the content decryption key generation unit 132 is defined as a “CK=D*Q+E*R+F mod N”.

(5) In the system secret parameter group generation unit 111, following may be applied: that secret parameters s, a and b are generated, for example, as natural numbers of 128 bits; that modules N in the intermediate key group generation unit 113, the time varying group generation unit 128, the content encryption key generation unit 129, and the content decryption key generation unit 132 as prime numbers of 128 bits; further that a natural number g of 128 bits is, for example, given commonly to the intermediate key group generation unit 113, the time varying parameter group generation unit 128, the content encryption key generation unit 129, and the content decryption key generation unit 132; further that an individualized parameter generation equation previously given to the intermediate key group generation unit 113 may be as “x*a+y*b=1 mod (N−1)”; that two intermediate key generation equations may be as “D=s*x mod (N−1)” and “E=s*y mod (N−1)”; that two time varying parameter generation equations previously given to the time varying parameter generation unit 128 may be as “Q=gˆ{z*a} mod N” and “R=gˆ{z*b} mod N”; that the content encryption key generation equation of the content encryption key generation unit 129 may be as “CK=gˆ{s*z} mod N”; and that the content decryption key generation equation of the content decryption key generation unit 132 may be as “CK=Qˆ{D}*Rˆ{E} mod N”.

Even if different intermediate key groups MKGa to MKGn are respectively assigned to each of the output apparatuses 13a to 13n, the same content key CK can be derived from all of the output apparatuses 13a to 13n. Because, when the intermediate key generation equation and the time varying parameter generation equation are assigned to the content decryption key generation equation, the result matches to the content encryption key generation equation which made up of only the common parameters of all output apparatuses 13a and 13b.

(6) The key issuing center 11 may transmit the intermediate key group to the system server 12 in place of the system secret parameter group SPG.

(7) The server 12 may play the role of the key issuing center 11. That is, the server 12 receives any one of the output apparatus identifiers AIDa to AIDn and distributes, to the plurality of output apparatuses 13a to 13n, the encrypted intermediate key group set ENCMKGS based any one of the output apparatus identifiers AIDa to AIDn.

(8) The intermediate key group generation unit 113 of the key issuing center 11 may receive the intermediate key group generation request information REQ3 from outside and generate the plurality of intermediate key groups MKGa to MKGn based on the intermediate key group generation request information REQ3.

(9) The time varying parameter group generation unit 128 of the server 12 may receive the time varying parameter group generation request information REQ4 from outside and generate the time varying parameter group PRG based on the time varying parameter group generation request information REQ4.

(10) The content distribution unit 124 of the server 12, in the case where there is no change from the time varying parameter group PRG which is transmitted before, transmits only the encrypted content ENCCNT to the output apparatuses 13a to 13n. The output apparatuses 13a to 13n which received only the encrypted content ENCCNT may decrypt the encrypted content ENCCNT based on the content key CK stored in the content key storage unit 133.

(11) In the case where the content key storage unit 133 of the output apparatuses 13a to 13n does not include the use time varying parameter group UPRG and the decryption generation unit 132a receives the time varying parameter group PRG, the decryption generation unit 132a may always generate a content key CK from the intermediate key group and the time varying parameter group PRG and output the content key CK to the content decryption unit 135.

(12) Whereas in the first embodiment, the number of output apparatuses are 14 (13a to 13n), the number of output apparatuses may be 15 or more, or 13 or less.

(13) In the case where the key issuing center 11 distributes an encrypted intermediate key group set ENCMKGS, the key issuing center 11 may distribute it at the same time or distribute it separately to the output apparatuses 13a to 13n.

(14) The present invention may be a method as described above. Also, it may be a computer program for causing a computer to implement these methods and be a digital signal which is formed by the computer program. Also, the present invention may be a recording medium by which a computer can read the computer program or the digital signal. For example, it may be stored in a flexible disk, a hard disk, a CD-ROM, an MO, a DVD, a DVD-ROM, a DVD-RAM, a Blu-ray Disc (BD), a semiconductor memory and the like. Further, the present invention may be the computer program or the digital signal stored in these recording mediums. Furthermore, the present invention may transmit the computer program or the digital signal via a telecommunication line, wireless, wire communication line, and a network, notably the Internet, and the like. Also, the present invention is a computer system having a microprocessor and a memory. The memory stores the computer program and the microprocessor operates according to the computer program. Further, the present invention is embodied by other independent computer system by transferring the program and the digital signal by storing them in the recording medium or by transferring them via the network.

(15) The above embodiment and variations may be respectively combined to each other.

### Second Embodiment

It is explained about a content distribution system 2 as an embodiment according to the present invention. In the content distribution system 1 in the first embodiment, each of the output apparatuses 13a to 13n generates a content key CK based on one pair of intermediate key D and E. However, the content distribution system 2 in the second embodiment differs with the first embodiment in that each output apparatus generates a content key based on a plurality of sets of intermediate keys.

Hereafter, it is explained in detail about the content distribution system 2 which is an embodiment of a content distribution system of the present invention.

<Structure of Content Distribution System 2>

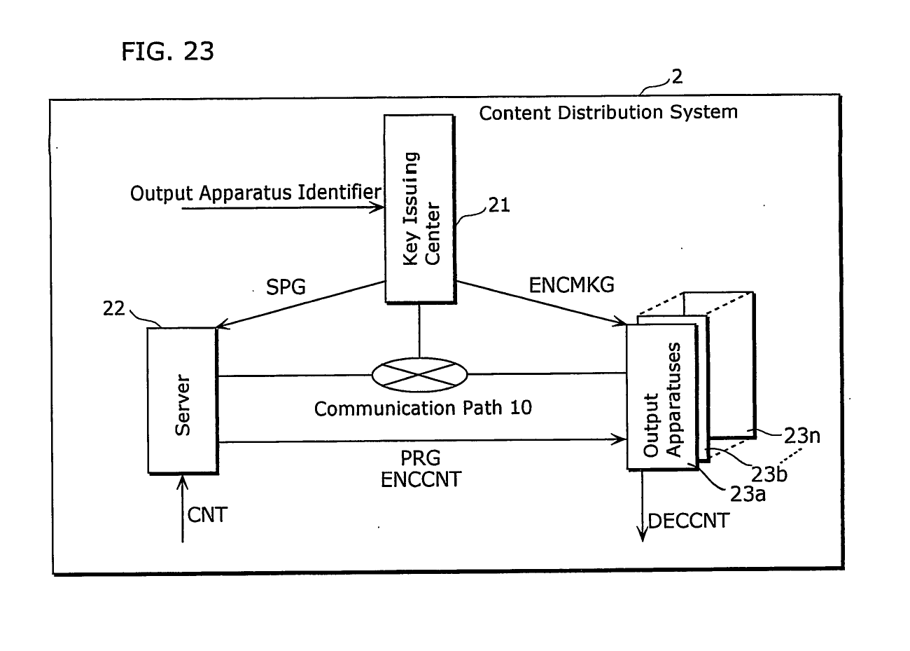

As shown in FIG. 23, the content distribution system 2 is made up of a communication path 10 which is same as in the first embodiment, a key issuing center 21, server 22 and output apparatuses 22a to 22n that are different constituents as in the first embodiment. The roles of constituents are respectively same as those of the key issuing center 11, the server 12 and the output apparatuses 13a to 13n in the content distribution system 1 of the first embodiment.

Hereafter, it is explained about these constituents focusing on differences with the constituents in the content distribution system 1. The structure of the communication path 10 has same structure with that in the content distribution system 1. Therefore, the explanation is omitted. Here, structures and operations of the key issuing center 21, server 22 and plurality of output apparatuses 23a to 23n are explained with references to diagrams.

<Structure of Key Issuing Center 21>

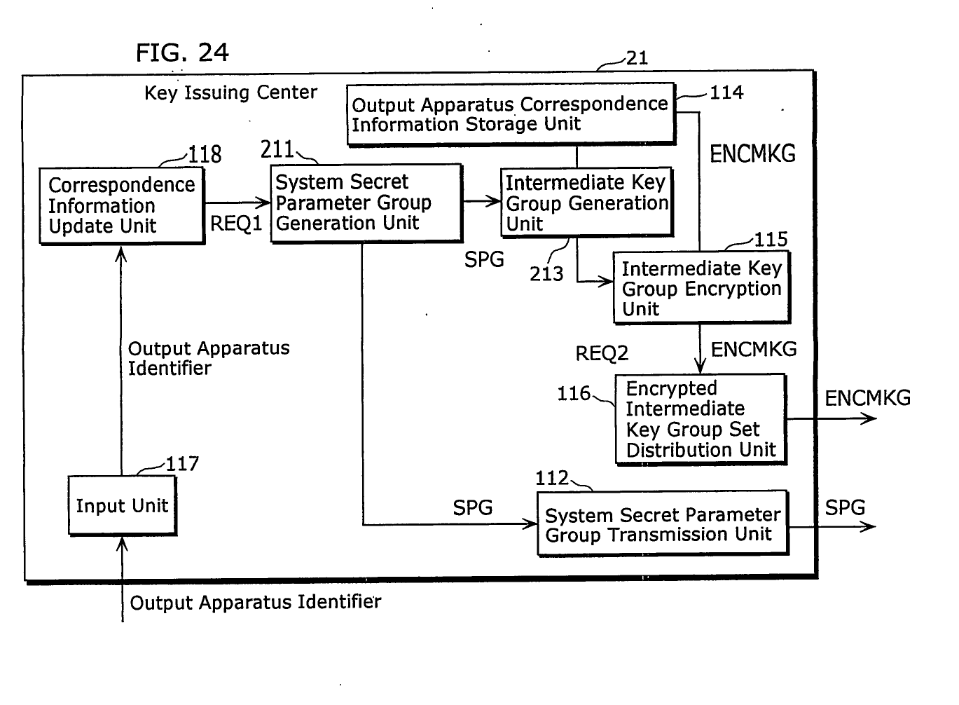

As shown in FIG. 24, the key issuing center 21 is made up of a secret parameter group generation unit 211, a system secret parameter group transmission unit 112, an intermediate key group generation unit 213, an output apparatus correspondence information storage unit 114, an intermediate key group encryption unit 115, an encrypted intermediate key group set distribution unit 116, an input unit 117, and a correspondence information update unit 118. In FIG. 24, same marks are assigned to the same constituents as in FIG. 2 and the explanations about the same constituents are omitted.

(1) Secret Parameter Group Generation Unit 211

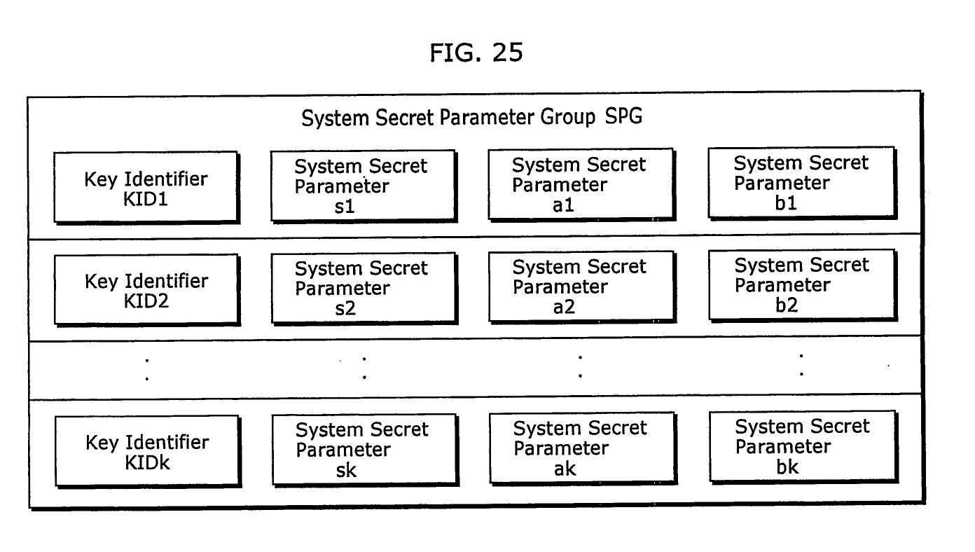

The secret parameter group generation unit 211 generates k sets of system secret parameters {s1, a1, b1} {s2, a2, b2} . . . {sk, ak, bk} when it receives a secret parameter group generation request REQ1 from the correspondence information update unit 118. Here, as a method of generating k sets of system secret parameters, there is, for example, a method of randomly generating them using random numbers. For example, s1 to sk, a1 to ak, b1 to bk are natural numbers of 128 bits and the like. Here, k numbers of system secret parameters are generated so as to satisfy a pre-given system secret parameter generation equation “ai*ai−bi*bi=0 mod N (i is 1 to k)”. The key identifiers KID1 to KIDk are associated respectively with the k sets of system secret parameters {s1, a1, b1}, {s2, a2, b2}, . . . and {sk, ak, bk}. Then, the secret parameter group generation unit 211 generates a system secret parameter group SPG={{KID1, s1, a1, b1}{KID2, s2, a2, b2} . . . {KIDk, sk, ak, bk}} which is formed of the k numbers of key identifiers and system secret parameters as shown in FIG. 25. It outputs the system secret parameter group SPG to the system secret parameter group transmission unit 112 and the intermediate key group generation unit 213. Note that, when the key issuing center starts its operation, similar to the case where the system secret parameter group generation request REQ1 is received, the secret parameter group generation unit 211 generates the system secret parameter group SPG and outputs it to the system secret parameter group transmission unit 112 and the intermediate key group generation unit 213.

(2) Intermediate Key Group Generation Unit 213

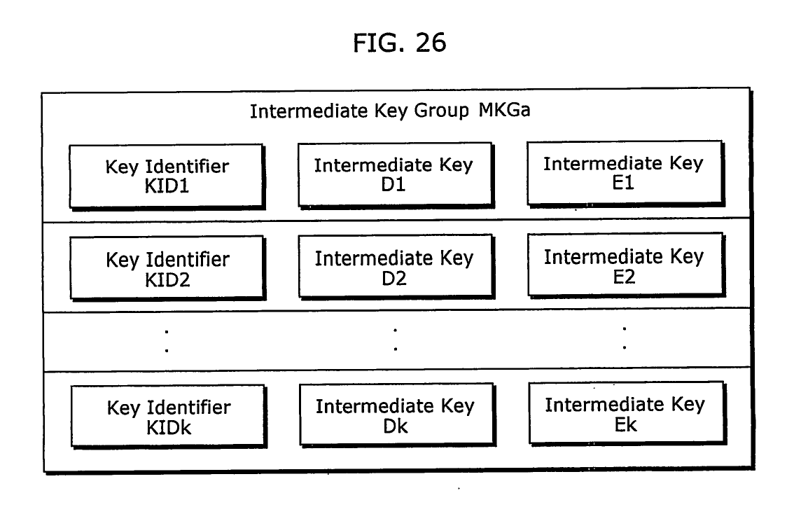

The intermediate key group generation unit 213, in the case of receiving the system secret parameter group SPG from the system secret parameter group generation unit 211, first deletes all of the intermediate key groups MKGa to MKGn in the output apparatus correspondence information storage unit 113. Then, it extracts, from the received system secret parameter group SPG, k sets of identifiers and system secret parameters {KID1, s1, a1, b1}, {KID2, s2, a2, b2}, . . . and {KIDk, sk, ak, bk}. Then, k numbers of individualized parameters, {KID1, x1, y1}, {KID2, x2, y2}, . . . and {KIDk, xk, yk}, which satisfy a pre-given individualized parameter generation equation “xi*ai−yi*bi=1 mod N” (i is 1 to k) are generated. After that, using the k sets of individualized parameters {x1, y1}, {x2, y2}, . . . and {xk, yk}, the intermediate key group generation unit 213 generates k sets of intermediate keys {KID1, D1, E1} {KID2, D2, E2} . . . {KIDk, Dk, Ek} based on the pre-given two intermediate key generation equations “Di=si*xi mod N (i is 1 to k)” and “Ei=si*yi mod N (i is 1 to k)”, and generates an intermediate key group MKGa as shown in FIG. 26 which is composed of the k sets of key identifiers and intermediate keys. The intermediate key group generation unit 213 then associates and stores the intermediate key group MKGa with the output apparatus identifier AIDa in the output apparatus correspondence information storage unit 113. It similarly generates and assigns the intermediate key MKGb to MKGn respectively to the output apparatus identifiers AIDb to AIDn other than the output apparatus identifier AIDa in the output apparatus correspondence information storage unit 113. Here, the structures of the intermediate key MKGb to MKGn are same as the structure of the intermediate key group MKGa shown in FIG. 26. However, each of the intermediate key groups MKGa to MKGn has a unique value. After assigning the intermediate key groups MKGa to MKGn respectively to all of the output apparatus identifiers AIDa to AIDn, the intermediate key group generation unit 213 outputs the encrypted intermediate key group generation request REQ2 to the intermediate key group encryption unit 115.

<Operations of Key Issuing Center 21>

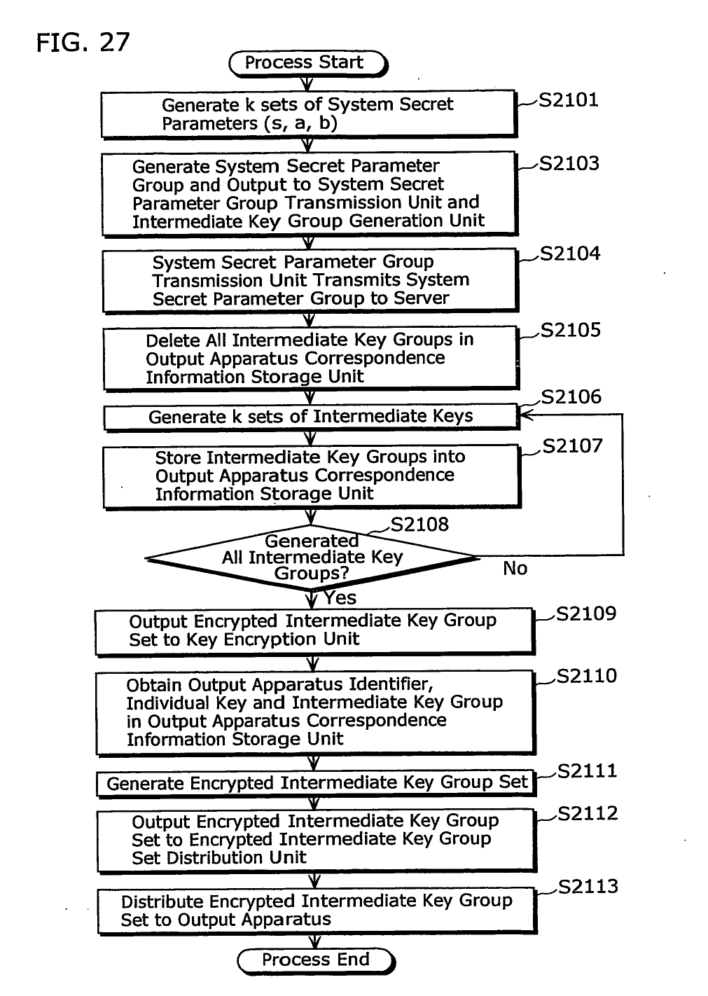

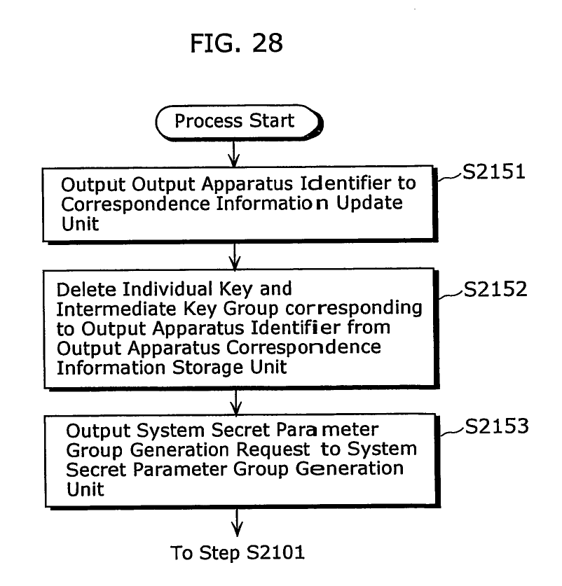

In the above, the structure of the key issuing center 21 is explained. Here, it is explained about an operation of the key issuing center 21. First, it is explained, using a flowchart shown in FIG. 27, about an operation at distributing key information necessary for sharing a content key to the server 22 and the plurality of output apparatuses 23a to 23n. After that, as an example of revoking an output apparatus, an operation of revoking the output apparatus 23a is explained using a flowchart shown in FIG. 28.

<<Operation at Key Information Distribution>>

The system secret parameter group generation unit 211 generates k sets of three system secret parameters {s1, a1, b1}, {s2, a2, b2}, . . . and {sk, ak, bk}. Here, they are selected so as to satisfy an equation of “ai*ai+bi*bi=0 mod N (i is 1 to k)” (S2101).

The system secret parameter group generation unit 211 associates key identifiers KID1 to KIDk respectively with k sets of system secret parameters {s1, a1, b1}, {s2, a2, b2}, . . . and {sk, ak, bk}, generates a system secret parameter group SPG formed thereby, and outputs the system secret parameter group SPG to the system secret parameter group transmission unit 112 and the intermediate key group generation unit 113 (S2103).

The system secret parameter group transmission unit 112 transmits the received system secret parameter group SPG to the server 22 (S2104).

The intermediate key group generation unit 112 deletes all intermediate key groups MKGa to MKGn stored in the output apparatus correspondence information storage unit 114 (S2105).

The intermediate key group generation unit 213 extracts, from the system secret parameter group SPG, k sets of key identifier and system secret parameters {KID1, s1, a1, b1}, {KID2, s2, a2, b2}, . . . and {KIDk, sk, ak, bk}. After that, it generates k sets of two individualized parameters {KID1, x1, y1}, {KID2, x2, y2}, and {KIDk, xk, yk} so as to satisfy an individualized parameter generation equation “xi*ai−yi*bi=1 mod N (i is 1˜k). Herein, each value of the individualized parameters {x1, x2, . . . xk} and {y1, y2, . . . yk} should not collide with each other.

The intermediate key group generation unit 213 generates, using k sets of individualized parameters {KID1, x1, y1}, {KID2, x2, y2}, . . . and {KIDk, xn, yk}, k sets of intermediate keys Di and Ei {KID1, D1, E1}, {KID2, D2, E2}, . . . and {KIDk, Dk, Ek} so as to satisfy the intermediate key generation equations “Di=si*xi mod N (i is 1 to k)” and “Ei=si*yi mod N (i is 1 to k)” (S2106).

The intermediate key group generation unit 213 generates an intermediate key group which is formed of k sets of key identifiers and intermediate keys {KID1, D1, E1}, {KID2, D2, E2}, . . . and {KIDk, Dk, Ek}; associates the intermediate key group with an apparatus identifier to which an intermediate key group has not assigned in the output apparatus correspondence information storage unit 114 and stores it (S2107).

If the intermediate key groups MKGa to MKGn are assigned respectively to all of the output apparatus identifiers AIDa to AIDn in the output apparatus correspondence information storage unit 114, the operation moves on to steps S2109. If there are output apparatus identifiers to which the intermediate key groups are not assigned yet, the operation returns to step S2106 (S2108).

The intermediate key group generation unit 213 outputs the encrypted intermediate key group set generation request REQ2 to the intermediate key group encryption unit 115 (S2109).

The intermediate key group encryption unit 115 which received the encrypted intermediate key group generation request REQ2 accesses to the output apparatus correspondence information storage unit 114 and obtains all sets of output apparatus identifiers AIDa to AIDn, individual keys IKa to IKn and intermediate key groups MKGa to MKGn (S2110).

The intermediate key group encryption unit 115 encrypts each of the intermediate key groups MKGa to MKGn based on each of the individual keys IKa to IKn and generates an encrypted intermediate key group set ENCMKGS={AIDa, ENCMKGa}, {AIDn, ENCMKGn} which is formed of the encrypted intermediate key group ENCMKGa=Enc (IKa, MGa), . . . , ENCMKGn=Enc (IKn, MKGn) and the apparatus identifiers AIDa to AIDn corresponding to the individual key used for the encryption (S2111).

The intermediate key group encryption unit 115 outputs the generated encrypted intermediate key group set ENCMKGS to the encrypted intermediate key group distribution unit 116 (S2112).

The encrypted intermediate key group set distribution unit 116 receives an encrypted intermediate key group set ENCMKGS, distributes the received encrypted intermediate key group set ENCMKGS to the output apparatus 23 and terminates the process (S2113).

<<Operation at Revoking Output Apparatus 23a>>

The input unit 117 outputs the received output apparatus identifier AIDa to the correspondence information update unit 118 (S2151).

The correspondence information update unit 118 deletes an individual key IKa corresponding to the output apparatus identifier AIDa received from the input unit 117 and an intermediate key group MKGa from the output apparatus correspondence information storage unit 114 (S2152).

The correspondence information update unit 118 outputs a system secret parameter group generation request REQ1 to the system secret parameter group generation unit 111 and the operation moves on to step S2101 (S2153).

Note that, the operations at revoking the output apparatuses 23b to 23n other than the output apparatus 23a are almost similar to the operation for the output apparatus 23a. However, they differ with the operation for the output apparatus 23a in that, in the correspondence information update unit 118, the output apparatus identifier, individual key, and intermediate key group to be deleted from the output apparatus correspondence information storage unit 114 differ depending on the output apparatuses 23b to 23n to be revoked.

They are the structure and operations of the key issuing center 21 which is a constituent of the content distribution system 2. Next, it is explained about the structure and operations of the server 22.

<Structure of Server 22>

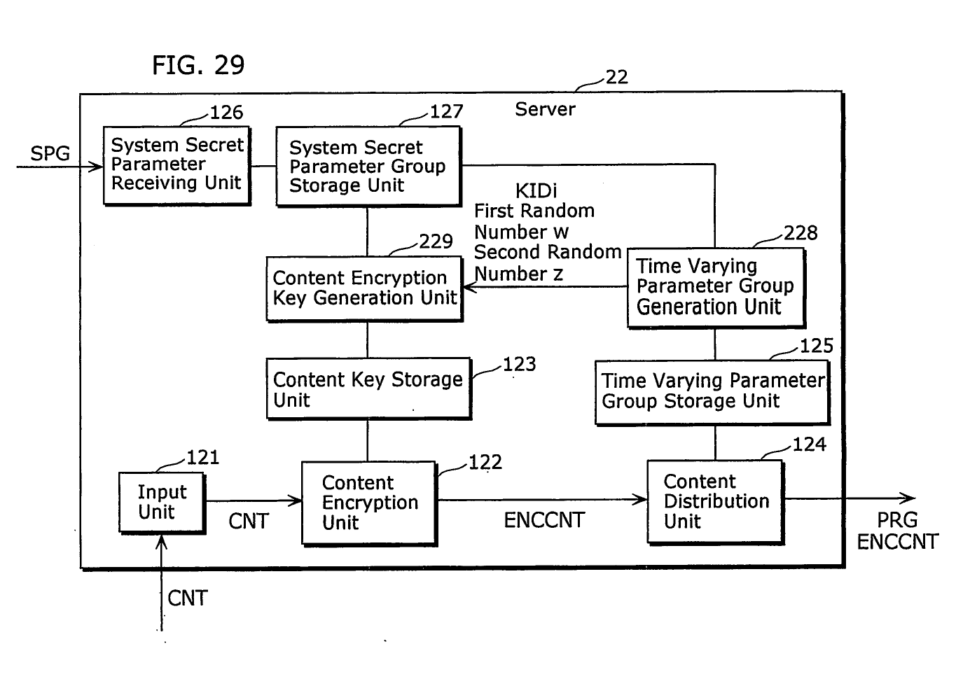

As shown in FIG. 29, the server 22 is made up of an input unit 121, a content encryption unit 122, a content key storage unit 123, a content distribution unit 124, a time varying parameter group storage unit 125, a system secret parameter group receiving unit 126, a system secret parameter group storage unit 127, a time varying parameter group generation unit 228 and an encryption key generation unit 229. In FIG. 29, same marks are assigned to the same constituents in FIG. 9 and the explanations about the same constituents are omitted.

(1) Time Varying Parameter Group Generation Unit 228

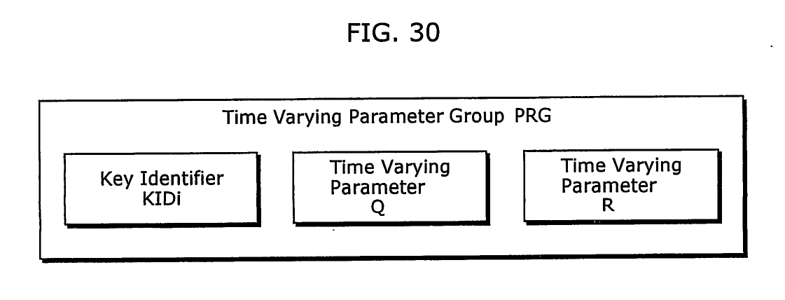

A time varying parameter group update condition is previously given to the time varying parameter group generation unit 228. When the time varying parameter group generation unit 228 satisfies the condition, it first accesses to the system secret parameter group storage unit 127 and obtains the stored system secret parameter group SPG. It then selects one out of k numbers of key identifiers {KID1, KID2, . . . KIDk} stored in the system secret parameter group SPG. Here, as a method of selecting one out of the k numbers of key identifiers {KID1, KID2, . . . KIDk}, for example, there is a method of randomly selecting the one using random numbers. Hereafter, it is assumed that the selected key identifier is described as KIDi (KIDi is one of KID1 to KIDk) and that the system secret parameters si, ai, and bi are associated with the key identifier KIDi in the system secret parameter group SPG. Then, the time varying parameter group generation unit 228 obtains the system secret parameters ai and bi corresponding to the key identifier KIDi from the system secret parameter group SPG. After that, it generates random numbers z and w. It then generates time varying parameters Q and R based on the pre-given time varying parameter generation equation “Q=z*ai+bi*w mod N” and “R=z*bi+ai*w mod N”. After that, it generates a time varying parameter group PRG as shown in FIG. 30 from the key identifier KIDi and generated time varying parameter and stores it to the time varying parameter group storage unit 125. Finally, it outputs key identifier KIDi, a first random number z and a second random number w to the content encryption key generation unit 129.

(2) Content Encryption Key Generation Unit 229

The content encryption key generation unit 229, in the case of receiving the key identifier KIDi and random numbers z and w from the time varying parameter group generation unit 228, first accesses to the system secret parameter group storage unit 127 and obtains a system secret parameter si corresponding to the key identifier KIDi. After that, the content encryption key generation unit 229 generates a content key CK based on the content encryption key generation equation “CK=si*z+si*w*a/b mod N” and stores the generated content key CK into the content key storage unit 123.

<Operation of Server 22>

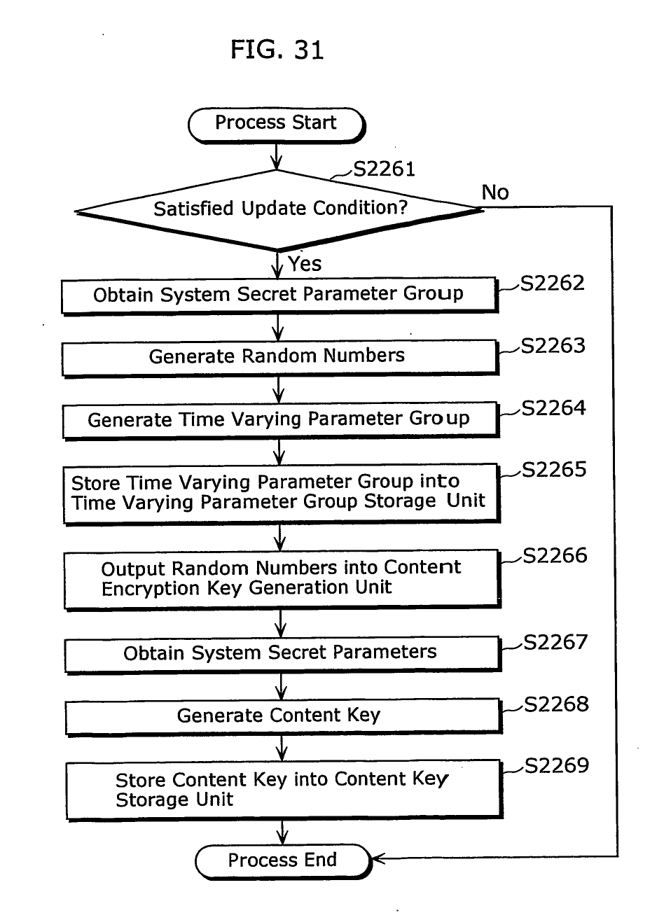

It is explained in the above about the structure of the server 22. Here, operations of the server 22 are explained. The explanations about operations at distributing content and at receiving system secret parameter group are omitted since they are same as the operations of the server 12 in the content distribution system 1 of the first embodiment. Here, it is explained about an operation at updating time varying parameter group PRG using a flowchart shown in FIG. 31.

<<Operation at Updating Time Varying Parameter Group PRG>>

When the time varying parameter group generation unit 228 satisfies the pre-given time varying parameter group update condition, an operation moves on to steps S2262. When it does not satisfy the time varying parameter group update condition, the operation is terminated (S2261).

The time varying parameter group generation unit 228 accesses to the system secret parameter group storage unit 127 and obtains the system secret parameter group SPG (S2262).

The time varying parameter group generation unit 228 selects one key identifier KIDi from the system secret parameter group SPG, obtains the system secret parameters si, ai and bi that are associated with the key identifier KIDi, and generates random numbers z and w (S2263).

The time varying parameter group generation unit 228 generates time varying parameters Q and R based on the time varying parameter generation equations “Q=z*ai+bi*w mod N” and “R=z*bi+ai*w mod N” corresponding to the pre-given key identifier KIDi and generates a time varying parameter group PRG which is formed of the generated time varying parameters Q and R (S2264).

The time varying parameter group generation unit 228 stores the time varying parameter group PRG into the time varying parameter group storage unit 125 (S2265).

The time varying parameter generation unit 228 outputs the key identifier KIDi, random numbers z and w to the content encryption key generation unit 229 (S2266).

The content encryption key generation unit 229 which received key identifier KIDi and random numbers z and w first accesses to the system secret parameter group storage unit 127 and obtains a system secret parameter si corresponding to the key identifier KIDi (S2267).

The content encryption key generation unit 229 generates a content key CK based on the content encryption key generation equation “CK=si*z+si*w*a/b mod N” corresponding to the pre-given key identifier KIDi (S2268).

The content encryption key generation unit 229 stores the generated content key CK into the content key storage unit 123 and the operation is terminated (S2269).

They are the structure and operations of the server 22 which is a constituent of the content distribution system 2. Next, it is explained about the structure and operations of the output apparatus 23a.

<Structure of Output Apparatus 23a>

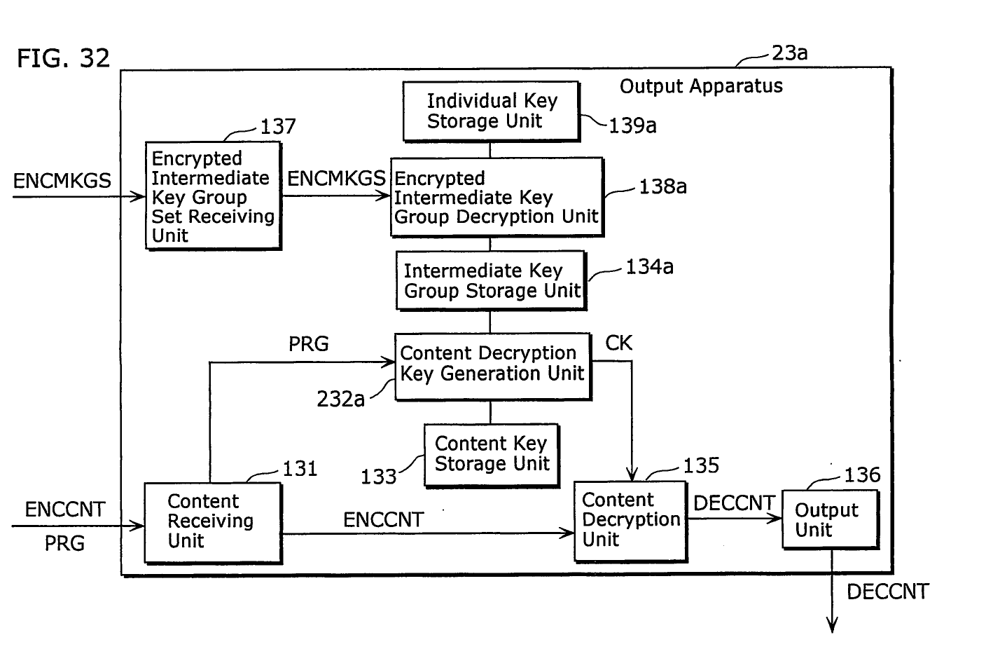

As shown in FIG. 32, the output apparatus 23a is made up of a content receiving unit 131, a content decryption key generation unit 232a, a content key storage unit 133, an intermediate key group storage unit 134a, a content decryption unit 135, an output unit 136, an encrypted intermediate key group set receiving unit 137, an encrypted intermediate key group decryption unit 138a, and an individual key storage unit 139a. In FIG. 32, same marks are assigned to the constituents that are same in FIG. 17 and the explanations about the same constituents are omitted.

(1) Content Decryption Key Generation Unit 232a

In the case of receiving the time varying parameter group PRG from the content receiving unit 131, the content decryption key generation unit 232a first verifies whether the use time varying parameter group UPRG stored in the content key storage unit 133 matches with the received time varying parameter group PRG. Here, when they match with each other, the content decryption key generation unit 232a accesses to the content key storage unit 133 and outputs the stored content key CK to the content decryption un it 135. If they do not match with each other, it accesses to the intermediate key group storage unit 134a and obtains the intermediate key group MKGa. Then, it obtains a key identifier KIDi from the time varying parameter group PRG and obtains the intermediate key which is associated with the key identifier KIDi. Here, intermediate keys associated with the key identifier KIDi are defined as Di and Ei (Di is any one of D1 to Dk, Ei is any one of E1 to Ek). After that, it calculates a content key CK based on the pre-given content decryption key generation equation “CK=Di*Q−Ei*R mod N”, stores the calculated content key CK into the content key storage unit 133, stores the time varying parameter group PRG into the content key storage unit 133 as the use time varying parameter group UPRG and outputs the content key CK to the first decryption unit 133.

<Operations of Output Apparatus 23a>

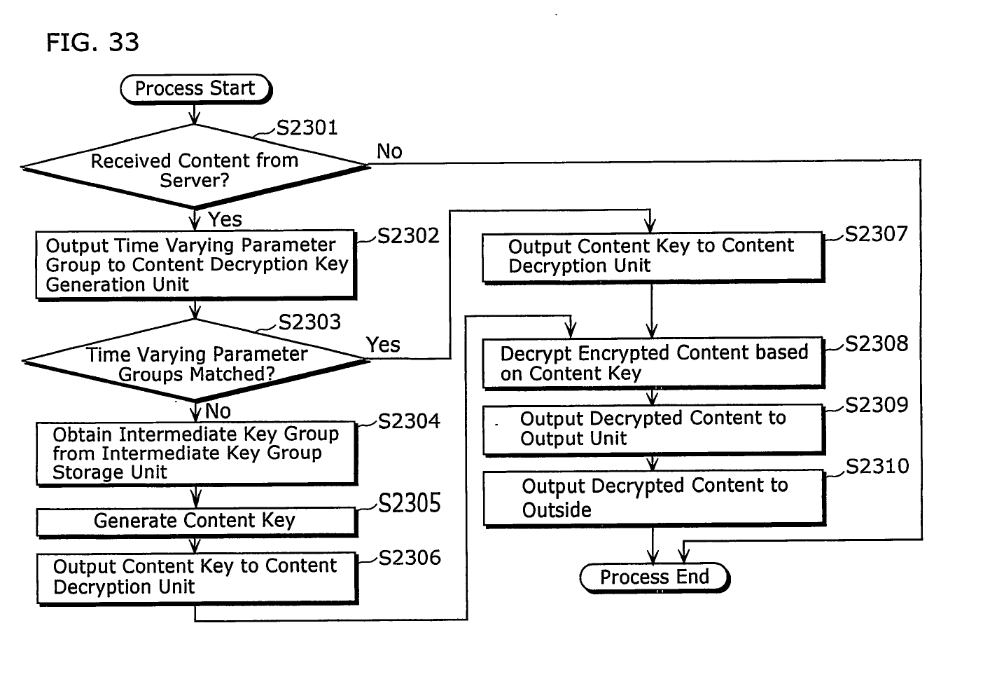

In the above, the structure of the output apparatus 23a is explained. Here, the operations of the output apparatus 23a are explained. First, the explanations about the operations at updating key information necessary for sharing the content key is omitted since it is same as the operation at updating key in the output apparatus 13a. Then, an operation at receiving the encrypted content is explained using a flowchart shown in FIG. 33.

<<Operation at Receiving Content>>

When the content receiving unit 131 receives the encrypted content ENCCNT and the time varying parameter group PRG, an operation moves on to step S2302. When it does not receive those, the process is terminated (S2301).

The content receiving unit 131 outputs the received time varying parameter group PRG to the content decryption key generation unit 232 (S2302).

The content decryption key generation unit 232 which received the time varying parameter group PRG accesses to the content key storage unit 133 and moves on to step S2307 if the received time varying parameter group PRG and the use time varying parameter group UPRG are the same. If they are different, it moves on to steps S2304 (S2303).

The content decryption key generation unit 232 divides the time varying parameter group PRG into a key identifier KIDi and time varying parameters Q and R, accesses to the intermediate key group storage unit 134 and obtains an intermediate key MKi (S2304).

It obtains intermediate keys Di and Ei corresponding to the key identifier KIDi and generates a content key CK based on the content decryption key generation equation “CK=Di*Q−Ei*R mod N” corresponding to the key identifier KIDi (S2305).

The content decryption key generation unit 232 outputs the content key CK to the content key decryption unit 135 and moves on to step S2308 (S2306).

The content decryption key generation unit 232 accesses to the intermediate key group storage unit 134a, obtains the content key CK, and outputs the content key CK to the content decryption unit 135 (S2307).

The content decryption unit 135 decrypts the encrypted content ENCCNT based on the content key CK (S2308).

The content decryption unit 135 outputs the decrypted content DECCNT to the output unit 136 (S2309).

The output unit 136 receives the decrypted content DECCNT from the first decryption unit 136 and outputs the received decrypted content DECCNT to the outside. The operation is then terminated (S2301).

They are the structure and operations of the output apparatus 23a which is a constituent of the content distribution system 2. Here, differences between the output apparatus 23a and other output apparatuses 23b to 23n are that intermediate key groups MKGa to MKGn that are respectively unique to the output apparatuses 23a to 23n are stored in the intermediate key group storage unit 134a; that individual keys IKa to IKn that are respectively unique to the output apparatuses 23a to 23n are stored in the individual key storage unit 139a; that the content decryption key generation unit 232a uses a unique intermediate key for each of the output apparatuses 23a to 23n; and that the encrypted intermediate key group decryption unit 138a uses a unique output apparatus identifier AIDa to AIDn and individual key IKa to IKn for each of the output apparatuses 23a to 23n.

<Verification of Operations in Second Embodiment>

In the second embodiment, in spite of the fact that a value unique to each of the intermediate key groups MKGa to MKGn is respectively assigned to each of the output apparatuses 23a to 23n, the reason why same content key CK can be generated from all of the output apparatuses 23a to 23n is same as explained in the first embodiment.

<Effect of Second Embodiment>

While the second embodiment basically has a similar effect as in the first embodiment, the second embodiment has an effect that the key issuing center 21 can reduce the frequency of distributing the encrypted intermediate key group set ENCMKGS to the plurality of output apparatuses 22a to 22n by embedding sets of intermediate key groups in the encrypted intermediate key group.

<Variations of Second Embodiment>

The embodiment explained in the above is an example of the embodiments of the present invention. Thus, the present invention is not restricted to this embodiment so that it can be embodied in main condition within a range of the context of the embodiment. The followings are also included in the present invention.

(1) The communication path 10 may be a terrestrial wave or a broadcasting network such as satellite.

(2) The server 22 may play a role of the key issuing center 21. That is, the server 22 may receive one of the output apparatus identifiers AIDa to AIDn and transmit the encrypted intermediate key group set ENCMKGS to the plurality of output apparatuses 23a to 23n based on the output apparatus identifier.

(3) The key issuing center 21 may transmit the intermediate key group to the server 22 in place of the system secret parameter group SPG and generate a content key CK based on the intermediate key group and the time varying parameter group.

(4) The intermediate key group generation unit 213 of the key issuing center 21 may receive the intermediate key group generation request information REQ3 from outside and generate the intermediate key group based on the intermediate key group generation request information REQ3.

(5) The time varying parameter group generation unit 228 of the server 22 may receive the time varying parameter group generation request information REQ4 from outside and generates the time varying parameter group PRG based on the time varying parameter group generation request information REQ4.

(6) In the second embodiment, the number of output apparatuses is 14 (23a to 23n). However, the number of output apparatuses may be 15 or more, or 13 or less.

(7) When the key issuing center 21 distributes the encrypted intermediate key group set ENCMKG, it may distribute it at the same time or separately to each of the output apparatuses 23a to 23n. Note that similarly in the case where the server 22 distributes the time varying parameter group PRG and an encrypted content ENCCNT, it may distribute those at the same time or separately to each of the output apparatuses 23a to 23n.

(8) The present invention may be the methods described in the above. Also, the present invention may be a computer program causing a computer to execute those methods and a digital signal which composed of the computer program. Further, the present invention may be a recording medium which can read the computer program or the digital signal by a computer. For example, it may be recorded in a flexible disc, a hard disk, a CD-ROM, an MO, a DVD, a DVD-ROM, a DVD-RAM, a Blu-ray Disc (BD), semiconductor memory and the like. Also, it may be the computer program or the digital signal stored in these recording mediums. Furthermore, the present invention may transmit the computer program or the digital signal via a telecommunication line, wireless or wire communication line, network, notably the Internet and the like. The present invention is a computer system having a microprocessor and a memory. The memory stores the computer program and the microprocessor may operate according to the computer program. Also, it may be embodied by another independent computer system by recording and transferring the program or the digital signal recorded in the recording medium.

(9) The present embodiments and the variations may be combined to each other.

### Third Embodiment

It is explained about a content distribution system 3 as one of the embodiments according to the present invention. In the content distribution system 1 in the first embodiment, each of the output apparatuses 13a to 13n generates a content key based on the pre-given content decryption key generation equation. In the content distribution system 3 in the third embodiment, it is very different from the first embodiment in that each of the output apparatuses 33a to 33n generates not the content decryption key generation equation but a content key based on table fixed values assigned respectively to the output apparatuses 33a to 33n.

<Structure of Content Distribution System 3>

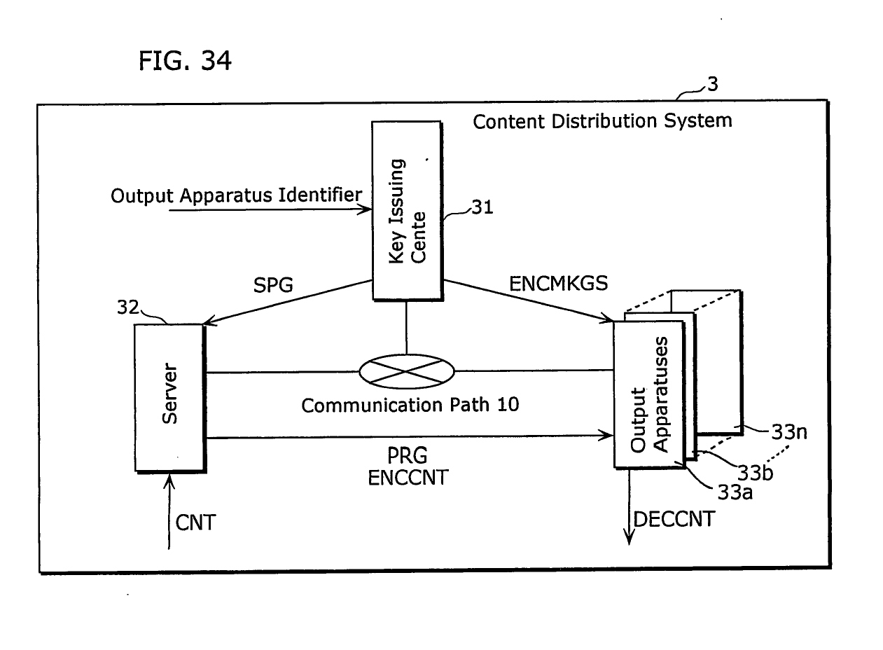

As shown in FIG. 34, the content distribution system 3 is made up of the communication path 10 that is same as in the first embodiment, and a key issuing center 31, server 32 and plurality of output apparatuses 33a to 33n that are different from the first embodiment. The roles of the constituents are same as those of the key issuing center 11, server 12 and output apparatuses 13a to 13n in the content distribution system 1 of the first embodiment.

Hereafter, it is explained in detail about these constituents. The structure of the communication path 10 is same as that in the content distribution system 1 so that the explanation about the structure is omitted. Here, the structures and operations of the key issuing center 31, server 32 and output apparatus 33a are explained with references to diagrams.

<Structure of Key Issuing Center 31>

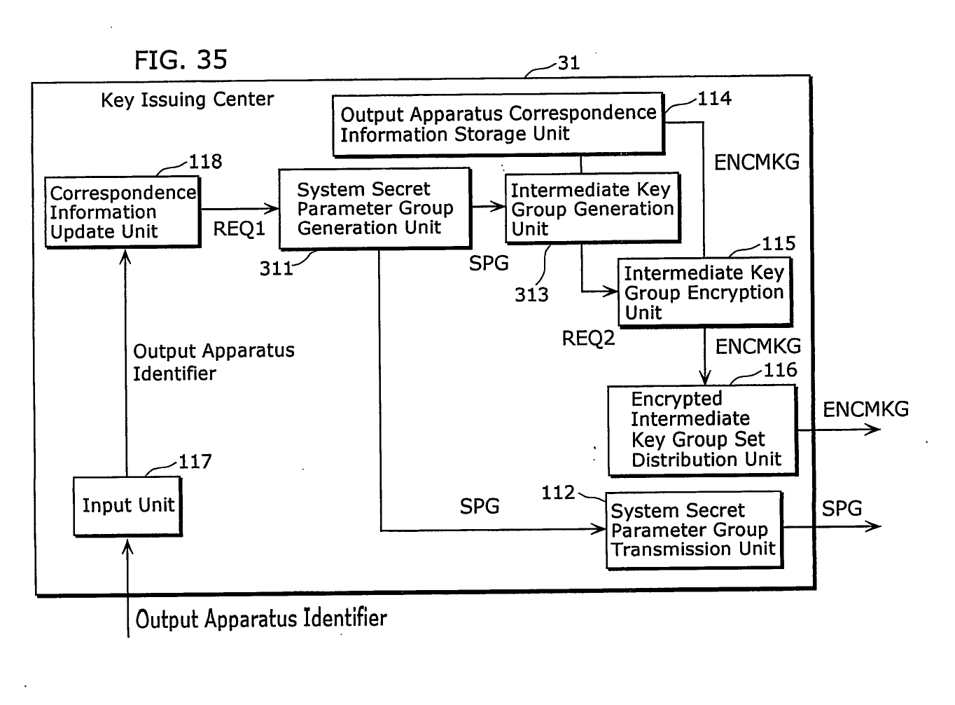

As shown in FIG. 35, the key issuing center 31 is made up of a system secret parameter group generation unit 311, a system secret parameter group transmission unit 112, an intermediate key group generation unit 313, an output apparatus correspondence information storage unit 114, an intermediate key group encryption unit 115, an encrypted intermediate key group set distribution unit 116, an input unit 117, and a correspondence information update unit 118. In FIG. 35, same marks are assigned to the same constituents as in FIG. 2 and the explanations about the same constituents are omitted in here.

(1) System Secret Parameter Group Generation Unit 311

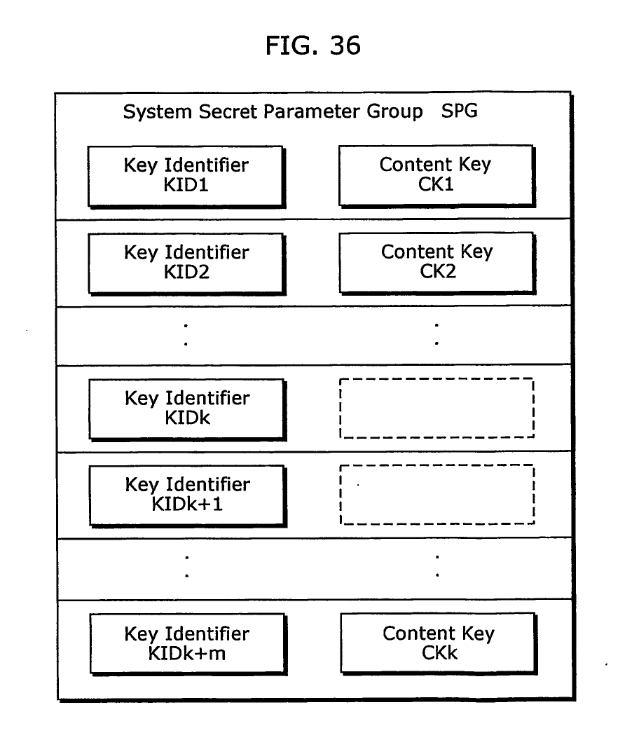

The system secret parameter group generation unit 311, in the case of receiving the system secret parameter group generation request REQ1 from the correspondence information update unit 118 which is described later, first selects k numbers of key identifiers out of (k+m) numbers of key identifiers KID1 to KIDk+m. The system secret parameter group generation unit 311 then generates content key CK1, CK2, . . . , and CKk respectively to the selected k numbers of key identifiers. Here, as a method of selecting k numbers of key identifiers out of (k+m) numbers of key identifiers KID1 to KIDk+m and of sharing the content key CK1, CK2, . . . , and CKk, there is, for example, a method of randomly sharing the content key using random numbers. The system secret parameter group generation unit 311 then generates a system secret parameter group SPG as shown in FIG. 36 composed of (k+m) sets of key identifiers and content keys and outputs the system secret parameter group SPG to the system secret parameter group transmission unit 112 and the intermediate key group generation unit 113. Note that, when the key issuing center starts its operation, similarly in the case of receiving the system secret parameter group generation request REQ1, it generates a system secret parameter group SPG and outputs to the system secret parameter group transmission unit 112 and the intermediate key group generation unit 113.

(2) Intermediate Key Group Generation Unit 313

The intermediate key group generation unit 313, in the case of receiving the system secret parameter group SPG from the system secret parameter group generation unit 311, first deletes all of the intermediate key groups MKGa to MKGn in the output apparatus correspondence information storage unit 113. It then obtains (k+m) sets of key identifiers and content keys from the received system secret parameter group SPG. Next, it generates dummy keys DMK1 to DMKm and assigns to the m numbers of key identifiers to which the content key CK and the content key CK have not assigned among the key identifiers KID1 to KIDk+m. Here, as a method of generating dummy keys DMK1 to DMKm, there is, for example, a method of randomly generating a dummy key using random numbers. Then, the intermediate key group generation unit 313 associates the intermediate key group MKGa with the output apparatus identifier AIDa in the output apparatus correspondence information storage unit 113 and stores it. After that, the intermediate key group generation unit 313 performs same operations on all of the output apparatus identifiers AIDb to AIDn other than the output apparatus identifier AIDa in the output apparatus correspondence information storage unit 113. Here, different dummy keys DMK1 to DMKm are assigned respectively to the output apparatus identifiers AIDa to AIDn. When the intermediate key groups MKGa to MKGn are assigned respectively to all of the output apparatus identifiers AIDa to AIDn in the output apparatus correspondence information storage unit 113, the intermediate key group generation unit 313 outputs the encrypted intermediate key group generation request REQ2 to the intermediate key group encryption unit 115.

<Operations of Key Issuing Center 31>

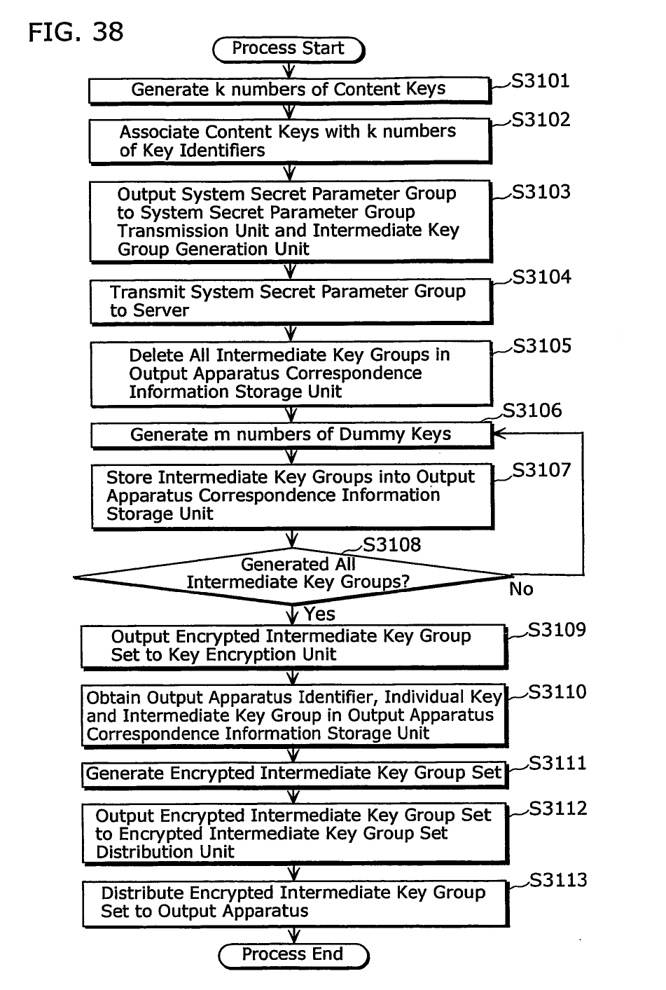

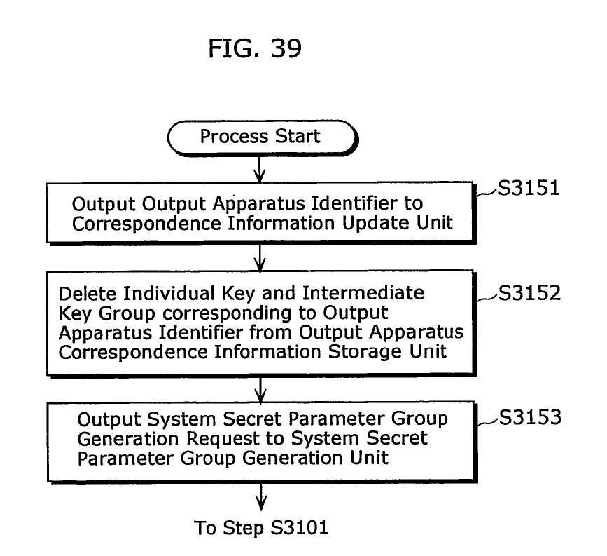

The structure of the key issuing center 31 is explained in the above. Here, it is explained about operations of the key issuing center 31. First, an operation at distributing key information used for sharing content key is explained using a flowchart shown in FIG. 38. After that, an operation at revoking an output apparatus is explained using a flowchart shown in FIG. 39.

<<Operations at Key Information Distribution>>

The system secret parameter group generation unit 311 generates k numbers of content key CK1, CK2, . . . , and CKk (S3101).

The system secret parameter group generation unit 311 assigns the generated content keys respectively to the (k+m) numbers of key identifiers KIDa to KIDk+m (S3102).

The system secret parameter group generation unit 311 generates a system secret parameter group SPG as shown in FIG. 36 and outputs the system secret parameter group SPG to the system secret parameter group transmission unit 112 and the intermediate key group generation unit 313 (S3103).

The system secret parameter group transmission unit 112 transmits the received system secret parameter group SPG to the server 32 (S3104).

The intermediate key group generation unit 313 deletes all of the intermediate key groups MKGa to MKGn stored in the output apparatus correspondence information storage unit 114 (S3105).

The intermediate key group generation unit 313 generates m numbers of dummy keys DMK1 to DMKm (S3106).

The intermediate key group generation unit 313 associates one of the generated m numbers of dummy keys DMK1 to DMKm to a key identifier to which a content key has not been assigned among the key identifiers KID1 to KIDk+m. It then generates an intermediate key group formed of (k+m) numbers of key identifiers KID1 to KIDk+m and (k+m) numbers of content keys corresponding to the key identifiers or the dummy keys.

The intermediate key group generation unit 313 associates and stores the intermediate key groups respectively to the output apparatus identifiers to which the intermediate key group has not been assigned in the output apparatus correspondence information storage unit 114 (S3107).

The intermediate key group generation unit 313 moves on to step S3109 if the intermediate key groups MKGa to MKGn are all assigned respectively to the output apparatus identifiers AIDa to AIDn in the output apparatus correspondence information storage unit 114. If there are output apparatus identifiers to which intermediate key groups have not been assigned, it returns to the step S3106 (S3108).

The intermediate key group generation unit 313 outputs the encrypted intermediate key group set generation request REQ2 to the intermediate key group encryption unit 115 (S3109).

The intermediate key group encryption unit 115 which received the encrypted intermediate key group generation request REQ2 accesses to the output apparatus correspondence information storage unit 114 and obtains all groups of output apparatus identifier, individual key and intermediate key group {AIDa, IKa, MKGa}, {AIDb, IKb, MKGb}, . . . and {AIDn, IKn, MKGn} (S3110).

The intermediate key group encryption unit 115 encrypts each of the intermediate key groups MKGa to MKGn based on each of the individual key IKa to IKn and generates an encrypted intermediate key group set ENCMKGS={AIDa, ENCMKGn}∥{AIDb, ENCMKGb} ∥ . . . ∥{AIDn, ENCMKGn} which is formed of each of the encrypted intermediate key groups and apparatus identifiers (S3111).

The intermediate key group encryption unit 115 outputs the generated encrypted intermediate key group set ENCMKGS to the encrypted intermediate key group set distribution unit 116 (S3112).

The encrypted intermediate key group set distribution unit 116 receives the encrypted intermediate key group set ENCMKGS, distributes the received encrypted intermediate key group set ENCMKGS to the output apparatuses 33a to 33n and terminates the operation (S3113).

<<Operation at Revoking Output Apparatus 33a>>

The input unit 117 outputs the received output apparatus identifier AIDa to the correspondence information update unit 118 (S3151).

The correspondence information update unit 118 deletes, from the output apparatus correspondence information storage unit 114, the received output apparatus identifier AIDa, the individual key IKa corresponding to the output apparatus identifier AIDa and the intermediate key group MKGa (S3152).

The correspondence information update unit 118 outputs the system secret parameter group generation request REQ1 to the system secret parameter group generation unit 111 and moves on to step S3101 (S3153).

Here, the operations at revoking output apparatuses 33b to 33n other than the output apparatus 33a are almost same as the operation of revoking the output apparatus 33a. However, they are different in that, in the correspondence information update unit 118, an output apparatus identifier, individual key and intermediate key group to be deleted from the output apparatus correspondence information storage unit 114 differ depending on output apparatuses 33b to 33n to be revoked.

They are the structure and operations of the key issuing center 31 which is a constituent of the content distribution system 3. Next, it is explained about the structure and operations of the server 32.

<Structure of Server 32>

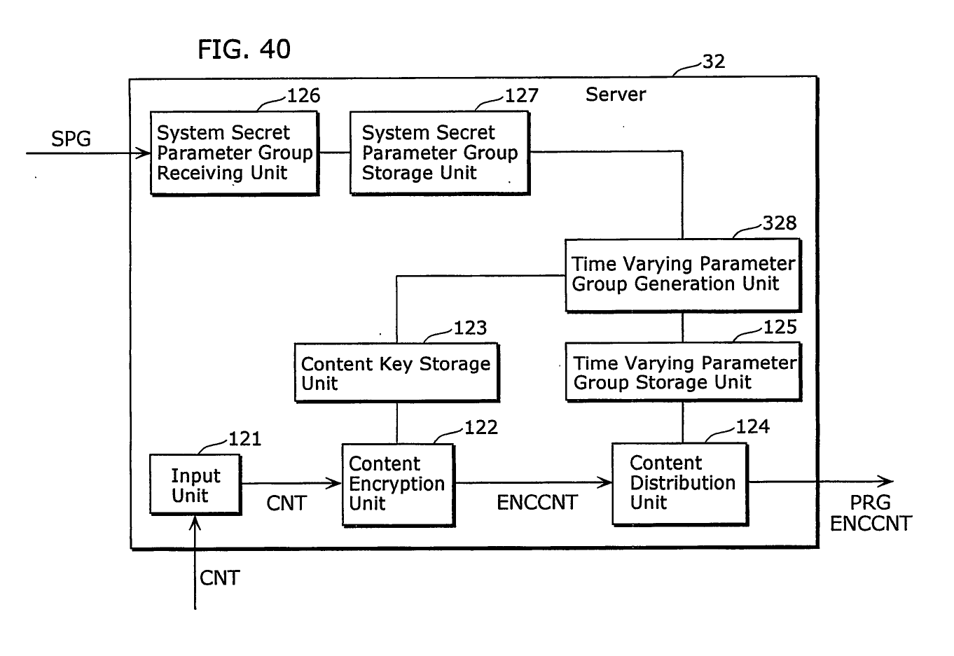

As shown in FIG. 40, the server 32 is made up of an input unit 121, a content encryption unit 122, a content key storage unit 123, a content distribution unit 124, a time varying parameter group storage unit 125, a system secret parameter group receiving unit 126, a system secret parameter group storage unit 127 and a time varying parameter group generation unit 328. In FIG. 40, same marks are assigned to the same constituents as in FIG. 9 so that the explanations about the same constituents are omitted.

(1) Time Varying Parameter Group Generation Unit 328

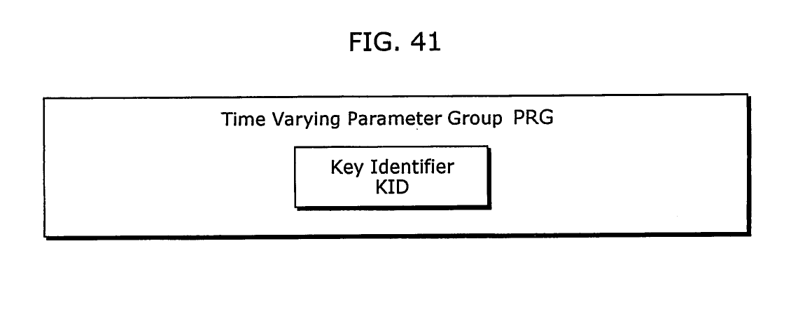

Time varying parameter group update condition is previously given to the time varying parameter group generation unit 328. When the condition is satisfied, the time varying parameter group generation unit 328 accesses to the system secret parameter group storage unit 127 and obtains the system secret parameter group SPG. Then, it randomly selects one key identifier to which a content key is assigned among the system secret parameter group SPG. Here, it is presumed that {KID, CK} are selected as key identifier and content key. After that, it generates a time varying parameter group PRG which is formed of the key identifiers KID as shown in FIG. 41 and stores the time varying parameter group PRG into the time varying parameter group storage unit 125. Lastly, it outputs the content key CK to the content key storage unit 123.

<Operation of Server 32>

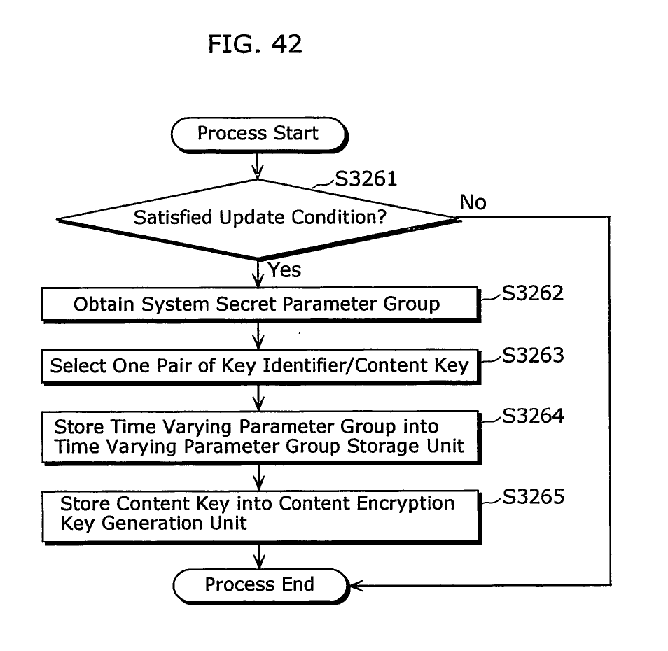

In the above, the structure of the server 32 is explained. Here, it is explained about the operations of the server 32 are explained. First, an operation at distributing content and an operation at receiving system secret parameter group are omitted since they are same operations as in the server 12. Here, it is explained about an operation of updating time varying parameter group using a flowchart shown in FIG. 42.

<<Operation at Updating Time Varying Parameter Group PRG>>

When the time varying parameter group generation unit 328 satisfies a pre-given time varying parameter group update condition, an operation moves on to step S3262. When it does not satisfy the time variant group update condition, the operation is terminated (S3261).

The time varying parameter group generation unit 328 accesses to the system secret parameter group storage unit 127 and obtains the system secret parameter group SPG (S3262).

The time varying parameter group generation unit 328 selects one key identifier to which a content key is assigned among the system secret parameter group SPG. Here, it is assumed that {KID, CK} are selected. It generates a time varying parameter group PRG formed of the key identifier KID (S3263).

The time varying parameter group generation unit 328 stores the time varying parameter group PRG into the time varying parameter group storage unit 125 (S3264).

It stores the content key CK into the content encryption key generation unit 329 and terminates the operation (S3265).

They are the structure and operations of the server 32 which is a constituent of the content distribution system 3. The following explains about the structure and operations of the output apparatus 33a.

<Structure of Output Apparatus 33a>

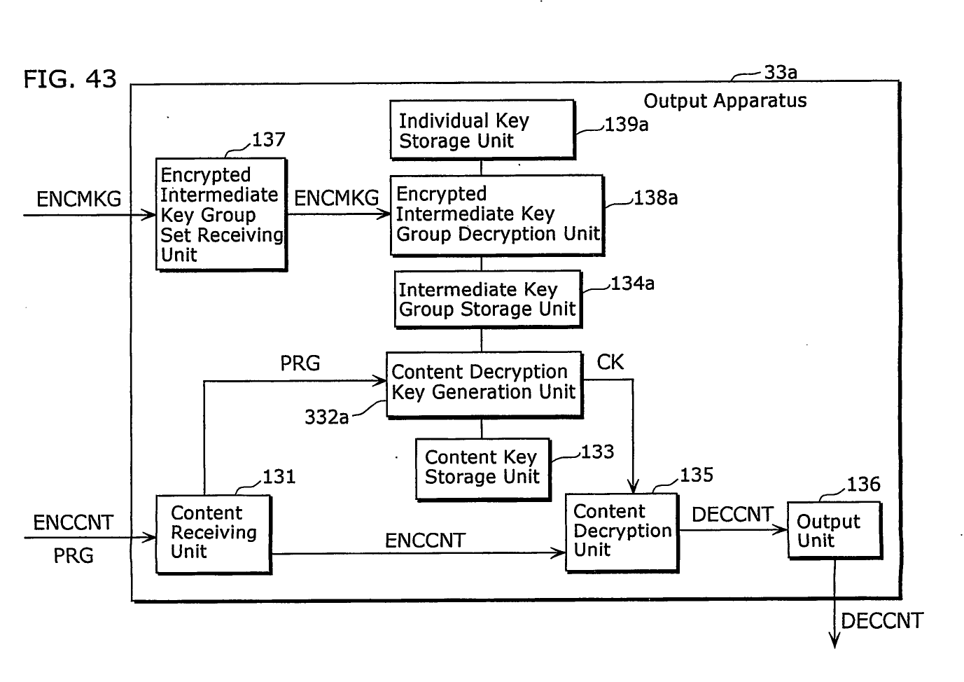

As shown in FIG. 43, the output apparatus 33a is made up of a content receiving unit 131, a content decryption key generation unit 332, a content key storage unit 133, an intermediate key group storage unit 134, a content decryption unit 135, an output unit 136, an encrypted intermediate key group set receiving unit 137, an encrypted intermediate key group decryption unit 138 and an individual key storage unit 139. In FIG. 43, same marks are assigned to the same constituents as in FIG. 17 and the explanations about the same constituents are omitted in here.

(1) Content Decryption Key Generation Unit 332a

When the content decryption key generation unit 332a receives the time varying parameter group PRG from the content receiving unit 131, the content decryption key generation unit 332a first verifies whether or not the use time varying parameter group UPRG stored in the content key storage unit 133 matches with the received time varying parameter group PRG. Here, when they are matched with each other, the content decryption key generation unit 332a accesses to the content key storage unit 133 and outputs the stored content key CK to the content decryption unit 135. If they are not matched with each other, it accesses to the intermediate key group storage unit 134a and obtains the intermediate key group MKGa. Then, it extracts a key identifier KID from the time varying parameter group PRG, obtains a key corresponding to the key identifier KID from the intermediate key MKa, stores it to the content key storage unit 133 as a content key CK, stores the time varying parameter group PRG into the content key storage unit 133 as a use time varying parameter group UPRG, and outputs the stored time varying parameter group PRG as the content key CK to the content decryption unit 135.

<Operations of Output Apparatus 33a>

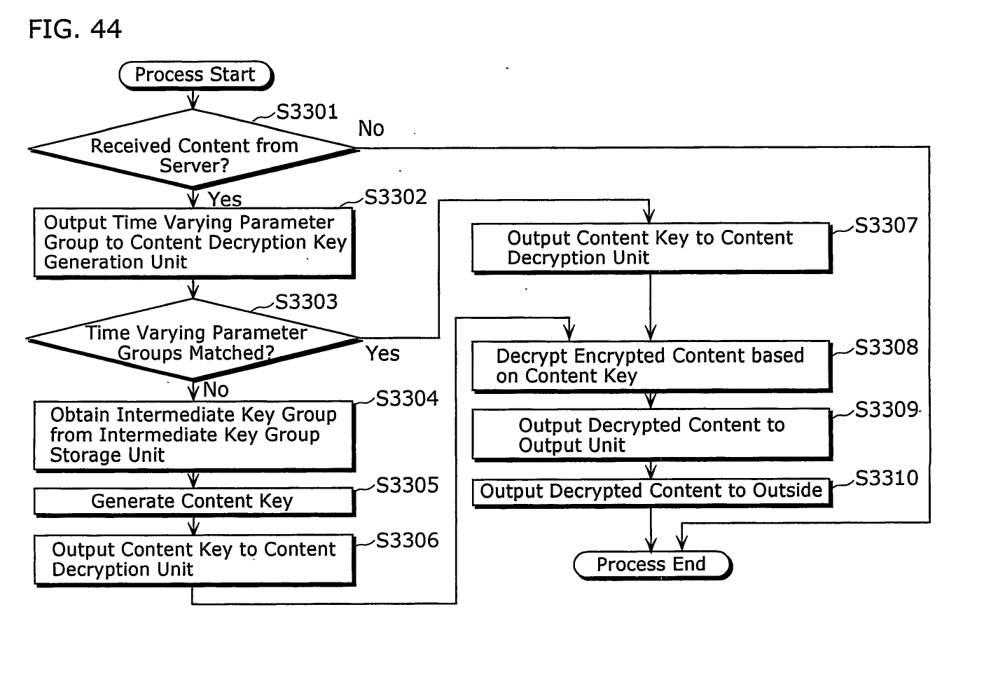

In the above, the structure of the output apparatus 33a is explained. Here, it is explained about the operation of the output apparatus 33a. First, the explanation about the operation at updating a key is omitted since it is same as the operation in the output apparatus 13a. Here, the operation at receiving content is explained using a flowchart shown in FIG. 44.

<<Operation at Receiving Content>>

When the content receiving unit 131 receives the encrypted content ENCCNT and the time varying parameter group PRG, an operation moves on to step S3302. When it does not receive those, the operation is terminated (S3301).

The content receiving unit 131 outputs the received time varying parameter group PRG to the content decryption key generation unit 332a (S3302).

The content decryption key generation unit 332a which received the time varying parameter group PRG accesses to the content key storage unit 133 and the operation moves on to step S3307 when the received time varying parameter group PRG and the use time parameter group UPRG match with each other. When they do not match, the operation moves on to step S3304 (S3303).

The content decryption key generation unit 332a accesses to the intermediate key group storage unit 134a and obtains the intermediate key group MKGa (S3304).

It obtains the key identifier KID from the time varying parameter group PRG and obtains a key corresponding to the key identifier KID as a content key CK among the intermediate key group MKGa (S3305).

The content decryption key generation unit 332a outputs the content key CK to the content decryption unit 135 and moves on to step S3308 (S3306).

The content decryption key generation unit 332a accesses to the intermediate key group storage unit 134a, obtains the content key CK, and outputs the content key CK to the content decryption unit 135 (S3307).

The content decryption unit 135 decrypts the encrypted content ENCCNT based on the content key CK (S3308).

The content decryption unit 135 outputs the decrypted content DECCNT to the output unit 136 (S3309).

The output unit 136 receives the decrypted content DECCNT from the first decryption unit 136, outputs the received decrypted content DECCNT to the outside, and the operation is terminated (S3310).

They are the structure and operations of the output apparatus 33 which is a constituent of the content distribution system 3.

<Verification of Operations in Third Embodiment>

In the third embodiment, it is explained about the reason why the same content CK can be obtained from all output apparatuses 33a to 33n in spite of the fact that a unique value of the intermediate key groups MKGa to MKGn is assigned respectively to each of the output apparatus 33a to 33n. Each of the intermediate key groups MKGa to MKGn is made up of a part of content key which is common to all types and a part of dummy key which is unique to each output apparatus. The server 32 knows which part of each of the intermediate key groups MKGa to MKGn is common to all types so that the time varying parameter group PRG can be generated so as to only use a key for the part. However, each of the output apparatuses 33a to 33n which only has a unique intermediate key cannot distinguish which part is the content key common to all types and which part is the dummy key unique to each output apparatus.

<Effect of Third Embodiment>

The third embodiment basically has an effect similar to the first embodiment. However, it differs with the first embodiment in that the output apparatuses 33a to 33n generates a content key CK by only referring to a table fixed value without using algebraic expression processing. Accordingly, compared to the first embodiment, the size of the encrypted intermediate key group set ENCMKGS that the key issuing center 31 distributes to the output apparatuses 33a to 33h becomes larger but the mount of arithmetic processing by each of the output apparatuses 33a to 33n can be reduced.

<Variations of Third Embodiment>

The embodiment explained in the above is an example of the embodiments of the present invention. Therefore, the present invention is not restricted to this embodiment. It can be embodied in main condition within a range which does not exceed the context of the embodiment. The following cases are also included in the present invention.

(1) The communication path 10 may be a broadcasting network such as terrestrial broadcasting and satellite broadcasting.

(2) The server 32 may play a role of the key issuing center 31. That is, the server 32 may receive one of the output apparatus identifiers AIDa to AIDn and transmit the encrypted intermediate key group set ENCMKGS to the plurality of output apparatuses 33a to 33n based on one of the output apparatus identifiers AIDa to AIDn.

(3) The intermediate key group generation unit 313 of the key issuing center 31 may receive the intermediate key group generation request information REQ3 from outside and generate the intermediate key group MKGa to MKGn based on the intermediate key group generation request information REQ3.

(4) The key issuing center 31 may transmit the intermediate key in place of the system secret parameter group SPG to the server 32.

(5) The time varying parameter group generation unit 328 of the server 32 may receive the time varying parameter group generation request information REQ4 from outside and generate the time varying parameter group PRG based on the time varying parameter group generation request information REQ4.

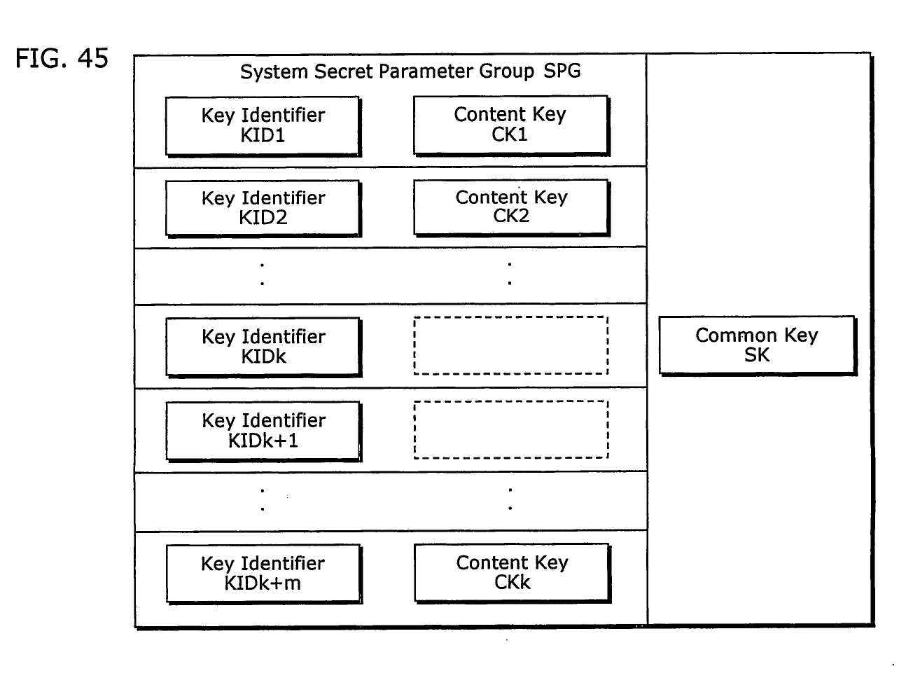

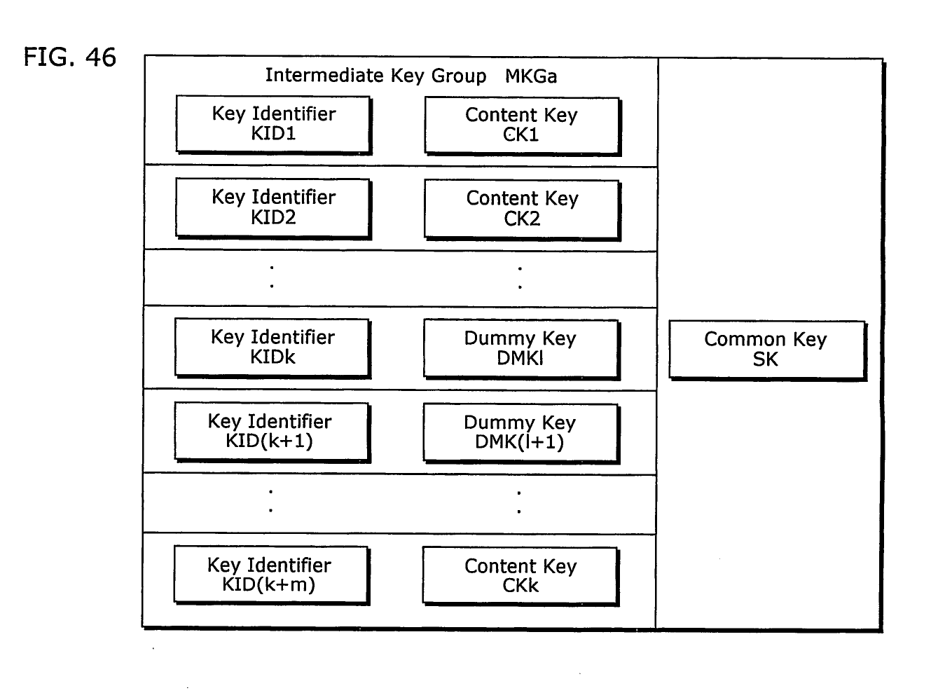

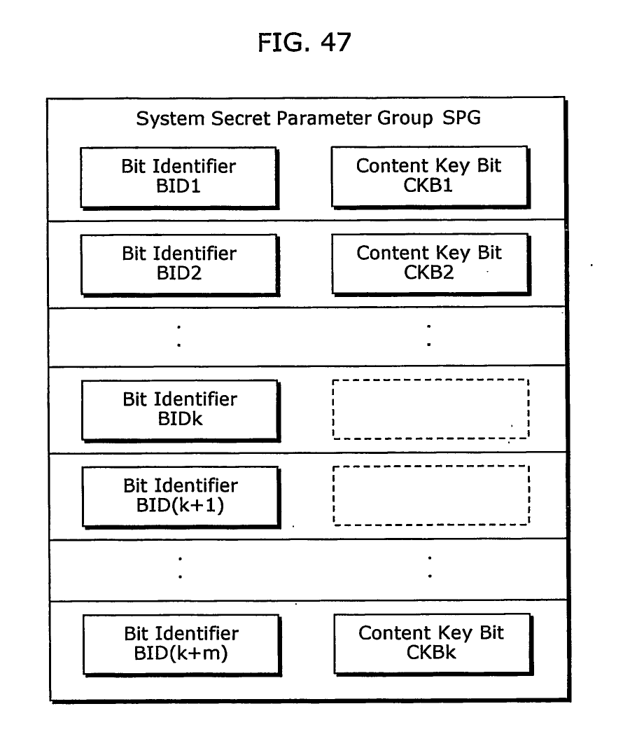

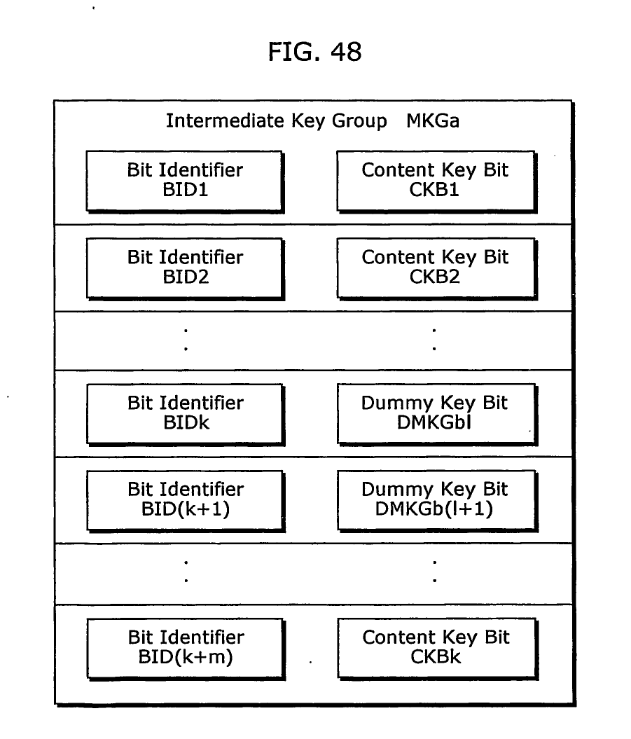

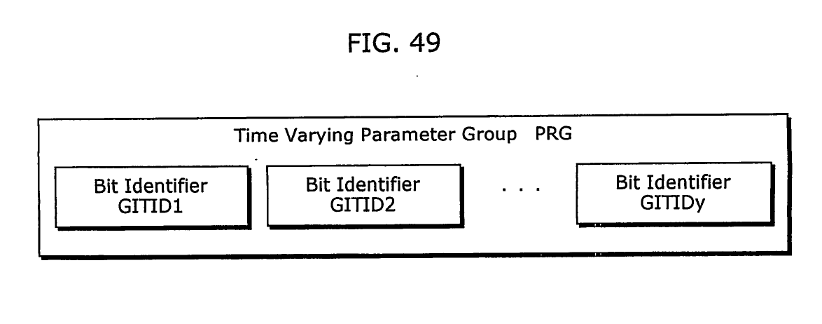

(6) The system secret parameter group SPG may set a common key SK as shown in FIG. 45; the system secret parameter group generation unit 311 may generate a content key and a common key SK in addition to the content key CK and set the common key SK for the intermediate key group MKGa to MKGn as shown in FIG. 46; the time varying parameter group generation unit 328 may store what the key corresponding to the randomly selected key identifier KID is connected to the common key SK as a content key CK into the encryption storage unit 123; and the content decryption key generation unit 332 may store what the key corresponding to the key identifier KID of the time varying parameter group PRG to the common key SK as the content key CK into the content key storage unit 133 and output to the content decryption unit 135. (7) As shown in FIG. 47, the system secret parameter group SPG may be formed of (k+m) sets of bit identifier BID1 to BID and k sets of content key bits. As shown in FIG. 48, the intermediate key groups MKGa to MKGn may be formed of bit identifiers BID1 to BIDk+m and the associated (k+m) numbers of bits. As shown in FIG. 49, the time varying parameter group PRG may be formed of a first bit identifier BITID1 to y-th bit identifier BITIDy. The time varying parameter group generation unit 328 of the server 32 may select y numbers of bit identifiers out of k numbers to which the content key bit is assigned in the system secret parameter group SPG, store the time varying parameter PRG which is formed of the selected bit identifier into the time varying parameter group storage unit 125, and store, into the content key storage unit 123, what the content key bits corresponding to the selected y numbers of bit identifiers are connected. The decryption generation unit of the output apparatus 332 may output, to the content decryption unit 135, what the content key bit corresponding to the y numbers of bit identifiers BITID1 to BIDITy of the received time varying parameter group PRG are connected in the intermediate key group as a content key CK.

(8) While, in the third embodiment, the number of output apparatuses are 14 (33a to 33n), the number of the output apparatuses may be 15 or more, or 13 or less.

(9) When the key issuing center 31 distributes the encrypted intermediate key group set ENCMKG, it may distribute it at the same time or separately to each of the output apparatuses 33a to 33n.

(10) The present invention may be the methods described in the above. Also, the present invention may be a computer program causing a computer to execute those methods and a digital signal which composed of the computer program. Further, the present invention may be a recording medium which can read the computer program or the digital signal by a computer. For example, it may be recorded in a flexible disc, a hard disk, a CD-ROM, an MO, a DVD, a DVD-ROM, a DVD-RAM, a Blu-ray Disc (BD), a semiconductor memory and the like. Also, it may be the computer program or the digital signal stored in these recording mediums. Furthermore, the present invention may transmit the computer program or the digital signal via a telecommunication line, wireless or wire communication line, a network, notably the Internet, and the like. The present invention is a computer system having a microprocessor and a memory. The memory stores the computer program and the microprocessor may operate according to the computer program. Also, it may be implemented by another independent computer system by recording and transferring the program or the digital signal recorded in the recording medium.

(11) The embodiments and the variations may be combined to each other.

### Fourth Embodiment

It is explained about a content distribution system 4 as an embodiment according to the present invention. In the content distribution system 3 in the third embodiment, k numbers of content keys and m numbers of dummy keys are included in the intermediate key groups MKGa to MKGn. However, the content distribution system 4 in the fourth embodiment largely differs with the content distribution system 3 in that information relating to an individual equation (output apparatus content key generation equation) is included in the intermediate key groups MKGa to MKGn and a content key is obtained based on the equation.

Hereafter, it is explained in detail about the content distribution system 4 which is an embodiment of the content distribution system of the present invention.

<Structure of Content Distribution System 4>

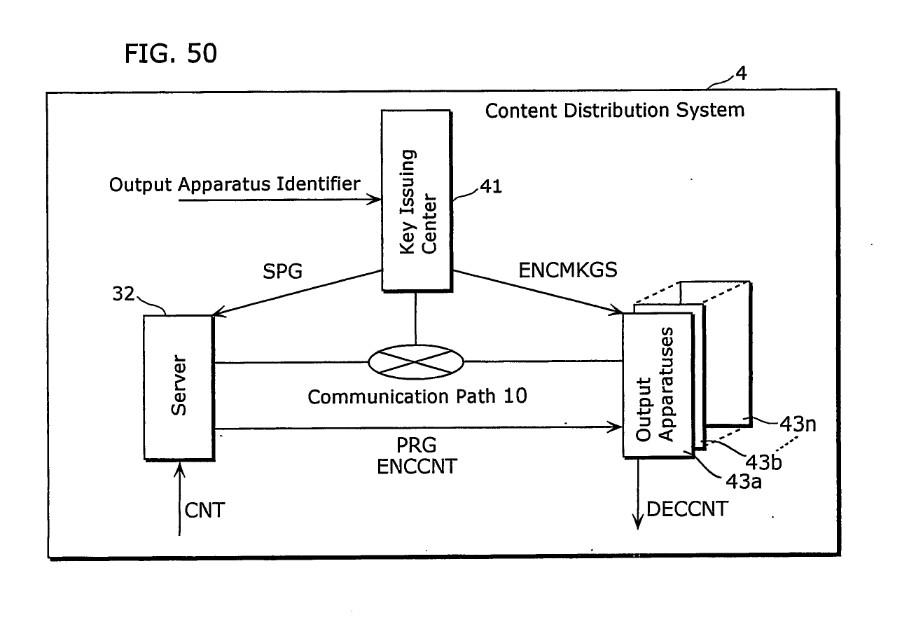

As shown in FIG. 50, the content distribution system 4 is made up of a communication path 10 same as in the first embodiment and a key issuing center 41, server 32 and plurality of output apparatuses 42a to 42n that are different as in the first embodiment. The role of each of the constituents is same as in the content distribution system 1.

Hereafter, it is explained in detail about these constituents. The explanation about the structure of the communication path 10 is omitted since it is same as in the content distribution system 1. The explanation about the server 32 is omitted since the structure and operations of the server 32 are same as in the content distribution system 3. Here, it is explained about structures and operations about a key issuing center 41 and an output apparatus 43 using diagrams.

<Structure of Key Issuing Center 41>

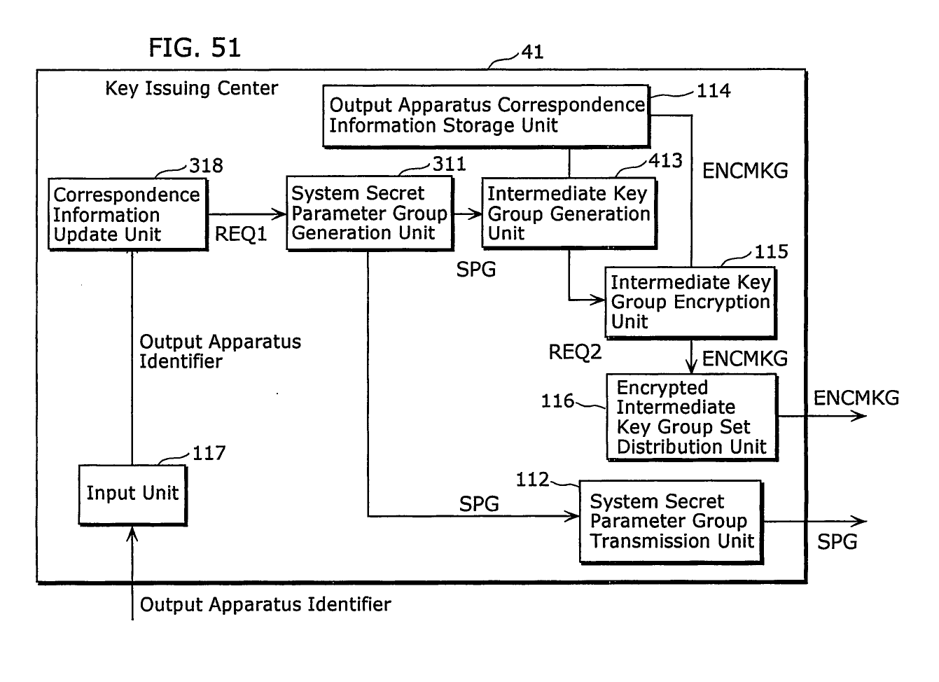

As shown in FIG. 51, the key issuing center 41 is made up of a system secret parameter group generation unit 311, a system secret parameter group transmission unit 112, an intermediate key group generation unit 413, an output apparatus correspondence information storage unit 114, an intermediate key group encryption unit 115, an encrypted intermediate key group set distribution unit 116, an input unit 117 and a correspondence information update unit 118. In FIG. 51, same marks are assigned to the same constituents as in FIG. 2 or FIG. 35 and the explanations about the same constituents are omitted in here.

(1) Intermediate Key Group Generation Unit 413

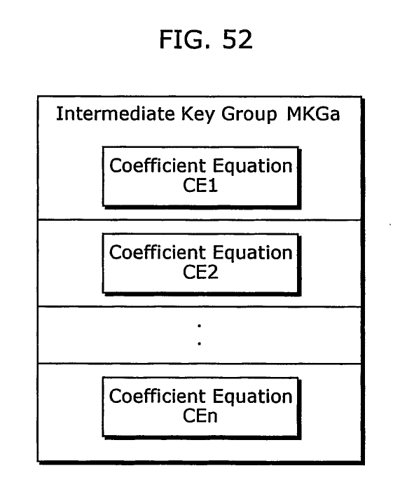

The intermediate key group generation unit 413, in the case of receiving the system secret parameter group SPG from the system secret parameter group generation unit 311, first deletes all of the intermediate key groups MKGa to MKGn in the output apparatus correspondence information storage unit 113. It then obtains (k+m) sets of key identifiers and content keys from the received system secret parameter group SPG. Next, it generates dummy keys DMK1 to DMKm and assigns respectively to m numbers of key identifiers to which a content key CK has not been assigned in the key identifiers KID1 to KIDk+m. Then, it describes in the two dimensional coordinate using the value of the key identifier as x-axis and the value of key as y-axis. Then, it obtains, for example, a (k+m+1) coordinate equation which passes all points on the two dimensional coordinate. Determining the coefficients of the equation as {CE1, CE2, . . . CKk+m+2}, it generates an intermediate key group MKGa which is composed of the equation coefficients CE1 to CKk+m+2 as shown in FIG. 52. It then stores the intermediate key group MKGa by associating with the output apparatus identifier AIDa in the output apparatus correspondence information storage unit 113. After that, this operation is performed on each of other output apparatus identifiers AIDb to AIDn in the output apparatus correspondence information storage unit 113. Here, a unique intermediate key group should be assigned respectively to each of the output apparatus identifiers AIDa to AIDn. After assigning all intermediate key groups MKGa to MKGn respectively to output apparatus identifiers AIDa to AIDn in the output apparatus correspondence information storage unit 113, the intermediate key group generation unit 413 outputs the encrypted intermediate key group generation request REQ2 to the intermediate key group encryption unit 115.

<Operation of Key Issuing Center 41>

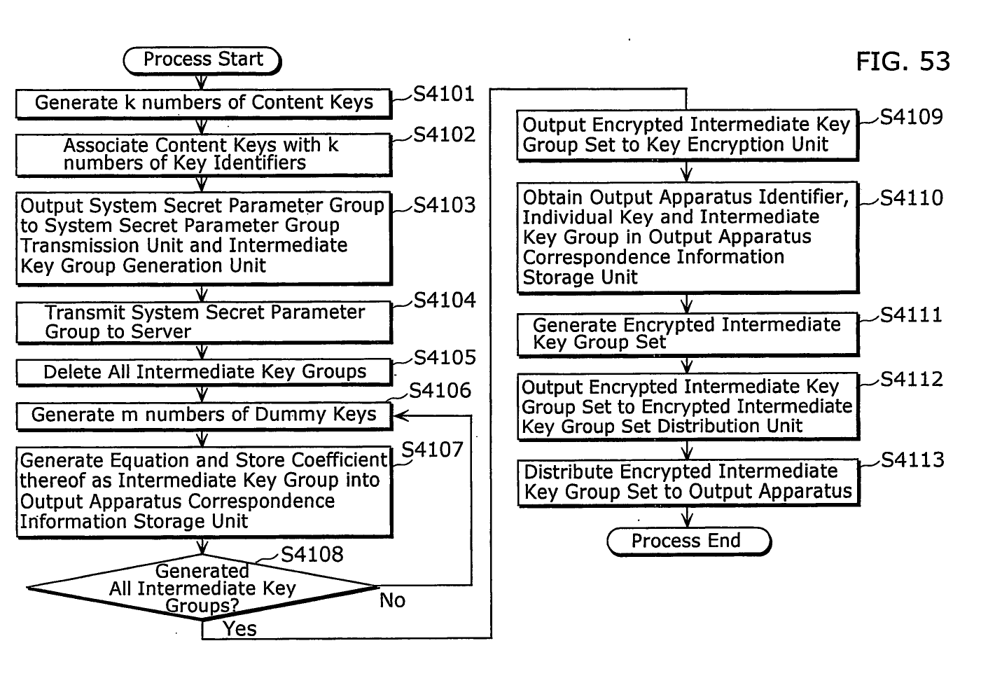

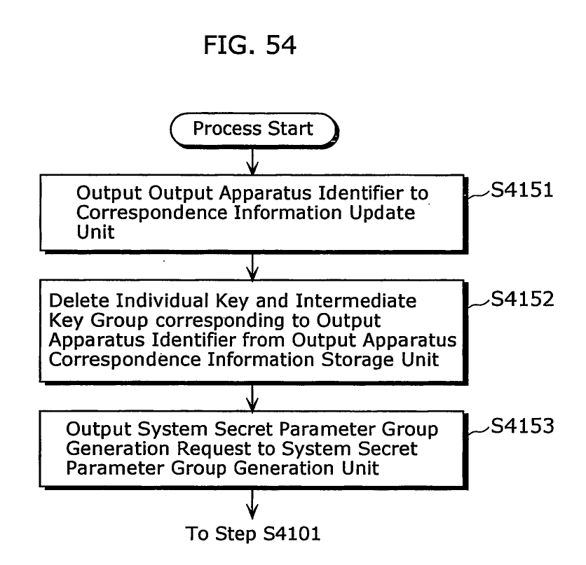

In the above, the structure of the key issuing center 41 is explained. Here, it is explained about operations of the key issuing center 41. First, an operation of the key issuing center 41 at distributing a key is explained using flowchart shown in FIG. 53. After that, it is explained using FIG. 54 about an operation of revoking an output apparatus.

<<Operation at Distributing Key>>

The system secret parameter group generation unit 311 generates k sets of content keys CK1, CK2, . . . and CKk (S4101).

The system secret parameter group generation unit 311 selects k sets out of the key identifiers KID1 to KIDk+m and associates k sets of content keys with the k sets of content keys (S4102).

The system secret parameter group transmission unit 112 transmits the received system secret parameter group SPG to the server 42 (S4104).

The intermediate key group generation unit 413 deletes all of the intermediate key groups MKGa to MKGn stored in the output apparatus correspondence information storage unit 114 (S4105).

The intermediate key group generation unit 413 generates and assigns dummy keys {DMK1, DMK2, . . . DMKm} to the m numbers of key identifiers to which a content key has not been assigned among the key identifiers KID1 to KIDk+m stored in the system secret parameter group SPG. Herein, the value of the generated dummy key should not be the same as the value of the previously generated dummy key (S4106).

The intermediate key group generation unit 413 describes a point in the two dimensional coordinate using the value of key identifier as x-axis and the value of corresponding key as y-axis. Next, it calculates an equation which passes all points on the two dimensional coordinate, for example, k+m+primary equation. It then generates an intermediate key group whose equation coefficients are composed of {CE1, CE2, . . . CK+m+2} (S4106).

The intermediate key group generation unit 413 associates and stores the intermediate key group with the output apparatus identifier to which an intermediate key group has not been assigned in the output apparatus correspondence information storage unit 114 (S4107).

If the intermediate key groups MKGa to MKGn are assigned respectively to the output apparatus identifiers AIDa to AIDn in the output apparatus correspondence information storage unit 114, the operation moves on to step S4109. If there are unassigned output apparatus identifiers, the operation returns to step S4106 (S4108).

The intermediate key group generation unit 413 outputs the encrypted intermediate key group set generation request REQ2 to the intermediate key group encryption unit 115 (S4109).

The intermediate key group encryption unit 115 which received the encrypted intermediate key group set generation request REQ2 accesses to the output apparatus correspondence information storage unit 114 and obtains all output apparatus identifiers AIDa to AIDn, individual keys IKa to IKn and intermediate key groups MKGa to MKGn (S4110).

The intermediate key group encryption unit 115 encrypts each of the intermediate key groups MKGa to MKGn based on each of the individual keys IKa to IKn and generates the encrypted intermediate key groups ENCMKGa=Enc (IKa, MKGa) to ENCMKGn=Enc (IKn, MKGn) and an encrypted intermediate key group set ENCMKGS={AIDa, ENCMKGa}∥ . . . ∥{AIDn, ENCMKGn} composed of the apparatus identifiers respectively corresponding to the individual keys used for the encryption (S4111).

The intermediate key group encryption unit 115 outputs the generated encrypted intermediate key group set ENCMKGS to the encrypted intermediate key group set distribution unit 116 (S4112).

The encrypted intermediate key group set distribution unit 116 receives the encrypted intermediate key group set ENCMKGS, distributes the received encrypted intermediate key group set ENCMKGS to the output apparatuses 13a to 13n and terminates the operation (S4113).

<<Operation at Revoking Output Apparatus 43a>>

The input unit 117 outputs the received output apparatus identifier AIDa to the correspondence information update unit 118 (S4151).

The correspondence information update unit 118 deletes the individual key IKa and intermediate key group MKGa corresponding to the received output apparatus identifier AIDa from the output apparatus correspondence information storage unit 114 (S4152).

The correspondence information update unit 118 outputs the system secret parameter group generation request REQ1 to the system secret parameter group generation unit 111 and moves on to step S4101 (S4153).

They are the structure and operations of the key issuing center 41 which is a constituent of the content distribution system 4. Next, it is explained about the structure and operations of the output apparatus 43.

<Structure of Output Apparatus 43a>

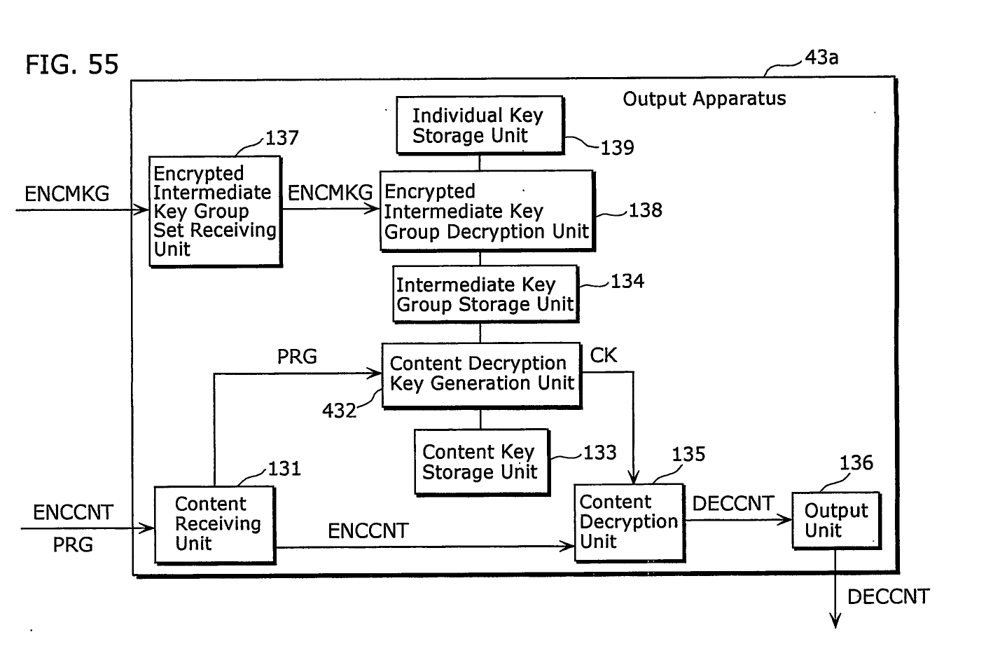

As shown in FIG. 55, the output apparatus 43a is made up of a content receiving unit 131, a content decryption key generation unit 432a, a content key storage unit 133, an intermediate key group storage unit 134a, a content decryption unit 135, an output unit 136, an encrypted intermediate key group set receiving unit 137, an encrypted intermediate key group decryption unit 138a, and an individual key storage unit 139a. In FIG. 55, same marks are assigned to the same constituents as in FIG. 17 and the explanations about the same constituents are omitted in here.

(1) Content Decryption Key Generation Unit 432a

When the content decryption key generation unit 432a receives a time varying parameter group PRG from the content receiving unit 131, it first verifies whether the use time varying parameter group UPRG stored in the content key storage unit 133 matches with the received time varying parameter group PRG. Here, if they match with each other, the content decryption key generation unit 432a accesses to the content key storage unit 133 and outputs the stored content key CK to the content decryption unit 135. If they do not match, it accesses to the intermediate key group storage unit 134a and obtains an intermediate key group MKGa. It then generates an output apparatus content key generation equation from equation coefficients extracted from the intermediate key group MKGa. After that, it obtains a key identifier from the time varying parameter group PRG and substitutes the key identifier into the output apparatus content key generation equation. It stores the value which is the result of substitution into the content key storage unit 133 as a content key CK and outputs the content key CK to the content decryption unit 135.

<Operation of Output Apparatus 43a>

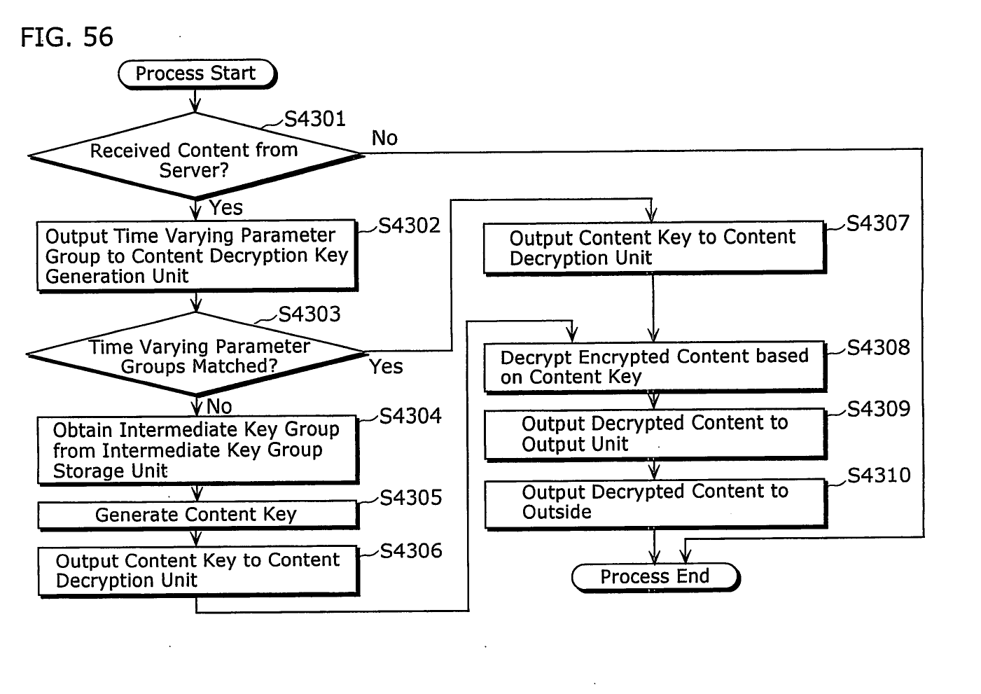

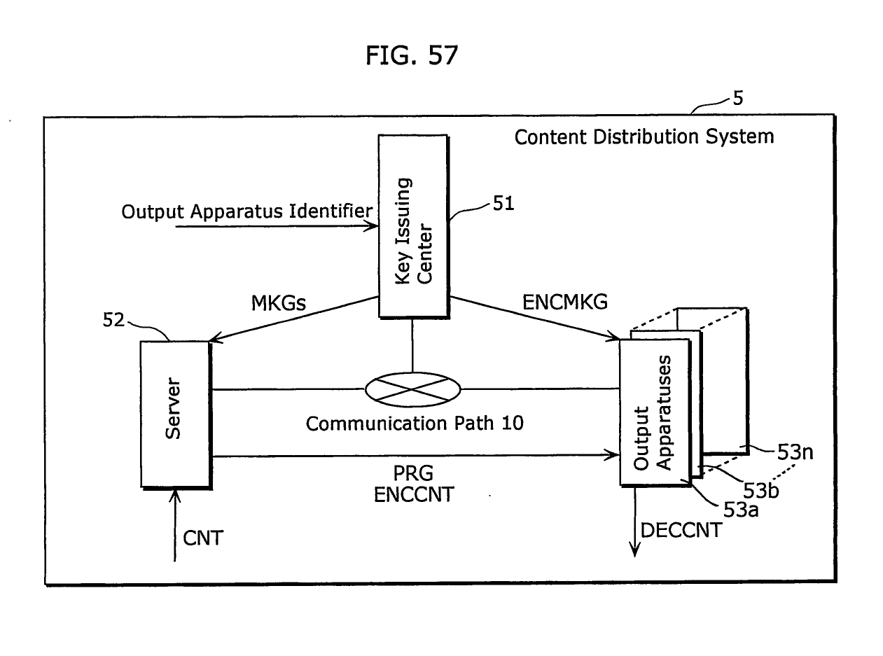

In the above, the structure of the output apparatus 43a is explained. Here, it is explained about the operation of the output apparatus 43a. First, an operation at receiving content is explained using a flowchart shown in FIG. 56. Then, an operation at updating a key is explained using a flowchart shown in FIG. 57.

<Operation at Receiving Content>

When the content receiving unit 131 receives an encrypted content ENCCNT and a time varying parameter group PRG, a process moves on to step S4302. When it does not receive them, the process is terminated (S4301).

The received time varying parameter group PRG is outputted to the content decryption key generation unit 432 (S4302).

The content decryption key generation unit 432 which received the time varying parameter group PRG accesses to the content key storage unit 133 and moves on to step S4307 when the use time varying parameter group UPRG which is same as the received time variant parameter group PRG is stored. When they are different, it moves on to step S4305 (S4303).

The content decryption key generation unit 432 accesses to the intermediate key group storage unit 134 and obtains the intermediate key group MKGa (S4304).

The content decryption key generation unit 432 generates an output apparatus content key generation equation from equation coefficients embedded in the intermediate key group MKGa. It then obtains a key identifier from the time varying parameter group PRG and substitutes the key identifier into the output apparatus content key generation equation. The value which is the result of the substitute is defined as content key CK (S4305).

The content decryption key generation unit 432 outputs the content key CK to the content decryption unit 135 and moves on to step S4308 (S4306).

The content decryption key generation unit 432 accesses to the intermediate key group storage unit 134a, obtains the content key CK and outputs the content key CK to the content decryption unit 135 (S4307).

The content decryption unit 135 decrypts the encrypted content ENCCNT based on the content key CK (S4308).

The content decryption unit 135 outputs the decrypted content DECCNT to the output unit 136 (S4309).

The output unit 136 receives the decrypted content DECCNT from the first decryption unit 136, outputs the received decrypted content DECCNT to the outside and terminates the process (S4310).

They are the structure and operations of the output apparatus 43 which is a constituent of the content distribution system 4.

<Verification of Operation in Fourth Embodiment>

The reason why, in the fourth embodiment, same content key CK can be obtained from all output apparatuses 33a to 33n in spite of the fact that a value of the intermediate key groups MKGa to MKGn is respectively assigned to each of the output apparatuses 33a to 33n is same as what is explained in the third embodiment.

<Effect of Fourth Embodiment>

The fourth embodiment basically has a similar effect as in the third embodiment. However, compared to the third embodiment, in the fourth embodiment, while the amount of operation processing in each of the output apparatuses 43a to 43n increases, the size of the encrypted intermediate key group set ENCMKGS that the key issuing center 41 distributes to the output apparatuses 43a to 43n can be reduced.

<Variations of Fourth Embodiment>

The embodiment explained in the above is an example of the embodiments of the present invention. Therefore, the present invention is not restricted to this embodiment. It can be embodied in main condition within a range which does not exceed the context of the embodiment. The following cases are also included in the present invention.

(1) The communication path 10 may be a broadcasting network such as terrestrial broadcasting and satellite broadcasting.

(2) The server 42 may also play a role of the key issuing center 41. That is, the server 42 may receive output apparatus identifiers and transmit the encrypted intermediate key group set ENCMKGS respectively to the output apparatuses 43a to 43n based on the output apparatus identifiers.

(3) The intermediate key group generation unit 413 of the key issuing center 41 may receive the intermediate key group generation request information REQ3 from outside and generate an intermediate key based on the intermediate key group generation request information REQ3.

(4) The key issuing center 41 may transmit the intermediate key in place of the system secret parameter group SPG to the server 42.

(5) The time varying parameter group generation unit 428 of the server 42 may receive the time varying parameter group generation request information REQ4 from the outside and generate the time varying parameter group PRG based on the time varying parameter group generation request information REQ4.

(6) Whereas, in the fourth embodiment, the number of output apparatuses are 14 (43a to 43n), the number may be 15 or more, or 13 or less.

(7) When the key issuing center 41 distributes the encrypted intermediate key group set ENCMKG, it may be distributed to the output apparatuses 43a to 43n at the same time or separately to each of the output apparatuses 43a to 43n.

(10) The present invention may be the methods described in the above. Also, it may be a computer program causing a computer to execute those methods and a digital signal which composed of the computer program. Further, the present invention may be a recording medium which can read the computer program or the digital signal by a computer. For example, it may be recorded in a flexible disc, a hard disk, a CD-ROM, an MO, a DVD, a DVD-ROM, a DVD-RAM, a Blu-ray Disc (BD), a semiconductor memory and the like. Also, it may be the computer program or the digital signal stored in these recording mediums. Furthermore, the present invention may transmit the computer program or the digital signal via a telecommunication line, wireless or wire communication line, a network, notably the Internet, and the like. The present invention is a computer system having a microprocessor and a memory. The memory stores the computer program and the microprocessor may operate according to the computer program. Also, it may be embodied by another independent computer system by recording and transferring the program or the digital signal recorded in the recording medium.

(9) The embodiments and the variations may be combined to each other.

### Fifth Embodiment

It is explained about a content distribution system 5 as the fifth embodiment according to the present invention. In the content distribution system 1 in the first embodiment, each of the output apparatuses 13a to 13n generates a content key CK using algebraic operation. The content distribution system 5 in the fifth embodiment largely differs with the first embodiment in that each of the output apparatuses 53a to 53n generates a content key CK using a shift register.

Hereafter, it is explained in detail about the content distribution system 5 that is an embodiment of the content distribution systems of the present invention.

<Structure of Content Distribution System 5>

As shown in FIG. 57, the content distribution system 5 is made up of a communication path 10 which is same as in the first embodiment, and a key issuing center 51, server 52 and plurality of output apparatuses 53a to 53n that are different from the first embodiment. The role of each of the constituents is same as in the content distribution system 1.

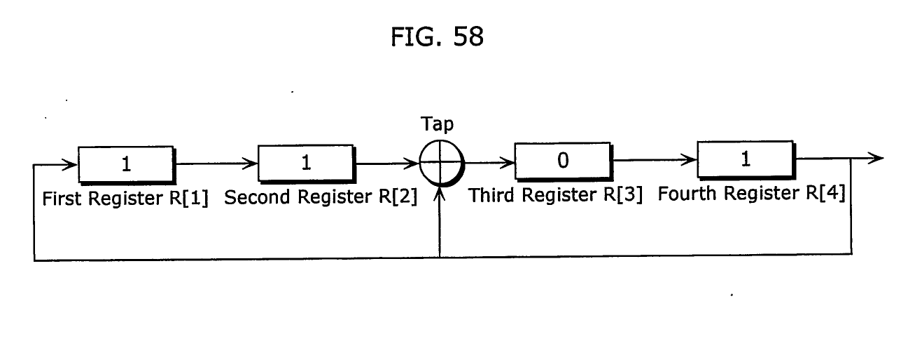

Here, it is explained about a structure and operations of a shift register commonly used by the key issuing center 51, the server 52 and the output apparatuses 53a to 53n using FIG. 58 to FIG. 60. First, it is explained about the structure of the shift register using FIG. 58. FIG. 58 shows a shift register which is formed of four registers of a first register R[1], a second register R[2], a third register R[3] and a fourth register R[4], and one tap between the second register R[2] and the third register R[3]. Here, in order to make the explanation easier, the number of registers is set as 4 and the number of taps is set as 1. However, the numbers of registers and taps can be any numbers. As a method of connecting to a tap, for example, there is a method of using a primitive polynomial as similar to M-series disclosed in the non-patent literature 4 (Eiji Okamoto, “Introduction to Cryptography Theory (Ango Riron Nyumon)”, Kyoritsu Publications). A value of binary data 0 or 1 is stored in each of the registers. In FIG. 58, 1 is stored in the first register R[1], 1 is stored in the second register R[2], 0 is stored in the third register R[3], and 1 is stored in the fourth register R[4]. Also, the tap indicates an exclusive OR operation.

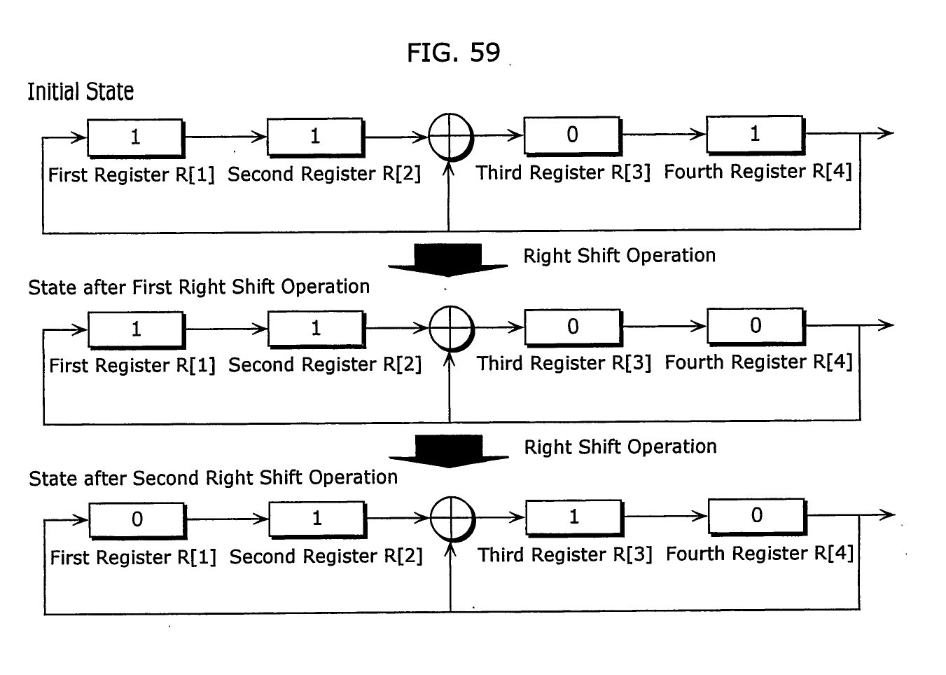

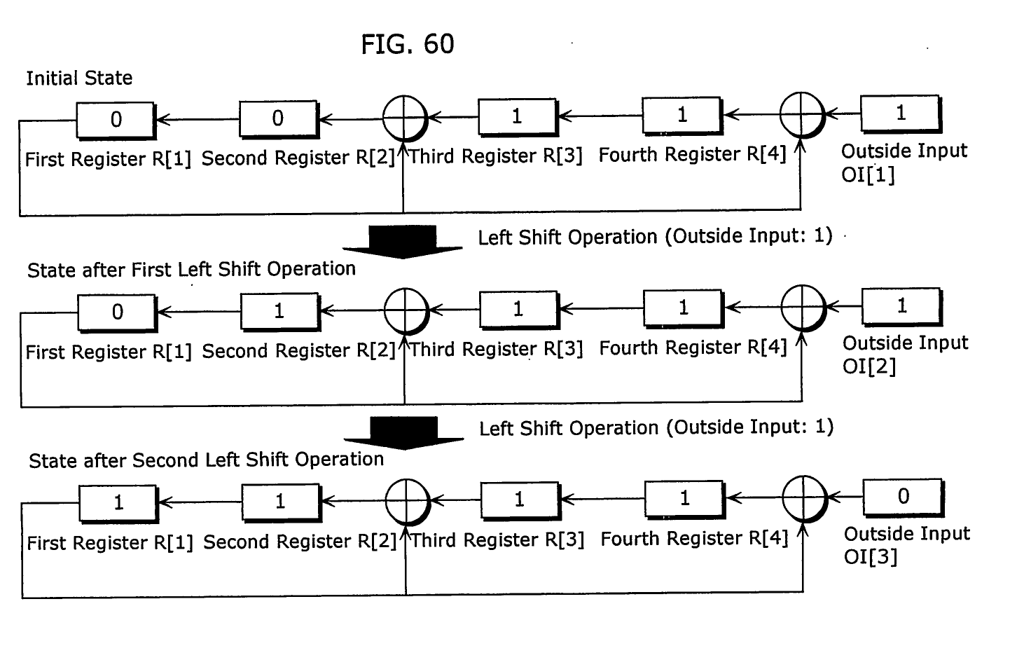

Next, it is explained about two operations of the shift register. They are a right shift operation and a left shift operation. The right shift operation is explained using FIG. 59 and the left shift operation is explained using FIG. 60.

First, it is explained about the right shift operation in the shift register. After the first right shift operation, the value of the third register R[3] before the shifting is stored in the fourth register R[2], the value of the first register R[1] before the shifting is stored in the second register R[2], and the value of the fourth register R[4] before the shifting is stored in the first register R[1]. Then, the value obtained by calculating an exclusive OR between the value of the fourth register R[4] before the shifting and the value of the second register R[2] before the shifting is stored in the third register R[3]. Therefore, as shown in FIG. 59, when, in an initial state, 1 is stored in the first register R[1], 1 is stored in the second register [2], 0 is stored in the third register R[3], and 1 is stored in the fourth register R[4], after shifting once to the right from the initial state, 1 is stored in the first register R[1], 1 is stored in the second register R[2], 0 is stored in the third register R[3], and 0 is stored in the fourth register R[4]. Then, after further shifting once to the right, as shown in the bottom on FIG. 59, 0 is stored in the first register R[1], 1 is stored in the second register R[2], 1 is stored in the third register R[3], and 0 is stored in the fourth register R[4].

Next, it is explained about a left shift operation in the shift register. After shifting once to the left, the value of the second register R[2] before the shifting is stored in the first register R[1] and the value of the fourth register R[4] is stored in the third register R[3]. Then, the value obtained by calculating an exclusive OR between the value of the third register R[3] before the shifting and the value of the first register R[1] before the shifting is stored in the second register R[2]. Also, the value obtained by calculating an exclusive OR between the value of the first register R[1] before the shifting and the value of each of the outside inputs OI[1] to OI[4] is stored in the fourth register R[4]. Therefore, as shown on the top in FIG. 60, in the initial state of the shift register, when 0 is stored in the first register R[1], 0 is stored in the second register R[2], 1 is stored in the third register R[3], and 1 is stored in the fourth register R[4], after once shifting from the initial state to the left defining the output input I[1] as 1, as shown in FIG. 60, 0 is stored in the first register R[1], 1 is stored in the second register R[2], 1 is stored in the third register R[3], and 1 is registered in the fourth register R[4]. Then, after further shifting once to the left defining the output input OI[2] as 1 from the shifted condition, as shown on the bottom in FIG. 60, 1 is stored in the first register R[1], 1 is stored in the second register R[2], 1 is stored in the third register R[3], and 1 is stored in the fourth register R[4].

They are the structure and operations of the shift register used by the key issuing center 51, the server 52 and the output apparatuses 53.

Hereafter, it is explained in detail about the constituents of the content distribution system 5. The structure of the communication path 10 is same as in the content distribution system 1 so that the explanation about the communication path 10 is omitted. Here, the structures and operations of the key issuing center 51, the server 52, and the output apparatuses 53a to 53n are explained using diagrams.

<Structure of Key Issuing Center 51>

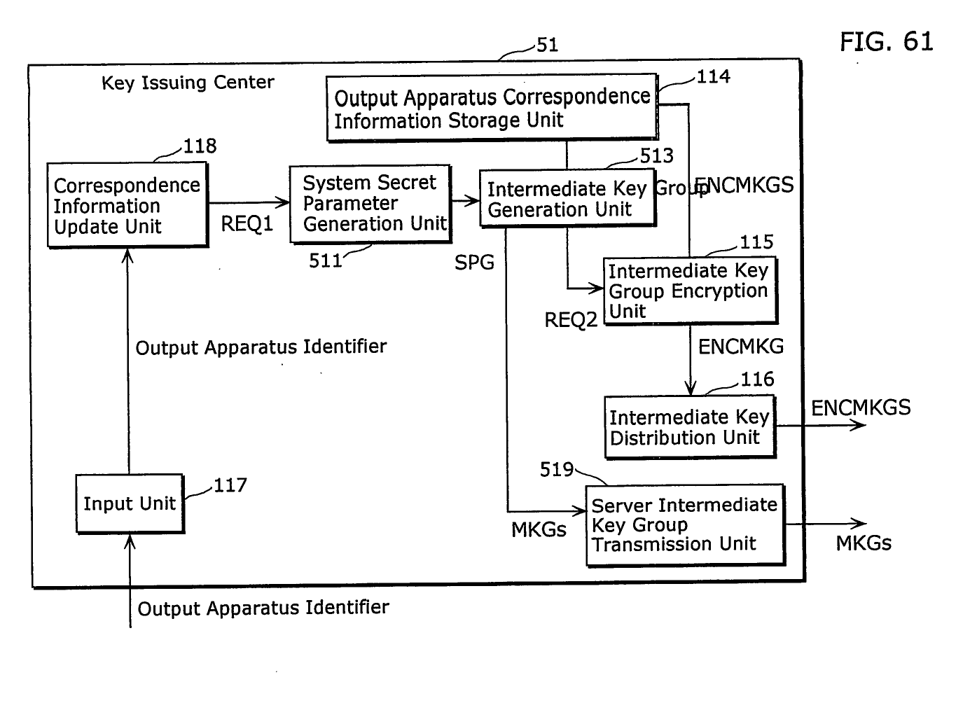

As shown in FIG. 61, the key issuing center 51 is made up of a system secret parameter group generation unit 511, an intermediate key group generation unit 513, an output apparatus correspondence information storage unit 114, an intermediate key group encryption unit 115, an encrypted intermediate key group set distribution unit 116, an input unit 117, a correspondence information update unit 118, and a server intermediate key group transmission unit 519. In FIG. 61, same marks are assigned to the same constituents as in FIG. 2 and the explanations about the same constituents are omitted in here.

(1) System Secret Parameter Group Generation Unit 511

The system secret parameter group generation unit 511 generates a new system secret parameter group SPG of t bits and outputs the system secret parameter group SPG to the intermediate key group generation unit 513. Here, as a method of generating system secret parameter group SPG, there is, for example, a method of randomly generating the system secret parameter group SPG using random numbers.

(2) Intermediate Key Group Generation Unit 513

In the case of receiving the system secret parameter group SPG from the system secret parameter group generation unit 511, the intermediate key group generation unit 513 first deletes all intermediate key groups MKGa to MKGn in the output apparatus correspondence information storage unit 113. The intermediate key group generation unit 513 holds a shift register SR formed of (t+r) numbers of registers and v numbers of taps. The content encryption key generation unit 529 of the server 52 and each of the content decryption key generation units 532 of the output apparatuses 53a to 53n hold this same shift register SR. First, the system secret parameter group SPG of t bits is expressed in bits and substituted into the first register R[1] to the t-th register R[t]. After that, the intermediate key group generation unit 513 generates an individualized parameter x of r bits and substitutes the individualized parameter x expressed in bits into the (t+1) register R[t+1] to the (t+r) register R[t+r]. Here, as a method of generating an individualized parameter x, there is, for example, a method of randomly generating the individualized parameter x using random numbers. It then shifts the shift register SR in that state to the right for u times. The intermediate key group generation unit 513 defines the value connecting in bits the values of the first register R1 to the (t+r) register R[t+r] after the u times of right shifts as the intermediate key group MKGa, associates and stores the intermediate key group MKGa with the output apparatus identifier AIDa of the output apparatus correspondence information storage unit 113. This operation is performed on all of the output apparatus identifiers AIDb to AIDn other than the output apparatus identifier AIDa in the output apparatus correspondence information storage unit 113. Here, a unique intermediate key group should be assigned to each of the output apparatus identifiers. When the intermediate key groups MKGa to MKGn are all assigned respectively to the output apparatus identifiers AIDa to AIDn in the output apparatus correspondence information storage unit 113, the intermediate key group generation unit 513 outputs the encrypted intermediate key group generation request REQ2 to the intermediate key group encryption unit 115. Lastly, similar to other intermediate key groups MKGa to MKGn, it generates one more intermediate key group and outputs the generated intermediate key group to the server intermediate key group transmission unit 519 as a server intermediate key group MKGs. Here, for example, t is 128, r is 32 and u is 160.

(3) Server Intermediate Key Group Transmission Unit 519

The server intermediate key group transmission unit 519 transmits the server intermediate key group MKGs received from the intermediate key group generation unit 513 to the server 52 via communication path 10.

<Operations of Key Issuing Center 51>

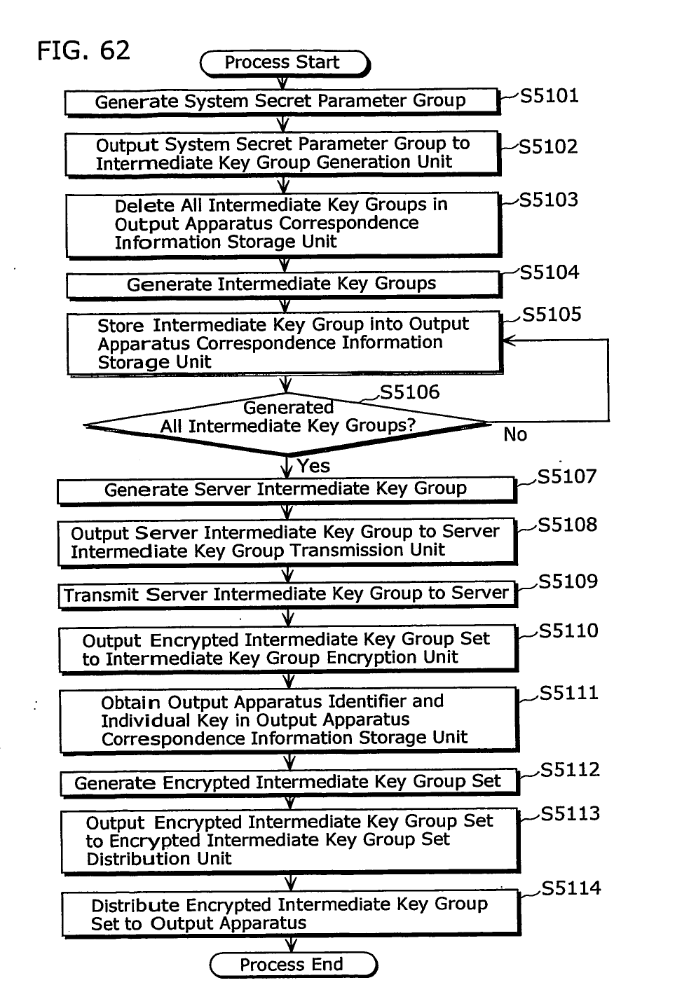

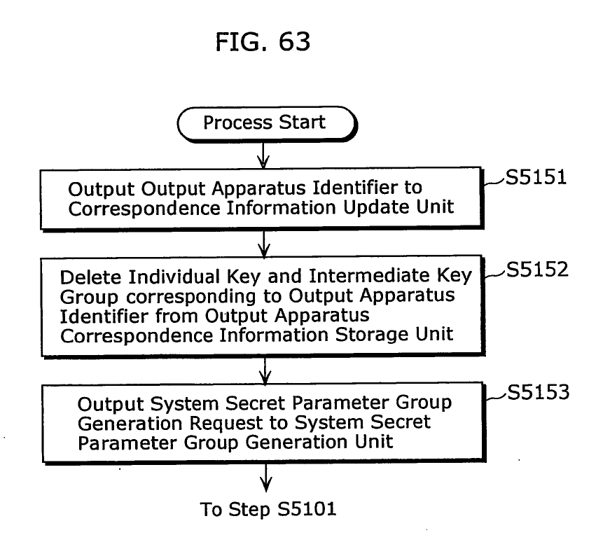

In the above, the structure of the key issuing center 51 is explained. Here, it is explained about operations of the key issuing center 51. First, an operation at distributing key information necessary for sharing a content key is explained using a flowchart shown in FIG. 62. After that, an operation at revoking the output apparatus 53a is explained using a flowchart shown in FIG. 63.

<<Operation at Distributing Key Information>>

The system secret parameter group generation unit 511 generates a system secret parameter group SPG of t bits (S5101).

The system secret parameter group generation unit 511 outputs the system secret parameter group SPG to the intermediate key group generation unit 513 (S5102).

The intermediate key group generation unit 513 deletes all of the intermediate key groups MKGa to MKGn stored in the output apparatus correspondence information storage unit 114 (S5103).

The intermediate key group generation unit 513 which received the system secret parameter SPG expresses the system secret parameter group SPG of t bits in bits and substitutes it to the first register R[1] to the t register R[t]. It then generates an individualized parameter x of r bits and substitutes the generated individualized parameter x into the (t+1) register R[t+1] to the register R[t+r]. After that, it performs right shifting u times on the shift register SR in that state. It obtains, as an intermediate key group, values of the first register R[1] to the (t+r) register R[t+r] after shifting to the right for u times (S5104).

The intermediate key group generation unit 513 associates and stores the intermediate key group with an output apparatus identifier to which an intermediate key group has not been assigned yet in the output apparatus correspondence information storage unit 113 (S5105).

The intermediate key group generation unit 513 moves on to step S5107 when intermediate key groups MKGa to MKGn are all respectively assigned to the output apparatus identifiers AIDa to AIDn in the output apparatus correspondence information storage unit 114. When there are unassigned output apparatus identifiers, it returns to step S5104 (S5106).

The intermediate key group generation unit 513, similar to the intermediate key groups MKGa to MKGn, generates one more intermediate key group and defines it as a server intermediate key group MKGa (S5107).

The intermediate key group generation unit 513 outputs the server intermediate key group MKGs to the server intermediate key group transmission unit 519 (S5108).

The server intermediate key group transmission unit 519 distributes the server intermediate key group MKGs to the output apparatuses 53a to 53n (S5109).

The intermediate key group generation unit 513 outputs the encrypted intermediate key group set generation request REQ2 to the intermediate key group encryption unit 115 (S5110).

The intermediate key group encryption unit 115 which received the encrypted intermediate key group generation request REQ2 accesses to the output apparatus correspondence information storage unit 114 and obtains groups formed of each of the output apparatus identifiers AIDa to AIDn, the individual keys IKa to IKn and the intermediate key groups MKGa to MKGn (S5111).

The intermediate key group encryption unit 115 encrypts each of the intermediate key groups MKGa to MKGn based on one of the individual keys IKa to IKn and generates an encrypted intermediate key group set ENCMKGS which is formed of the apparatus identifiers corresponding to the encrypted intermediate keys and the individual keys used for the encryption (S5112).

The intermediate key group encryption unit 115 outputs the encrypted intermediate key group week y-issue ENCMKGS to the encrypted intermediate key group set distribution unit 116 (S5113).

The encrypted intermediate key group set distribution unit 116 receives the encrypted intermediate key group set ENCMKGS, distributes the received encrypted intermediate key group set ENCMKGS to the output apparatus 53 and terminates the process (S5114).

<<Operation at Revoking Output Apparatus 53a>>

The input unit 117 outputs the received output apparatus identifier AIDa to the correspondence information update unit 118 (S5151).

The correspondence information update unit 118 deletes the individual key IKa and the intermediate key group MKGa corresponding to the received output apparatus identifier AIDa from the output apparatus correspondence information storage unit 114 (S5152).

The correspondence information update unit 118 outputs the system secret parameter group generation request REQ1 to the system secret parameter group generation unit 111 and moves on to steps S5101 (S5153).

They are the structure and operations of the key issuing center 51 which is a constituent of the content distribution system 5. In the following, it is explained about the structure and operations of the server 52.

<Structure of Server 52>

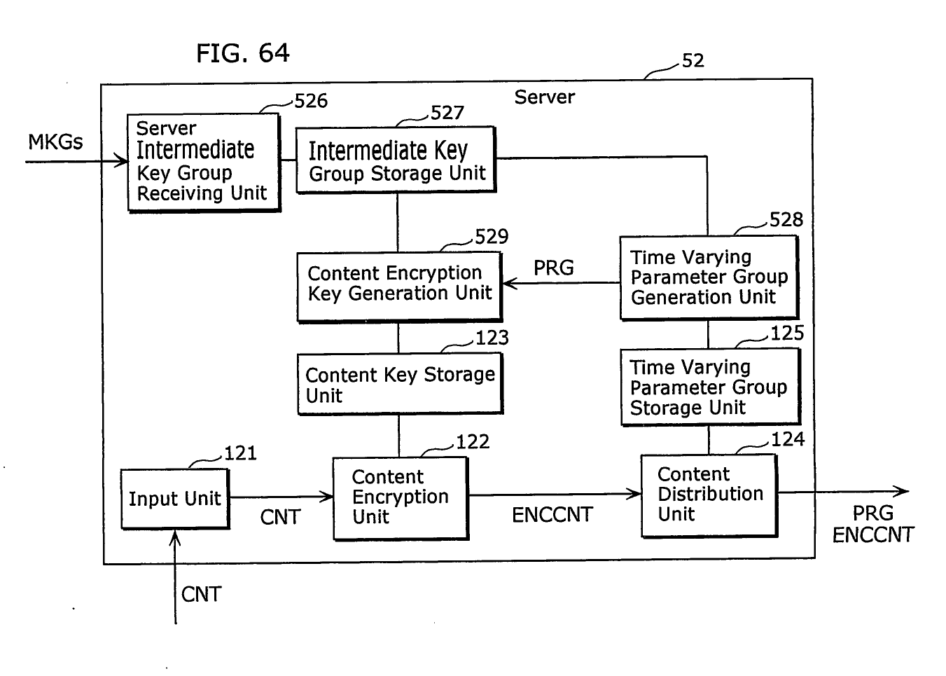

As shown in FIG. 64, the server 52 is made up of an input unit 121, a content encryption unit 122, a content key storage unit 123, a content distribution unit 124, a time varying parameter group storage unit 125, a server intermediate key group receiving unit 526, an intermediate key group storage unit 527, a time varying parameter group generation unit 528, and a content encryption key generation unit 529. In FIG. 62, same marks are assigned to the same constituents as in FIG. 9. Here, the explanations about the same constituents are omitted.

(1) Server Intermediate Key Group Receiving Unit 526

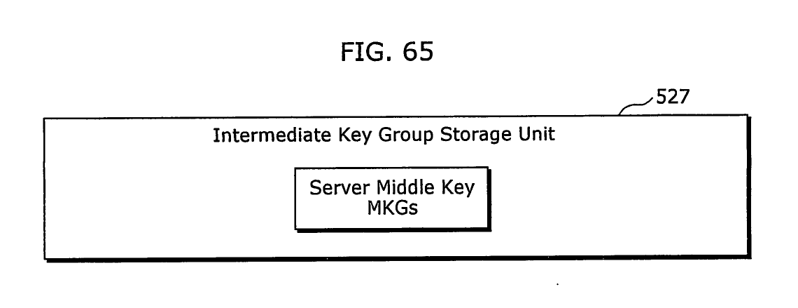

In the case of receiving the server intermediate key group MKGs from the key issuing center 51, the server intermediate key group receiving unit 526 stores the received intermediate key group MKGs into the intermediate key group storage unit 527 as shown in FIG. 65.

(2) Intermediate Key Group Storage Unit 527

As shown in FIG. 65, the intermediate key group storage unit 527 holds the intermediate key groups MKGs. The content encryption key generation unit 529 can access to the intermediate key group storage unit 527.

(3) Time Varying Parameter Group Generation Unit 528

When the time varying parameter group generation unit 528 satisfies a pre-given time varying parameter group update condition, it generates a time varying parameter group PRG of u bits, stores the time varying parameter group PRG into the time varying parameter group storage unit 125 and outputs the stored time varying parameter group PRG to the content encryption key generation unit 529. Here, as a method of generating a time varying parameter group PRG of u bits, there is a method of randomly generating it using random numbers. Herein, the parameter u in the time varying parameter group generation unit 528 is the same value as the parameter u in the intermediate key group generation unit 513.

(4) Content Encryption Key Generation Unit 529

In the case of receiving the time varying parameter group PRG from the time varying parameter group generation unit 528, the content encryption key generation unit 529 first obtains server intermediate key groups MKGs from the intermediate key group storage unit 527. It then substitutes the server intermediate key groups MKGs of (t+r) bits into registers of the shift register SR, and performs left shift u times using the time varying parameter group PRG of u bits inputted from outside. The value of the shift register SR after being shifted u times extracting the t-th register unit R[t] from the first register unit R[1] is defined as content key CK and stored into the content key storage unit 123. Here, the shift register SR is the same register used in the intermediate key group generation unit 513. Further, the parameter u in the content encryption key generation unit 529 is the same value as the parameter u in the intermediate key group generation unit 513.

<Operation of Server 52>

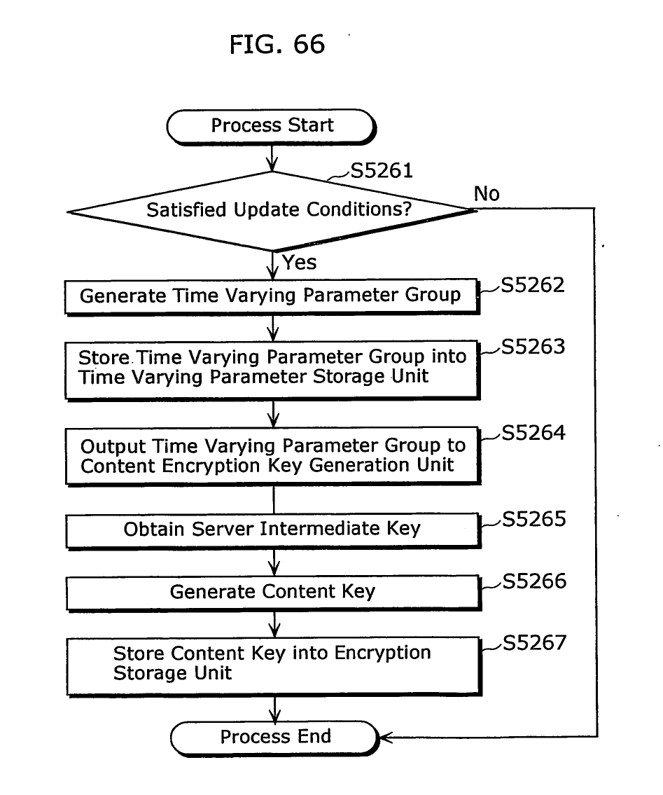

In the above, the structure of the server 52 is explained. Here, it is explained about an operation of the server 52. The operation at distributing content and an operation at receiving system secret parameter group are same operations as those of the server 12. Therefore, the same explanations are omitted. Here, it is explained about an operation at updating the time varying parameter group with reference to a flowchart shown in FIG. 66.

<<Operation at Updating Time Varying Parameter Group PRG>>

When the time varying parameter group generation unit 528 satisfies a pre-given time varying parameter group update condition, an operation moves on to step S5262. When it does not satisfy the condition, the operation is terminated (S5261).

The time varying parameter group generation unit 528 generates a time varying parameter group PRG of t bits (S5262).

The time varying parameter group generation unit 528 stores the time varying parameter group PRG into the time varying parameter group storage unit 125 (S5263).

The time varying parameter group generation unit 528 outputs the time varying parameter group PRG to the content encryption key generation unit 529 (S5264).

The content encryption key generation unit 529 which received the time varying parameter group PRG first accesses to the intermediate key group storage unit 527 and obtains server intermediate key groups MKGs (S5265).

The content encryption key generation unit 529 substitutes the server intermediate key groups MKGs of (t+r) bits into registers of the shift register SR, inputs the time varying parameter group PRG of u bits from outside and performs left shift u times. The value obtained by extracting the values from the t-th register R[t] to the first register R[1] of the shift register SR after being left shifted u times from the first register R[1] is defied as a content key CK (S5266).

The content encryption key generation unit 529 stores the obtained content key CK into the content key storage unit 123 (S5267) and terminates the process.

They are the structure and operation of the server 52 which is a constituent of the content distribution system 5. Following that, it is explained about a structure and operation of the output apparatus 53.

<Structure of Output Apparatus 53a>

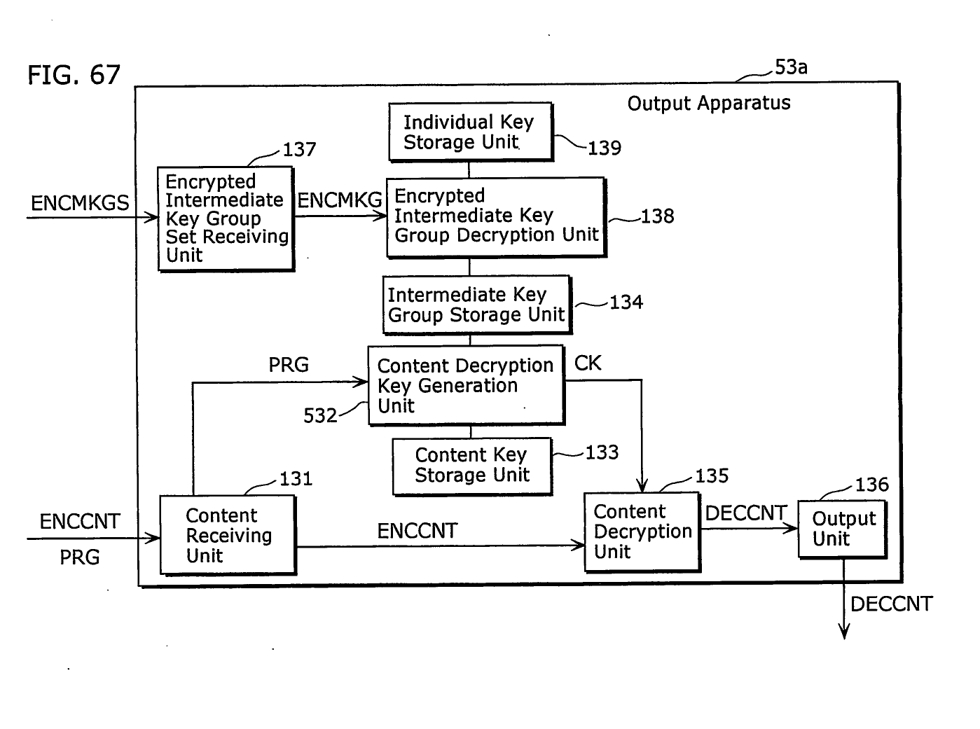

As shown in FIG. 67, the output apparatus 53a is made up of a content receiving unit 131, a content decryption key generation unit 532a, a content key storage unit 133, an intermediate key group storage unit 134a, a content decryption unit 135, an output unit 136, an encrypted intermediate key group set receiving unit 137, an encrypted intermediate key group decryption unit 138a, and an individual key storage unit 139a. In FIG. 66, same marks are assigned to the same constituents as in FIG. 17. The explanations about the same constituents are omitted in here.

(1) Content Decryption Key Generation Unit 532a

In the case of receiving a time varying parameter group PRG from the content receiving unit 131, the content decryption key generation unit 532a first verifies whether the time varying parameter group PRG stored in the content key storage unit 133 matches with the received time varying parameter group PRG. Here, when they match, the content decryption key generation unit 532a accesses to the content key storage unit 133 and outputs the stored content key CK to the content decryption unit 135. If they do not match, it accesses to the intermediate key group storage unit 134a and obtains an intermediate key group MKGa. Then, it substitutes the intermediate key group MKGa of (t+r) bits into the registers of the shift register SR, uses the time varying parameter group PRG of u bits as output input OI[1] to OI[t+r], and outputs the content key CK to the content key decryption unit 135.

<Operation of Output Apparatus 53a>

In the above, the structure of the output apparatus 53a is explained. Here, it is explained about an operation of the output apparatus 53a. Since the operation at updating key is same as that by the output apparatus 13a, the explanation about the operation is omitted. Here, it is explained about an operation at receiving content using a flowchart shown in FIG> 68.

<<Operation at Receiving Content>>

The content receiving unit 131 moves on to step S5302 when it receives the encrypted content ENCCNT and the time varying parameter group PRG. When it does not receive them, the process is terminated (S5301).

The content receiving unit 131 outputs the received time varying parameter group PRG to the content decryption key generation unit 532 (S5302).

The content decryption key generation unit 532 which received the time varying parameter group PRG accesses to the content key storage unit 133 and moves on to step S5307 when the received time varying parameter group PRG and the use time varying parameter group UPR are the same. If they are different, it moves on to step S5303 (S5303).

The content decryption key generation unit 532 accesses to the intermediate key group storage unit 134 and obtains an intermediate key group (S5304).

The content decryption key generation unit 532 substitutes the intermediate key group into registers of the shift register SR and uses the time varying parameter group of u bits as output inputs OI[1] to OI[u] and performs left shifting u times. Extracting the t-th register R[t] from the first register R[1] which are values of registers after being shifted to the left u times is defined as content key CK (S5305).

The content decryption key generation unit 532 stores the content key CK into the content key storage unit 133 and further outputs the content key CK into the content decryption unit 135 (S5306).

The content decryption key generation unit 132 accesses to the intermediate key group storage unit 134a, obtains the content key CK and outputs the content key CK to the content decryption unit 135 (S5307).

The content decryption unit 135 decrypts the encrypted content ENCCNT based on the content key CK (S5308).

The content decryption unit 135 outputs the decrypted content DECCNT to the output unit 136 (S5309).

The output unit 136 receives the decrypted content DECCNT from the first decryption unit 136, outputs the received decrypted content DECCNT to the outside, and terminates the process (S5310).

They are the structure and operation of the output apparatus 53 which is a constituent of the content distribution system 5.

<Verification of Operation in Fifth Embodiment>

Here, the operation is verified using specific values. First, as a shift register SR, the shift register shown in FIG. 58 is used. Then, determining the number of bits of the system secret parameter group SPG as 2, the number of bits of the individualized parameter x as 2, 2 bits of the first register R[1] and the second register [2] as a system secret parameter SR, and the third register R[1] and the fourth register R[4] as an individualized parameter x. That is, the first register R[1] and the second register R[2] are common values for all output apparatuses and the third register R[3] and the fourth register R[4] are values for individual output apparatuses. Here, as a system secret parameter group SPG, determining the first register R[1] as 1 and the second register R[2] as 0. Also, as an individualized parameter x of the output apparatus 53b, determining the third register R[3] as 1 and the fourth register R[4] as 0. Also the number of right shifting u is determined as 4.

In this case, as intermediate key groups MKGa to MKGb, the intermediate key group MKGa of the output apparatus 53a has values 1 for the first register R[1], 0 for the second register R[2], 1 for the third register R[3], and 0 for the fourth register R[4]. The intermediate key group MKGb of the output apparatus 53b has values 0 for the first register R[1], 0 for the second register R[2], 1 for the third register R[3], and 0 for the fourth register R[4]. Then, when output inputs OI[1] to OI[4] are all 0 to each of the intermediate key groups MKGa to MKGb, in the case of the output apparatus 53a, the first register R[1] is 1, the second register R[2] is 0, the third register R[3] is 0, and the fourth register R[4] is 0. In the case of the output apparatus 53b, the first register R[1] is 1, the second register R[2] is 0, the third register R[3] is 1, and the fourth register R[4] is 0. That is, the output apparatuses 53a to 53b can obtain, as a common content key, values of 1 for the first register R[1] and 0 for the second register R[2]. Also, when values for the output inputs are 0 for the output input OI[1], 1 for the output input OI[2], 1 for the output input OI[3] and 0 for the output input OI[4], in the case of the output apparatus 53a, the first register R[1] is 1, the second register R[2] is 1, the third register R[3] is 1 and the fourth register R[4] is 0. In the case of the output apparatus 53b, the first register R[1] is 1, the second register R[2] is 1, the third register R[3] is 1 and the fourth register R[4] is 0. That is, similarly, as a common content key, they can obtain values 1 for the first register R[1] and 0 for the second register R[2].

<Effect of Fifth Embodiment>

The fifth embodiment has same effects as in the first embodiment. However, it differs with the first embodiment in that the plurality of output apparatuses 53a to 53n generates a content key CK using a shift register.

<Variations of Fifth Embodiment>

The embodiment explained in the above is an example of the embodiments of the present invention. Therefore, the present invention is not restricted to this embodiment. It can be implemented in main condition in a range which does not exceed the context of the embodiment. The following cases are also included in the present invention.

(1) The communication path 10 may be a broadcasting network such as terrestrial broadcasting and satellite broadcasting.

(2) The server 52 can also play a role of key issuing center 51. That is, the server 52 receives output apparatus identifiers and transmits the encrypted intermediate key group set ENCMKGS respectively to the output apparatuses 53a to 53n based on the output apparatus identifiers.

(3) The intermediate key group generation unit 513 of the key issuing center 51 may receive the intermediate key group generation request information REQ3 from the outside and generate an intermediate key based on the intermediate key group generation request information REQ3.

(4) The time varying parameter group generation unit 528 of the server 12 may receive the time varying parameter group generation request information REQ4 from the outside and generate a time varying parameter group PRG based on the time varying parameter group generation request information REQ4.

(5) The number of right shifts by the intermediate key group generation unit 513 and the number of left shifts by the content encryption key generation unit 529 and the content decryption key generation unit 532 may not need to be the same numbers.

(6) While, in the fifth embodiment, the number of output apparatuses are 14 (53a to 53n), the number may be 15 or more, or 13 or less.

(7) When the key issuing center 51 distributes the encrypted intermediate key group set ENCMKG, it may distribute to the output apparatuses 53a to 53n at the same time or distribute separately to each of the output apparatuses 53a to 53n.

(8) The method of connecting tap of shift registers held by the key issuing center 51, the server 52 and the output apparatuses 53a to 53n, for example, does not need to be a primitive polynomial similar to the M series disclosed in the non-patent literature (Eiji Okamoto, “Introduction to Encryption Theory”, Kyoritsu Publications). The key issuing center 51, the server 52 and the output apparatuses 53a to 53n may have a common tap connecting method. For example, tap may be set randomly using random numbers.

(9) The present invention may be the methods described in the above. Also, the present invention may be a computer program causing a computer to execute those methods and a digital signal which composed of the computer program. Further, the present invention may be a recording medium which can read the computer program or the digital signal by a computer. For example, it may be recorded in a flexible disc, a hard disk, a CD-ROM, an MO, a DVD, a DVD-ROM, a DVD-RAM, a Blu-ray Disc (BD), a semiconductor memory and the like. Also, it may be the computer program or the digital signal stored in these recording mediums. Furthermore, the present invention may transmit the computer program or the digital signal via a network represented by a telecommunication line, wireless or wire communication line and the Internet. The present invention is a computer system having a microprocessor and a memory. The memory stores the computer program and the microprocessor may operate according to the computer program. Also, it may be implemented by another independent computer system by recording and transferring the program or the digital signal recorded in the recording medium.

(10) The embodiments and the variations may be combined to each other.

### Sixth Embodiment

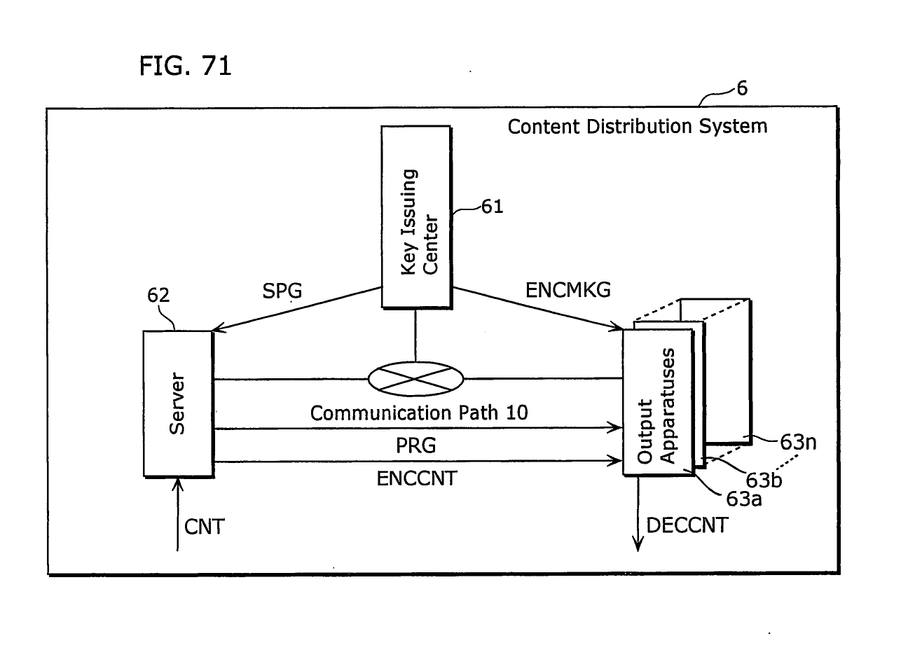

It is explained about the content distribution system 6 as one of the embodiments according to the present invention. First, a summary of the present embodiment is explained using FIG. 71.

In FIG. 71, the communication path 10 that is same as in the first embodiment is a communication path connecting the key issuing center 61, server 61 and output apparatuses 63a to 63n that are different from those in the first embodiment and is realized by a network such as the Internet and a broadcasting network. The key issuing center 61 distributes system secret parameter group SPG which is information necessary for sharing a content key CK used for encrypting content to the server 62 and the encrypted intermediate key group set ENCMKGS to the plurality of output apparatuses 63a to 63n. The server 62 encrypts the content CNT based on the system secret parameter group SPG and distributes it to the plurality of output apparatuses 63a to 63n. The plurality of output apparatuses 63a to 63n decrypts the received encrypted content ENCCNT based on the encrypted intermediate key group set ENCMKGS and outputs the decrypted content DECCNT to the outside. Here, it is presumed that an individual key shared by each pair is given to all sets of the key issuing center 61 and each of the output apparatuses 63a to 63n. For example, it is presumed that, in advance, the key issuing center 61 and the output apparatus 63a shares an individual key IKa, the key issuing center 61 and the output apparatus 63b shares an individual key IKb, . . . , and the key issuing center 61 and the output apparatus 63n shares an individual key IKn.

Here, it is explained further in detail about an operation of each constituent. First, it is explained about a method of distributing one of intermediate key groups MKGa to MKGn respectively to each of the output apparatuses 63a to 63n. The key issuing center 61 first generates a system secret parameter group SPG according to pre-given condition and transmits the system secret parameter group SPG to the server 62. Also, according to the pre-given condition, using the system secret parameter group SPG, it generates the intermediate key group MKGa to MKGn as many as the output apparatuses 13. Then, it associates each of the intermediate key groups MKGa to MKGn respectively with each of the output apparatuses 63a to 63n and decrypts each of the associated intermediate key groups MKGa to MKGn based on each of the individual keys IKa, IKb, . . . Ikn held by each of the intermediate key groups MKGa to MKGn. After that, it transmits, to plurality of output apparatuses 63a to 63n, the value of connecting encrypted sentences Enc(IKa, MKGa), Enc(IKb, MKGb), . . . , to Enc(IKn, MKGn) as an encrypted intermediate key group set ENCMKGS=Enc(IKa, MKa)∥Enc(IKb, MKb)∥ . . . Enc(IKn, MKGn). The output apparatus 63a which received the encrypted intermediate key group set ENCMKGS, using a pre-given individual key IKa, decrypts the encrypted sentence Enc(IKa, MKGa) corresponding to own individual key in the encrypted intermediate key group set ENCMKGS and obtains the intermediate key group MKGa associated with the output apparatus 63a. Note that, similarly the output apparatuses 63b to 63n other than the output apparatus 63a, using individual key held by each output apparatus, decrypts the encrypted sentence corresponding to own individual key in the encrypted intermediate key group and obtains the intermediate key group associated with each output apparatus. Accordingly, each of the output apparatuses 63a to 63n can hold respectively one of the intermediate key groups MKGa to MKGn.

Next, it is explained about an operation by the server 62 to update the content key CK. First, the server 62 generates a time varying parameter group PRG according to the pre-given condition and distributes the time varying parameter group PRG to the plurality of output apparatuses 63a to 63n. Also, based on the time varying parameter group PRG and the system secret parameter groupu SPG, the server 62 generates a content key CK used for encrypting the content CNT. The plurality of output apparatuses 63a to 63n receives the time varying parameter group PRG and, based on the time varying parameter group PRG and each of the intermediate key groups MKGa to MKGn respectively held by each of the output apparatuses, generates a content key CK used for decrypting the encrypted content ENCCNT. Accordingly, the server 62 updates the content key CK held by the server 62 and the output apparatuses 63a to 63n.

Lastly, it is explained about an operation when the server 62 distributes content to the plurality of output apparatuses 63a to 63n. First, the server 62 encrypts the content CNT based on the content key CK, and distributes the encrypted content ENCCNT=Enc(CK, CNT) to the plurality of output apparatuses 63a to 63n. The plurality of output apparatuses 63a to 63n receives the encrypted content ENCCNT, decrypts the encrypted content ENCCNT and outputs the decrypted content DECCNT to the outside. Accordingly the server 62 distributes the content to the plurality of output apparatuses 63a to 63n.

Note that, in the content distribution system 6 in the present embodiment, the output apparatus which has a key issuing center 61 and holds a particular individual key is revoked so that the content CNT cannot be decrypted. In the key issuing center 61, this can be realized, when the key issuing center 61 updates the system secret parameter group SPG and the intermediate key group, by not generating the intermediate key group to the output apparatus to be revoked and further by not using an individual key held by the targeted output apparatus.

This is the summary of the present invention. In the following, it is explained in detail about the content distribution system 6 which is one embodiment of the content distribution system of the present invention. The constituents of the content distribution system 6 are explained in detail.

<Structure of Content Distribution System 6>

As shown in FIG. 71, the content distribution system 6 is made up of the communication path 10, the key issuing center 61, the server 62 and the plurality of output apparatuses 63a to 63n.

The key issuing center 61 distributes the system secret parameter group SPG which is information necessary for sharing the content key to the server 62 and the encrypted intermediate key group set ENCMKGS to the plurality of output apparatuses 63a to 63n. The server 62 generates a time varying parameter group PRG and distributes the time varying parameter group PRG to the plurality of output apparatuses 63a to 63n. Also, the server 62 generates a content key CK based on the system secret parameter group SPG and the time varying parameter group PRG. The output apparatuses 63a to 63n obtains the content key CK based on the intermediate key groups MKGa to MKGn obtained from the encrypted intermediate key group set ENCMKGS and received time varying parameter group PRG. The server 62 then encrypts the content CNT based on the content key CK and distributes the encrypted content ENCCNT to the plurality of output apparatuses 63a to 63n. The plurality of output apparatuses 63a to 63n decrypts the received encrypted content ENCCNT based on the content key CK and outputs the decrypted content DECCNT to the outside.

Hereafter, it is explained in detail about these constituents.

First, a structure of the communication path 10 is explained followed by the explanations of the structure and operations of the key issuing center 61, the server 62 and the output apparatuses 63a to 63n using diagrams.

<Structure of Communication Path 10>

The communication path 10 is, for example, a network such as a telephone line and a private line.

<Structure of Key Issuing Center 61>

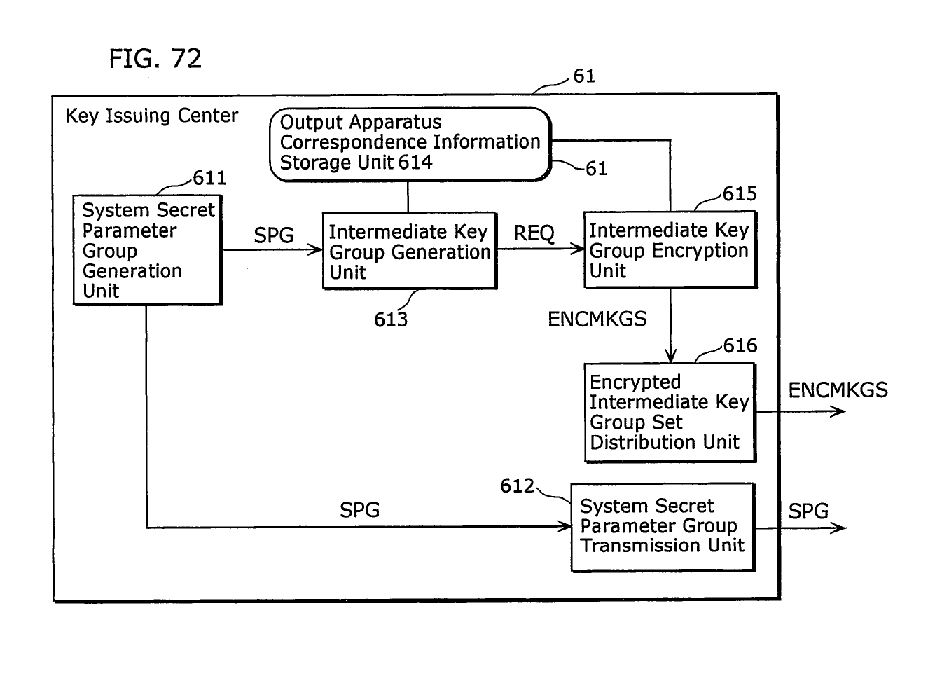

As shown in FIG. 72, the key issuing center 61 is made up of a system secret parameter group generation unit 611, a system secret parameter group transmission unit 612, an intermediate key group generation unit 613, an output apparatus correspondence information storage unit 614, an intermediate key group encryption unit 615 and an encrypted intermediate key group set distribution unit 616.

(1) System Secret Parameter Group Generation Unit 611

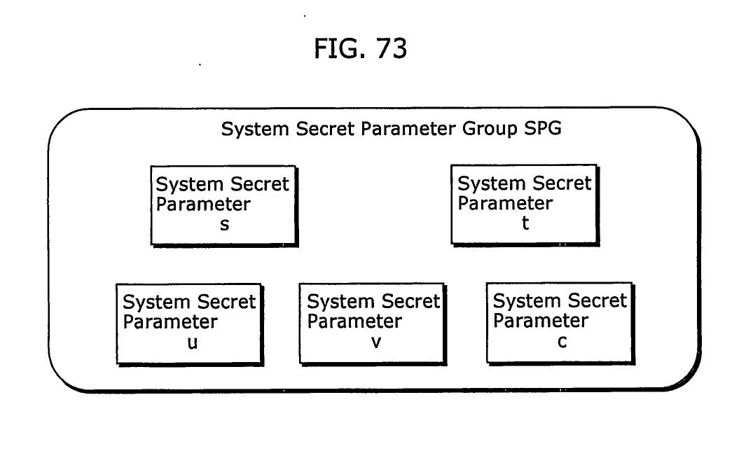

The system secret parameter group generation unit 611 generates a system secret parameter c when it satisfies the pre-given system secret parameter update condition and the key issuing center starts operating. Here, as a method of generating a system secret parameter c, for example, there is a method of randomly generating the system secret parameter c using random numbers. After that, it generates system secret parameters s, t, u, and v so as to satisfy the pre-given system secret parameter generation equation “s*t=u*v mod N”. Note that, as a method of generating system secret parameters s, t, u, and v, for example, there is a method of randomly generating the secret parameters using random numbers. Here, the system secret parameters s, t, u, v, x and modulus N are, for example, natural numbers of 128 bits. The value of the modulus N in here is the value previously given as a common value to the intermediate key group generation unit 613 which is described later, the time varying parameter group generation unit 623 and content encryption key generation unit 625 of the server 62, and content decryption key generation unit 63a of the output apparatuses 63a to 63n. For example, it is 2ˆ{128} and the like. Here, “ˆ” indicates a power operation. For example, 2ˆ{4} indicates 16. Hereafter, it is used in the same meaning. After that, the system secret parameter group generation unit 611 generates a system secret parameter group SPG formed of the system secret parameters s, t, u, v and c as shown in FIG. 73 and outputs the system secret parameter group SPG to the system secret parameter group transmission unit 612 and the intermediate key group generation unit 613. For example, the secret parameter update condition is “every day” “every year” and the like. They can be implemented by setting a counter in the content secret parameter group generation unit 611.

(2) System Secret Parameter Group Transmission Unit 612

The system secret parameter group transmission unit 612 transmits the system secret parameter group SPG received from the system secret parameter group generation unit 611 to the server 62 via the communication path 10.

(3) Intermediate Key Group Generation Unit 613

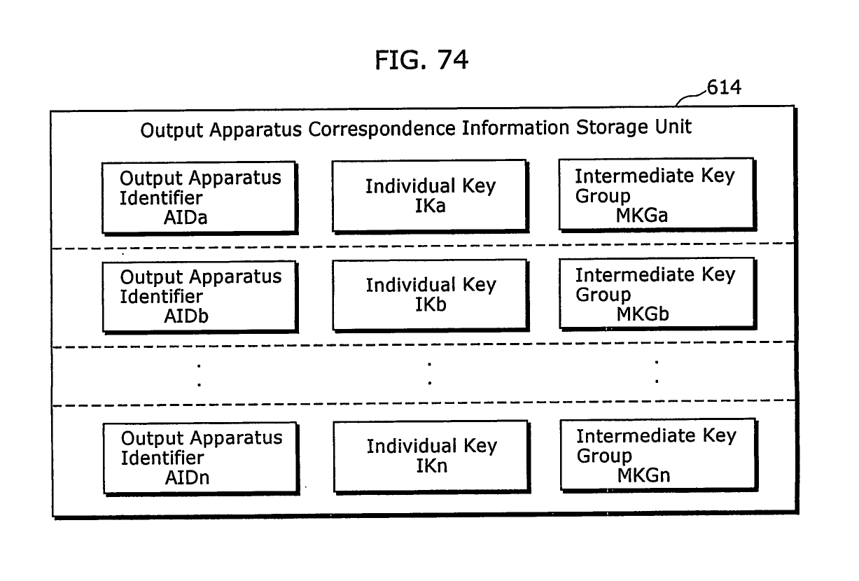

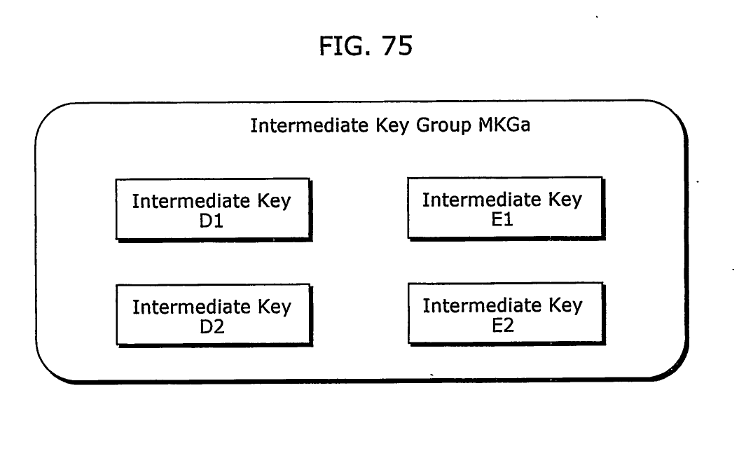

The intermediate key group generation unit 613 deletes all intermediate key groups MKGa to MKGn stored in the output apparatus correspondence information storage unit 614 as shown in FIG. 74 when it receives the system secret parameter group SPG from the system secret parameter group generation unit 611. After that, it extracts system secret parameters s, t, u, v, and c from the received system secret parameter group SPG. Then, it generates individualized parameters x and y so as to satisfy the pre-given individualized parameter equation “x*y=c mod N”. Here, as a method of generating individualized parameters x and y, for example, there is a method of randomly generating the parameters using random numbers. Also, the individualized parameters x and y are, for example, natural numbers of 128 bits, and “*” indicates a multiplication. For example, 2*5 indicates 10. Hereafter, it indicates the same. As a method of individualized parameters x and y, for example, there is a method of generating the individualized parameter x as random natural numbers and substituting the individualized parameter x into the individualized parameter equation “x*y=c mod N2 so that the individualized parameter y is obtained. When selecting one random individualized parameter x, there is certainly the individualized parameter y. Next, using the individualized parameters x and y, the intermediate key group generation unit 613, using the individualized parameters x and y, generates four intermediate keys D1, E1, D2 and E2 based on the pre-given four intermediate key generation equations “D1=s*x mod N”, “E1=t*y mod N”, “D2=−u*x mod N”, “E2=−v*y mod N”. Then, it generates an intermediate key group MKGa as shown in FIG. 75 formed of the intermediate keys D1, E1, D2 and E2. After that, it associates the intermediate key group MKGa with the output apparatus identifier AIDa and stores it to the output apparatus correspondence information storage unit 114. Next, it similarly generates intermediate keys MKb to MKGn respectively to the output apparatus identifiers AIDb to AIDn other than the output apparatus identifier AIDa in the output apparatus correspondence information storage unit 114. Here, the structures of the intermediate keys MKb to MKGn are same as the structure of the intermediate key group MKGa shown in FIG. 75. However, each value of the intermediate key groups MKGa to MKGn should be independent. In order to do so, the individualized parameters x and y used for generating each of the intermediate key groups MKGa to MKGn can be respectively different values. When the intermediate key groups MKGa to MKGn are all assigned respectively to the output apparatus identifiers AIDa to AIDn, it outputs the key update request information REG to the intermediate key group encryption unit 615.

(4) Output Apparatus Correspondence information Storage Unit 614

As shown in FIG. 74, the output apparatus correspondence information storage unit 614 holds the output apparatus identifiers AIDa to AIDn for identifying the plurality of output apparatuses 63a to 63n, individual keys IKa to IKn and intermediate key group MKGa to MKGn previously given respectively to the output apparatuses 63a to 63n. For example, in FIG. 74, the output apparatus 63a associated with the output apparatus identifier AIDa holds an individual key IKa and an intermediate key group MKGa; the output apparatus 63b associated with the output apparatus identifier AID2 holds an individual key IKb and an intermediate key MKb; and the output apparatus 63n associated with the output apparatus identifier AIDn holds an individual key IKn and an intermediate key MKGn. The intermediate key group generation unit 613 and an intermediate key group encryption unit 615 can access to the output apparatus correspondence information storage unit 114.

(5) Intermediate Key Group Encryption Unit 615

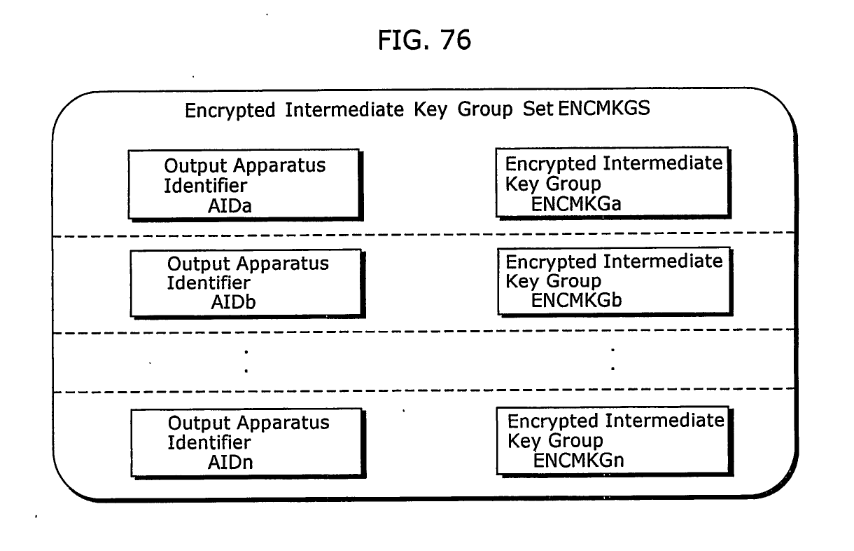

The intermediate key group encryption unit 615, in the case of receiving a key update request information REQ from the intermediate key group generation unit 613, accesses to the output apparatus correspondence information storage unit 614 and obtains all of the output apparatus identifiers AIDa to AIDn, the individual keys IKa to IKn, and intermediate key groups MKGa to MKGn. Then, it first for the output apparatus identifier AIDa encrypts the intermediate key group MKGa based on the corresponding individual IKa, and associates the encrypted sentence with the output apparatus identifier AIDa as the encrypted intermediate key group ENCMKGa=Enc(Ika, MKGa). Then, similar to other output apparatus identifiers AIDb to AIDn, it encrypts each intermediate key group based on the corresponding individual key and associates each of the encrypted sentence Enc (IKb, MKGb), . . . , Enc (IKn, MKGn) respectively with one of the output apparatus identifiers AIDb to AIDn as the encrypted intermediate key group ENCMKGb, . . . , and ENCMKGn. After that, it generates, as shown in FIG. 76, an encrypted intermediate key group set ENCMKGS={AIDa, ENCMKGa}∥{AIDb, ENCMKGb} . . . ∥{AIDn, ENCMKGn}} formed of the apparatus identifiers AIDa to AIDn and the encrypted intermediate key groups ENCMKGa to ENCMKGn and outputs the encrypted intermediate key group set ENCMKGS to the encrypted intermediate key group set distribution unit 616. Here, an encryption algorithm used for encrypting the intermediate key is, for example, a DES encryption method of a block encryption and the like and uses the same method as the decrypted algorithm used by the encrypted intermediate key group decryption unit 632a of the output apparatuses 63a to 63n.

(6) Encrypted Intermediate Key Group Set Distribution Unit 616

The encrypted intermediate key group set distribution unit 616, in the case of receiving the encrypted intermediate key group set ENCMKGS from the intermediate key group encryption unit 615, distributes the received encrypted intermediate key group set ENCMKGS to the plurality of output apparatuses 63a to 63n via the communication path 10.

<Operation of Key Issuing Center 61>

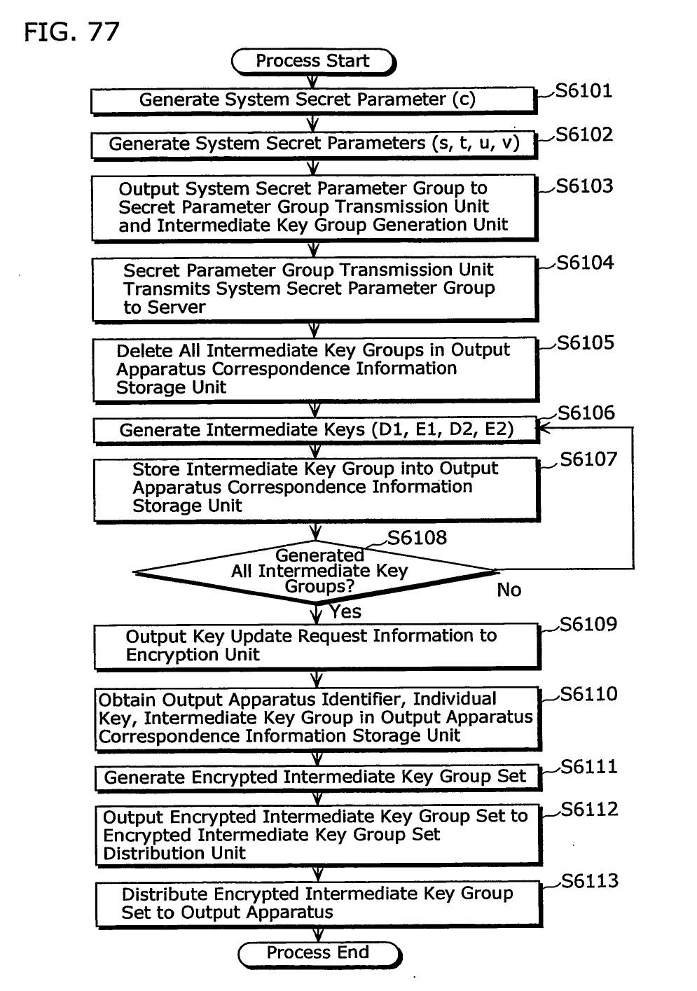

In the above, the structure of the key issuing center 61 is explained. Here, it is explained about the operation of the key issuing center 61. Here, it is explained about an operation of distributing key information necessary for sharing a content key to the server 62 and the plurality of output apparatuses 63a to 63n using a flowchart shown in FIG. 77.

<<Operation at Key Information Distribution>>

The system secret parameter group generation unit 611 generates a system secret parameter c (S6101).

The system secret parameter group generation unit 611 generates system secret parameters s, t, u, and v so as to satisfy the pre-given system secret parameter generation equation “s*t=u*v mod N” (S6102).

The system secret parameter group generation unit 611 generates a system secret parameter group SPG formed of the generated system secret parameters s, t, u, v and c and outputs the system secret parameter group SPG to the system secret parameter group transmission unit 612 and the intermediate key group generation unit 613 (S6103).

The system secret parameter group transmission unit 612 transmits the received system secret parameter group SPG to the server 62 (S6104).

The intermediate key group generation unit 613 deletes all of the intermediate key groups MKGa to MKGn stored in the output apparatus correspondence information storage unit 614 (S6105).

The intermediate key group generation unit 613 generates individualized parameters x and y satisfying the pre-given individualized parameter generation equation “x*y=c mod N”. Herein, the values of the pre-generated individualized parameters x and y and the values of the generated individualized parameters x and y should not be the same. Then, it, using the individualized parameters x and y, generates four intermediate keys D1, E1, D2 and E2 for satisfying the pre-given four intermediate key generation equations “D1=s*x mod N”, “E1=t*y mod N”, “D2=−u*x mod N”, and “E2=−v*y mod N” (S6106).

The intermediate key group generation unit 613 generates an intermediate key group formed of the intermediate keys D1, E1, D2 and E2 and stores by associating the intermediate key group with one of the output apparatus identifiers AIDa to AIDn to which an intermediate key group has not been assigned in the output apparatus correspondence information storage unit 614 (S6107).

When the intermediate key groups MKGa to MKGn are all assigned respectively to the output apparatus identifiers AIDa to AIDn stored in the output apparatus correspondence information storage unit 614, the process moves on to step S1109. When there are unassigned output apparatuses, the process returns to step S1106 (S6108).

The intermediate key group generation unit 613 outputs the key update request information REQ to the intermediate key group encryption unit 615 (S6109).

The intermediate key group encryption unit 615 which received the key update request information REQ accesses to the output apparatus correspondence information storage unit 614 and obtains all of the output apparatus identifiers AIDa to AIDn, the individual keys IKa to IKn and the intermediate key groups MKGa to MKGn (S6110).

The intermediate key group encryption unit 615 encrypts each of the intermediate key groups MKGa to MKGn based each of the individual keys IKa to IKn and generates an encrypted intermediate key group set ENCMKGS formed of the encrypted intermediate keys ENCMKGa to ENCMKGn and the output apparatus identifiers AIDa to AIDn corresponding to the individual keys IKa to IKn used for the encryption (S6111).

The intermediate key group encryption unit 615 outputs the generated encrypted intermediate key group set ENCMKGS to the encrypted intermediate key group set distribution unit 616 (S6112).

The encrypted intermediate key group set distribution unit 616 receives the encrypted intermediate key group set ENCMKGS, distributes the received encrypted intermediate key group set ENCMKGS to the plurality of output apparatuses 63 a to 63n and terminates the process (S6113).

They are the structure and operations of the key issuing center 61 which is a constituent of the content distribution system 6. Next, it is explained about a structure and operations of the server 62.

<Structure of Server 62>

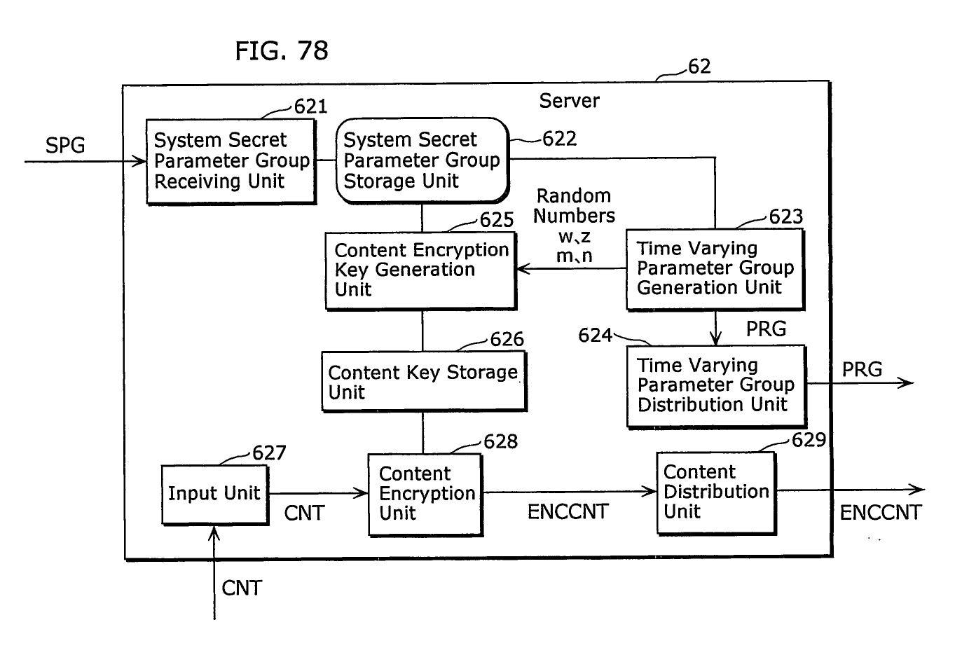

As shown in FIG. 78, the server 62 is made up of a system secret parameter group receiving unit 621, a system secret parameter group storage unit 622, a time varying parameter group generation unit 623, a time varying parameter group distribution unit 624, a content encryption key generation unit 625, a content key storage unit 626, an input unit 627, a content encryption unit 628 and a content distribution unit 629.

(1) System Secret Parameter Group Receiving Unit 621

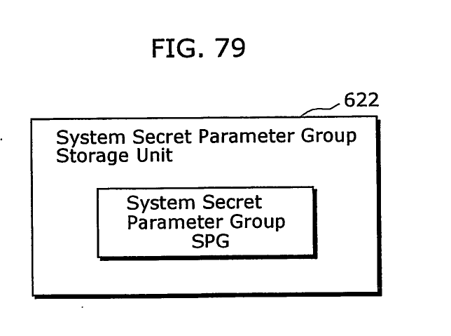

The system secret parameter group receiving unit 621, in the case of receiving the system secret parameter group SPG from the key issuing center 61, stores the received system secret parameter group SPG into the system secret parameter group storage unit 622 as shown in FIG. 79.

(2) System Secret Parameter Group Storage Unit 622

The system secret parameter group storage unit 622 stores the system secret parameter group SPG as shown in FIG. 79. the system secret parameter group receiving unit 621, the time varying parameter group generation unit 623, and a content encryption key generation unit 625 can access to the system secret parameter group storage unit 622.

(3) Time Varying Parameter Group Generation Unit 623

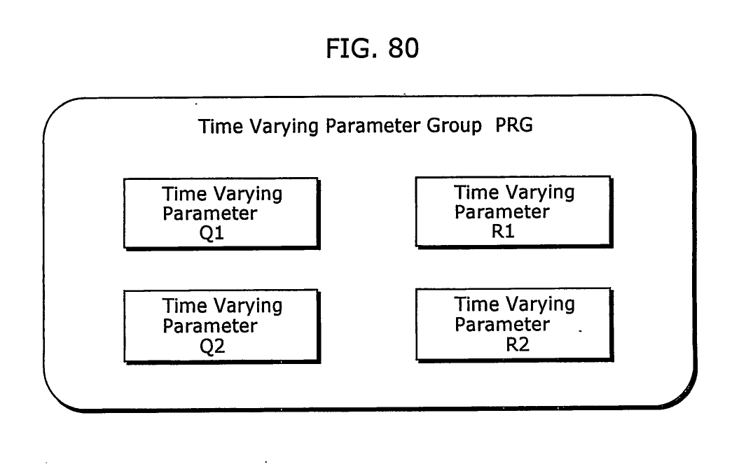

Time varying parameter group update condition is previously given to the time varying parameter group generation unit 623, when it satisfies the condition; it generates four random numbers z, w, m and n. Here, the random numbers z, w, m and n are, for example, respectively natural numbers of 128 bits. Also, the time varying parameter group generation unit 623 accesses to the system secret parameter group storage unit 622, obtains the system secret parameter group SPG and extracts the secret parameters s, t, u and v from the obtained system secret parameter group SPG. Then, it generates four time varying parameters Q1, R1, Q2 and R2 based on the pre-given four time varying parameter equations: “Q1=s*z+v*m mod N”; “R1=t*w+u*n N”; “Q2=u*z+t*m mod N” and “R2=v*w+s*n N”. After that, it generates a time varying parameter group PRG as shown in FIG. 80 formed of the generated time varying parameters Q1, R1, Q2 and R2 and outputs the generated time varying parameter group PRG to the time varying parameter group distribution unit 624. Lastly, it outputs random numbers z, w, m and n to the content encryption key generation unit 625. For example, the time varying parameter group update condition is “every one hour”, “every day” and the like. They can be realized by setting a counter in the time varying parameter group generation unit 623. Note that, the time varying parameter group generation unit 623 may receive the time varying parameter group update request signal from the outside and may newly generate a time varying parameter group PRG in the case of receiving the time varying parameter update request signal.

(4) Time Varying Parameter Group Distribution Unit 624

The time varying parameter group distribution unit 624 obtains a time varying parameter group PRG from the time varying parameter group generation unit 623 and distributes the time varying parameter group PRG to the plurality of output apparatuses 63a to 63n via the communication path 10.

(5) Content Encryption Key Generation Unit 625

The content encryption key generation unit 625, in the case of receiving random numbers z, w, m and n from the time varying parameter group generation unit 623, first accesses to the system secret parameter group storage unit 622, obtains a system secret parameter group SPG and extracts the secret parameters s, t, u, v and c from the system secret parameter group SPG. After that, it generates a content key CK based on the pre-given content encryption key generation equation “CK=2*s*t*(z+w+c+n*m)+2*(u*s*n*z+t*v*m*w) mod N” and stores the generated content key CK into the content key storage unit 626.

(6) Content Key Storage Unit 626

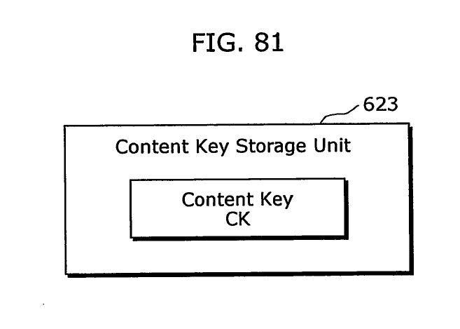

As shown in FIG. 81, the content key storage unit 626 holds a content key CK. The content key CK is used as an encryption key and decryption key of content CNT.

(7) Input Unit 627

The input unit 627 can input content CNT from outside. The content CNT inputted from outside is in a format that the output apparatuses 63a to 63n can output. For example, it is video data in a MPEG format, audio data in a MP3 format and the like. The input unit 627 outputs, when it receives the content CNT from outside, the received content CNT to the content encryption unit 628.

(8) Content Encryption Unit 628

The content encryption unit 628 accesses to the content key storage unit 626 and obtains the content key CK when it receives the content CNT from the input unit 627. Then, based on the obtained content key CK, it sequentially encrypts the received content CNT. Here, an encryption algorithm used for encrypting the content CNT is, for example, a DES encryption method of a block encryption and the like. The same method as the decryption algorithm used for decrypting the encrypted content ENCCNT in the content decryption unit 638 in each of the output apparatuses 63a to 63n that is described later is used. After that, the content encryption unit 628 outputs the encrypted content ENCCNT to the content distribution unit 629.

(9) Content Distribution Unit 629

The content distribution unit 629 sequentially distributes the encrypted content ENCCNT received from the content encryption unit 628 to the plurality of output apparatuses 63a to 63n via the communication path 10.

<Operation of Server 62>

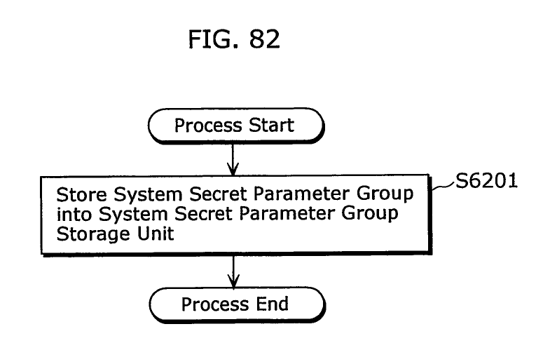

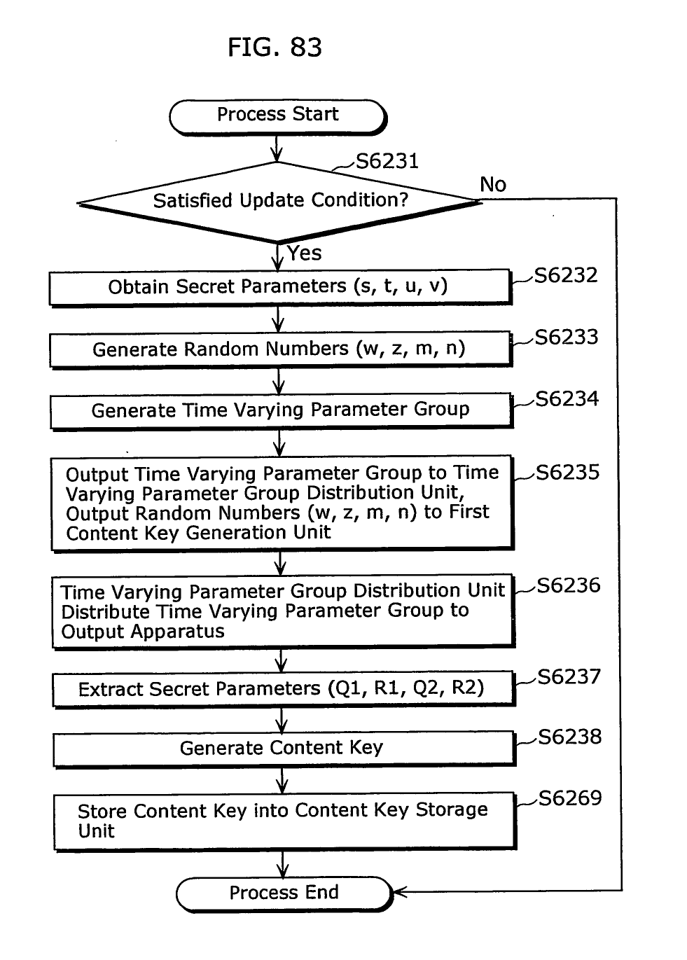

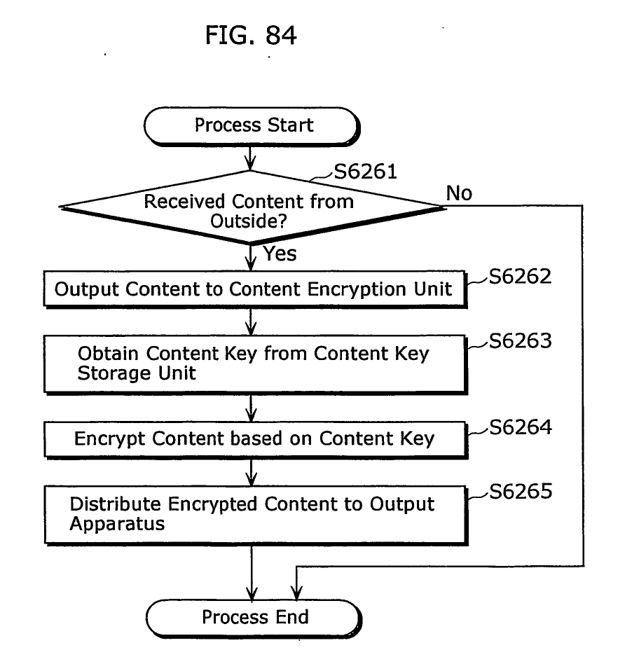

In the above, the structure of the server 62 is explained. Here, it is explained about operations of the server 62. First, an operation at receiving a system secret parameter group SPG used for sharing a content key CK from key issuing center 61 is explained using a flowchart shown in FIG. 82. Next, an operation of the server 62 to update the time varying parameter group PRG is explained using a flowchart shown in FIG. 83. Lastly, an operation of the server 62 to distribute the content CNT to the output apparatuses 63a to 63n is explained using a flowchart shown in FIG. 84.

<<Operation at Receiving System Secret Parameter Group SPG from Key Issuing Center 61>>

The system secret parameter group receiving unit 621 stores the received system secret parameter group SPG into the system secret parameter group storage unit 622 and terminates the process (S6201).

<<Operation by Server 62 to Update Time Varying Parameter Group PRG>>

When the time varying parameter group generation unit 623 satisfies the pre-given time varying parameter group update condition, it moves on to step S6232. When it does not satisfy the condition, it terminates the process (S6231).

The time varying parameter group generation unit 623 accesses to the system secret parameter group storage unit 622, obtains a system secret parameter group SPG and extracts secret parameters s, t, u and v from the system secret parameter group SPG (S6232).

The time varying parameter group generation unit 623 generates random numbers z, w, m and n (S6233).

The time varying parameter group generation unit 623 generates four time varying parameters Q1, R1, Q2 and R2 based on the pre-given time variant generation equations “A1=s*z+v*m mod N”, “R1=t*w+u*n mod N”, “Q2=u*z+t*m mod N”, and “R2=v*w+s*n mod N” and generates a time varying parameter group PRG formed of the generated time varying parameters Q1, R1, Q2 and R2 (S6234).

The time varying parameter group generation unit 623 outputs the time varying parameter group PRG to the time varying parameter group distribution unit 624 and outputs the random numbers z, w, m and n to the content encryption key generation unit 625 (S6235).

The time varying parameter group generation unit 624 distributes the time varying parameter group PRG to the output apparatuses 63a to 63n (S6236).

The content encryption key generation unit 625 which received the random numbers z, w, m and n first accesses to the system secret parameter group storage unit 622, obtains a system secret parameter group SPG and extracts secret parameters s, t, u, b and c from the system secret parameter group SPG (S6237).

The content encryption key generation unit 625 generates a content key CK based on the pre-given content encryption key generation equation “CK=2*s*t*(z*w+c*n*m)+2*(u*s*n*z+t*v*m*w) mod N” (S6238).

The content encryption key generation unit 625 stores the generated content key CK into the content key storage unit 626 and terminates the process (S6239).

<<Operation of Server 62 to Distribute Content to Output Apparatuses 63a to 63n>>

When the input unit 627 receives the content CNT from outside, it moves on to step S1262. When it does not receive the content CNT, it terminates the process (S6261).

The input unit 627 outputs the received content CNT to the content encryption unit 628 (S6262).

Next, the content encryption unit 628 which received the content CNT accesses to the content key storage unit 626 and obtains the content key CK (S6263).

The content encryption unit 628 encrypts the content CNT based on the content key CK and outputs the encrypted content ENCCNT to the content distribution unit 629 (S6264).

The content distribution unit 629 which received the encrypted content ENCCNT distributes the encrypted content ENCCNT to the output apparatuses 63a to 63n and terminates the process (S6265).

They are the structure and operations of the server 62 which is a constituent of the content distribution system 6. Following that, it is explained about the structure and operations of the output apparatuses 63a to 63n. First, a structure and operations of the output apparatus 63a is explained. Next, differences between the output apparatus 63a and other output apparatuses 63b to 63n are described.

<Structure of Output Apparatus 63a>

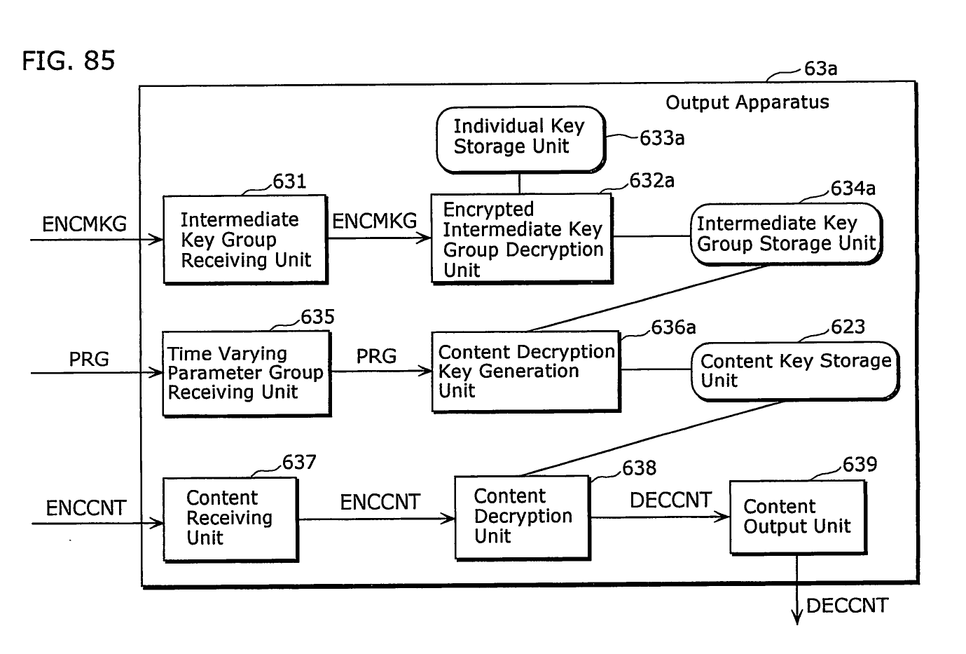

As shown in FIG. 85, the output apparatus 63a is made up of an intermediate key group receiving unit 631, an encrypted intermediate key group decryption unit 632a, an individual key storage unit 633a, an intermediate key group storage unit 634a, a time varying parameter group receiving unit 635, a content decryption key generation unit 636a, a content key storage unit 623, a content receiving unit 637, a content decryption unit 638 and an output unit 639. Here, the content key storage unit 623 performs same operations as the content key storage unit 623 which is a constituent of the server 62. Therefore, the explanation about the content key storage unit 623 is omitted. Also, the intermediate key group receiving unit 631, the time varying parameter group receiving unit 635, the content key storage unit 623, the content receiving unit 637, the content decryption unit 638, and the output unit 639 are constituents common to the output apparatuses 63a to 63n. On the other hand, the encrypted intermediate key group decryption unit 632a, an individual key storage unit 633a, an intermediate key group storage unit 634a and a content decryption key generation unit 636a are constituents specific to the output apparatus 63a.

(1) Intermediate Key Group Receiving Unit 631

The intermediate key group receiving unit 631 outputs, when it receives an encrypted intermediate key group set ENCMKGS={AIDa, ENCMKGa}∥ . . . ∥{AIDn, ENCMKGn} from the server 62, the received encrypted intermediate key group set ENCMKGS to the encrypted intermediate key group decryption unit 632a.

(2) Encrypted Intermediate Key Group Decryption Unit 632a

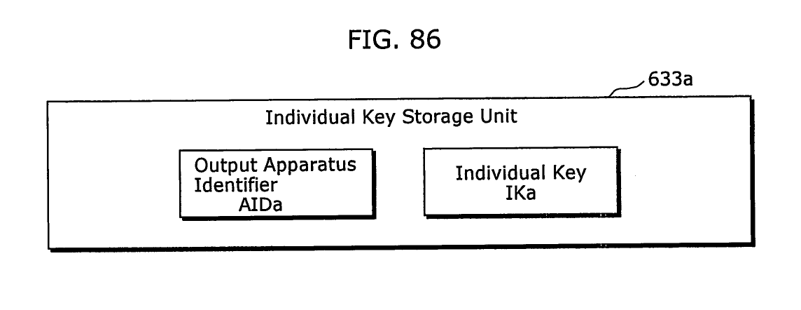

The encrypted intermediate key group decryption unit 632a first obtains an output apparatus identifier AIDa and an individual key IKa from the individual key storage unit 633a as shown in FIG. 86 when it receives the encrypted intermediate key group set ENCMKGS={AIDa, ENCMKGa}∥ . . . ∥{AIDn, ENCMKGn}. Then, it obtains the encrypted intermediate key group ENCMKGa corresponding to the output apparatus identifier AIDa from the received encrypted intermediate key group set ENCMKGS. After that, based on the individual key IKa stored in the individual key storage unit 633a, it decrypts the corresponding encrypted intermediate key group ENCMKGa=Enc(IKa, MKGa). It stores the decrypted intermediate key group MKGa into the intermediate key group storage unit 634a.

(3) Individual Key Storage Unit 633a

As shown in FIG. 86, the individual key storage unit 633a holds an output apparatus identifier AIDa and an individual key IKa. The encrypted intermediate key group decryption unit 632a can access to the individual key storage unit 633a.

(4) Intermediate Key Group Storage Unit 634a

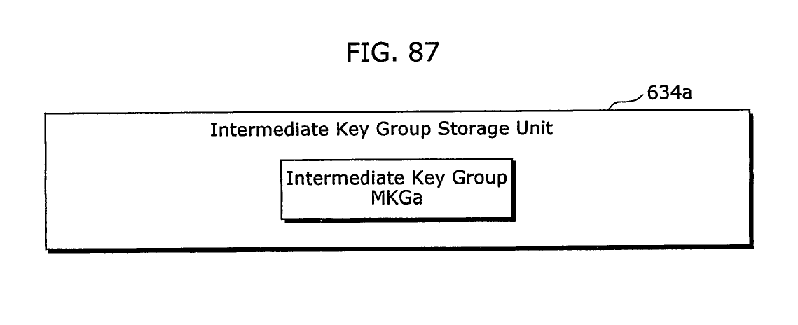

As shown in FIG. 87, the intermediate key group storage unit 634a holds an intermediate key group MKGa. The encrypted intermediate key group decryption unit 632a and the content decryption key generation unit 636a can access to the intermediate key group storage unit 634a.

(5) Time Varying Parameter Group Receiving Unit 635

The time varying parameter group receiving unit 635 outputs, when it receives a time varying parameter group PRG from the server 62, the received time varying parameter group PRG to the content decryption key generation unit 636a.

(6) Content Decryption Key Generation Unit 636a

When the content decryption key generation unit 636a receives a time varying parameter group PRG from the time varying parameter group receiving unit 635, it accesses to the intermediate key group storage unit 634a and obtains an intermediate key group MKGa. Then, it extracts, from the time varying parameter group PRG, time varying parameters Q1, R1, !2, and R2 and then extracts the intermediate key D1, E1, D2 and E2 from the intermediate key group MKGa. After that, it generates a content key CK based on the pre-given content decryption key generation equation “CK=(Q1+D1)*(R1+E1)+(Q2+D2)*(R2+E2) mod N” and stores the generated content key CK into the content key storage unit 623.

(7) Content Receiving Unit 637

The content receiving unit 637 outputs, when it receives the encrypted content ENCCNT from the server 62, the encrypted content ENCCNT to the content decryption unit 638.

(8) Content Decryption Unit 638

When the content decryption unit 638 receives the encrypted content ENCCNT from the content receiving unit 637, it obtains a content key CK from the content key storage unit 623 and decrypts the encrypted content ENCCNT based on the content key CK. Here, the decryption algorithm used for the decryption is, for example, a DES method of a block encryption and the like and uses the same method as the encryption algorithm used by the content encryption unit 628 of the server 62. It outputs the decrypted content DECCNT=Dec(CK, ENCCNT) to the content output unit 639. Here, Dec(K, C) is a decryption sentence when the encryption sentence C is decrypted based on the decryption key K.

(9) Content Output Unit 639

The content output unit 639 outputs, when it receives the decrypted content DECCNT from the content decryption unit 638, the received decrypted content DECCNT to the outside.

<Operation of Output Apparatus 63a>

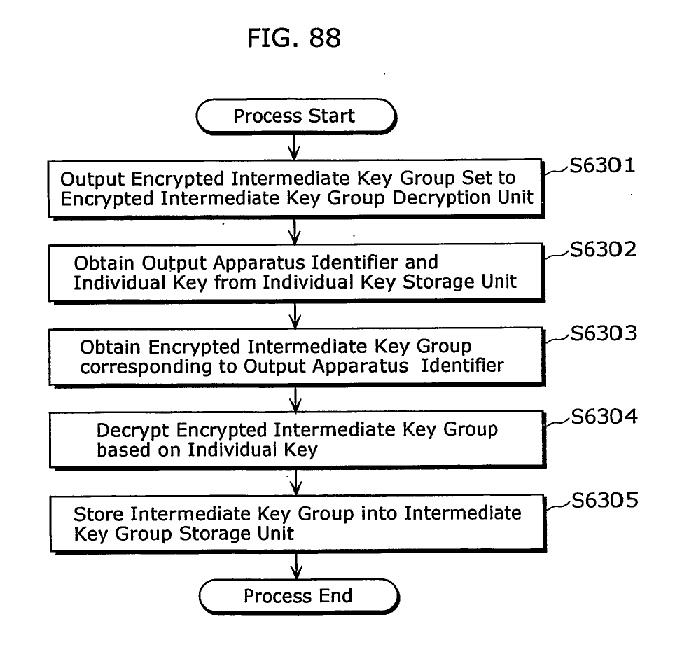

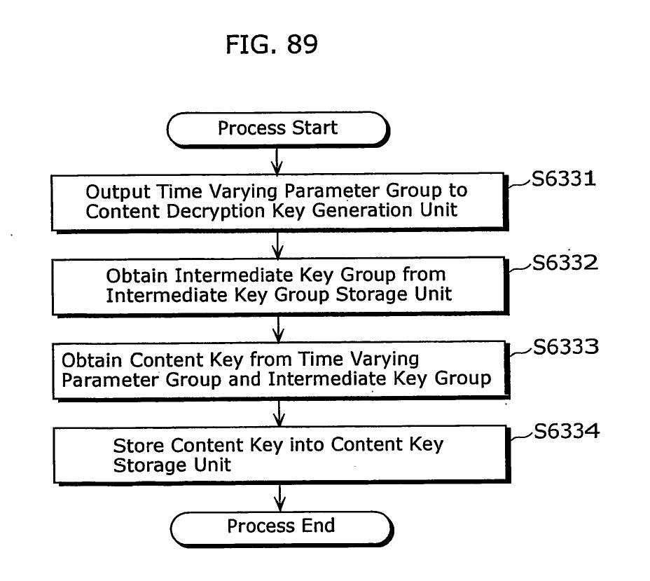

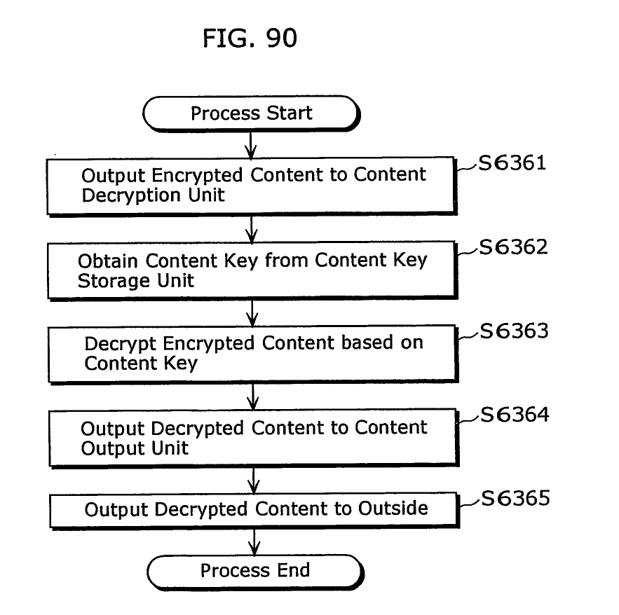

In the above, the structure of the output apparatus 63a is explained. Here, it is explained about an operation of the output apparatus 63a. First, it is explained, using a flowchart shown in FIG. 88, about an operation at obtaining an intermediate key group MKGa when the output apparatus 63a receives the encrypted intermediate key group set ENCMKGS. Next, it is explained, using a flowchart shown in FIG. 89, about an operation at generating a content key CK using the intermediate key group MKGa when the output apparatus 63a receives the time parameter group PRG. Lastly, it is explained, using a flowchart shown in FIG. 90, about an operation at outputting the decrypted content DECCNT to the outside when the output apparatus 63a receives the encrypted content ENCCNT from the server 62.

<<Operation at Receiving an Encrypted Intermediate Key Group Set ENCMKGS from Key Issuing Center 61>>

The intermediate key group receiving unit 631 outputs the received encrypted intermediate key group set ENCMKGS to the encrypted intermediate key group decryption unit 632a (S6301).

The encrypted intermediate key group decryption unit 632a obtains an output apparatus identifier AIDa and an individual key IKa from the individual key storage unit 633a (S6302).

The encrypted intermediate key group decryption unit 632a obtains an encrypted intermediate key group ENCMKGa=Enc(IKa, MKGa) associated with the output apparatus identifier AIDa from the received encrypted intermediate key group set ENCMKGS (S6303).

The encrypted intermediate key group decryption unit 632a decrypts the encrypted intermediate key group ENCMKGa based on the individual key IKa and obtains an intermediate key group MKGa (S6304).

The encrypted intermediate key group decryption unit 632a stores the obtained intermediate key group MKGa into the intermediate key group storage unit 634a and terminates the process (S6305).

<<Operation at Receiving Time Varying Parameter Group PRG from Server 62>>

The time varying parameter group receiving unit 635 outputs the received time varying parameter group PRG to the content decryption key generation unit 636a (S6331).

The content decryption key generation unit 636a accesses to the intermediate key group storage unit 634a and obtains the intermediate key group MKGa (S6332).

The content decryption key generation unit 636a extracts intermediate keys D1, E1, D2 and E2 from the intermediate key group MKGa and extracts time varying parameters Q1, R1, Q2 and R2 from the time varying parameter group PRG. After that, it generates a content key CK based on the pre-given content decryption key generation equation “CK=(Q1+D1)*(R1+E1)+(Q2+D2)*(R2+E2) mod N” (S6333).

The content decryption key generation unit 636a stores the content key CK into the content key storage unit 623 and terminates the process (S6334).

<<Operation at Receiving Encrypted Content ENCCNT from Server 62>>

The content receiving unit 637 outputs the received encrypted content ENCCNT to the content decryption unit 638 (S6361).

The content decryption unit 638 accesses to the content key storage unit 623 and obtains a content key CK (S6362).

The content decryption unit 638 decrypts the encrypted content ENCCNT based on the obtained content key CK and obtains the decrypted content DECCNT (S6363).

The content decryption unit 638 outputs the decrypted content DECCNT to the content output unit 639 (S6364).

The content output unit 639 receives the decrypted content DECCNT from the content decryption unit 638, outputs the received decrypted content DECCNT to the outside and terminates the process (S6365).

They are the structure and operations of the output apparatus 63a which is a constituent of the content distribution system 6. Note that differences between the output apparatus 63a and other output apparatuses 63b to 63n are described in the following.

(i) An output apparatus identifier (AIDa to AIDn) and individual key (IKa to IKn) used for decrypting the encrypted intermediate key group in the encrypted intermediate key group decryption unit 632a are different for each of the output apparatuses 63a to 63n.

(ii) An output apparatus identifier (AIDa to AIDn) and individual key (IKa to IKn) stored in the individual key storage unit 633a are different for each of the output apparatuses 63a to 63n.

(iii) An intermediate key group (MKGa to MKGn) stored in the intermediate key group storage unit 634a is different for each of the output apparatuses 63a to o63n.

(iv) An intermediate key group (MKGa to MKGn) used for generating a content key CK in the content decryption key generation unit 636a is different for each of the output apparatuses 63a to 63n.

<Verification of Operation in Sixth Embodiment>

In sixth embodiment, it is explained about the reason why same content key CK can be obtained in all of the output apparatuses 63a to 63n in spite of the fact that a different value of intermediate key groups MKGa to MKGn is assigned to each of the output apparatuses 63a to 63n. First, the intermediate key groups MKGa to MKGn are respectively made of the intermediate keys D1, E1, D2 and E2. Also, the time varying parameter group PRG is generated so as to satisfy the time varying parameter generation equation. Accordingly, the content decryption key generation equation can be transformed as follows:

$$\begin{matrix}CK = ( Q 1 + D 1 ) * ( R 1 + E 1 ) + ( Q 2 + D 2 ) * ( R 2 + E 2 ) \\ = \{ s * ( z + x ) + v * m \} * \{ t * ( w + y ) + u * n \} + \{ u * ( z - x ) + t * m \} * \\ \{ v * ( w - y ) + s * n \} \\ = \{ s * ( z + x ) * t * ( w + y ) + u * ( z - x ) * v * ( w - y ) \} + \{ u * n * s * \\ ( z + x ) + v * m * t * ( w + y ) + s * n * u * ( z - x ) + t * m * v * \\ ( w - y ) \} + u * v * m * n + s * t * m * n\end{matrix}$$

Here, using a condition of “x*y=c”,
. . . =2*s*t*(z*w+c*n*m)+2*(u*s*n*z+t*v*m*w)
This is formed of only parameters common to all of the output apparatuses 63a to 63n (i.c. it does not include individualized parameters x and y). Therefore, a common content key CK is obtained from all of the output apparatuses 63a to 63n. Also, this matches with the content encryption key generation equation “CK=2*s*t*(z*w+c*n*m)+2*(u*s*n*z+t*v*m*w)”.

<Effect of Sixth Embodiment>

In the sixth embodiment of the present invention, a content key CK used for decrypting content CNT is generated from an intermediate key specific to output apparatus. Thus, it becomes possible to specify an output apparatus which is an origin of leakage based on the intermediate key group included in the output apparatus correspondence information storage unit of the key issuing center and correspondence information of the output apparatus identifier even for an unauthorized output apparatus in which an intermediate key is embedded.

<Variations of Sixth Embodiment>

The embodiment explained in the above is an example of the embodiments of the present invention. Therefore, the present invention is not restricted to this embodiment. It can be implemented in main condition in a range which does not exceed the context of the embodiment. The following cases are also included in the present invention.

(1) The communication path 10 may be a broadcasting network such as terrestrial wave and satellite

(2) The secret parameter generation equation of the system secret parameter group generation unit 611, the individualized parameter generation equation and intermediate key generation of the intermediate key group generation unit 613, the time varying parameter generation equation of the time varying parameter group generation unit 623, the content encryption key generation equation of the content encryption key generation unit 625, and the content decryption key generation equation of the content decryption key generation unit 636a are not restricted to the equations used in the sixth embodiment. Any equations can be applied unless that an equation obtained by substituting the individualized parameter generation equation, the intermediate key generation equation and the time varying parameter generation equation into the content decryption key generation equation matches with the content encryption key generation equation and that the intermediate key generation equation includes individualized parameters x and y and further the time varying parameter generation equation and the content encryption key generation equation do not include individualized parameters x and

(3) The system secret parameter group generation unit 611 in the sixth embodiment generates a system secret parameter group SPG using one secret parameter generation equation. However, it may generate the system secret parameter group SPG using two or more types of secret parameter generation equations or without using secret parameter generation equations. For example, the system secret parameter group SPG may be random numbers.

(4) The intermediate key group generation unit 613 in the sixth embodiment generates individualized parameters using one individualized parameter generation equation. It may generate individualized parameters using two or more types of individualized parameter generation equation or without using individualized parameter generation equations. For example, the individual parameters may be random numbers.

(5) The intermediate key group generation unit 613 in the sixth embodiment generates an intermediate key using four intermediate key generation equations. However, it may generate the intermediate key using five or more types of intermediate key generation equations or using three or less types of intermediate key generation equations.

(6) The time variant group generation unit 623 in the sixth embodiment, it generates a time varying parameter group PRG using four time varying parameter generation equations. However, it may generate the time varying parameter group PRG using five or more types of time varying parameter generation equations or using three or less types of time varying parameter generation equations. Further, it may generate a time varying parameter group PRG without using the time varying parameter generation equations. For example, the time varying parameter group PRG may be random numbers.

(7) The content encryption key generation unit 625 in the sixth embodiment calculates a content key CK using one content encryption key generation equation. However, it may calculate a content key CK using two or more types of content encryption key generation equations.

(8) The content decryption key generation unit 636a in the sixth embodiment calculates a content key using one content decryption key generation equation. However, it may generate a content key using two or more types of content decryption key generation equations.

(9) The content decryption key generation equation used in the content decryption key generation unit 636a does not need to use a generation equation common to all of the output apparatuses 63a to 63n.

(10) Each of the intermediate key groups MKGa to MKGn is formed based on four intermediate keys D1, E1, D2 and E2. However, it may be formed of five or more intermediate keys or of three or less intermediate keys.

(11) The time varying parameter group PRG is formed of four time varying parameters. However, it may be formed of five or more time varying parameters or three or less time varying parameters.

(12) Same individual key or intermediate key may be assigned to some of the plurality of output apparatuses.

(13) The key issuing center 61 may transmit the intermediate key group to the server 62 instead of the system secret parameter group SPG and the server 62 may generate a content key from the time varying parameter group PRT and the intermediate key group.

(14) When the server 62 receives the system secret parameter group SPG from the key issuing center 61, the system secret parameter group receiving unit 621 stores the system secret parameter group SPG into the system secret parameter group storage unit 622. At the same time, the time varying parameter group generation unit 623 may generate newly a time varying parameter group PRG.

(15) The content encryption key generation unit 625 and the content decryption key generation unit 636a in the sixth embodiment outputs the same content key CK. However, the content encryption key generation unit 625 may output the content encryption key CEK and the content decryption key generation unit 636a outputs the content decryption key CDK so that the content encryption key CEK and the content decryption key CDK may be different from each other. In this case, the content encryption unit 628 and the content decryption unit 638, for example, use a public key encryption method such as RSA encryption. As for the RSA encryption method, it is disclosed in non-patent literature, (Shinichi Ikeno, and Kenzo Koyama, “Modern Cryptographic Theory”, The Institute of Electronics, Information and Communication Engineers ed.).

(16) In the sixth embodiment, the server 62 encrypts the content CNT based on the content key CK. However, it may newly generate a second content key CK2, encrypts the second content key CK2 based on the content key CK, further encrypts the content CNT based on the second content key CK2 and distributes the encrypted content ENCCNT and the encrypted second content key CK2 to the output apparatuses 63a to 63n. Note that, it may newly generate a second content key CK2 and a third content key CK3, encrypt the content key CK based on the second content key CK2, encrypt the second content key CK2 based on the third content key CK3, encrypt the content CNT based on the third content key CK3, and distribute the encrypted content ENCCNT, second content key CK2 and third content key CK3 to the output apparatuses 63a to 63n. It may generate content keys more than that.

(17) In the sixth embodiment, the number of output apparatuses is 14 (63a to 63n). However, the number of output apparatuses may be 15, or more or 13 or less.

(18) When the key issuing center 61 distributes the encrypted intermediate key group set ENCMKG, it may distribute it to the output apparatuses 63a to 63n at the same time or may distribute separately to each of the output apparatuses 63a to 63n. Note that, similarly when the server 62 distributes the time varying parameter group PRG and an encrypted content ENCCNT, the server 62 may distribute those to the output apparatus 63a to 63n at the same time or separately to each of the output apparatuses 63a to 63n.

(19) In the sixth embodiment, the server 62 encrypts the content CNT and generates an encrypted content ENCCNT based on the content key CK, and distributes the encrypted content ENCCNT to the output apparatuses 63a to 63n, and the output apparatuses 63a to 63n decrypts the encrypted content ENCCNT based on the content key CK and outputs the decrypted content DECCNT to the outside. However, while the server 62 does not distribute the encrypted content ENCCNT, the output apparatuses 63a to 63n may output the content key CK to the outside. Herein, the server 62 may output the content key CK to the outside.

(20) In the sixth embodiment, the server 62 transmits the time varying parameter group PRG to the output apparatuses 63a to 63n. However, the server 62 and the output apparatuses 63a to 63n may previously hold a plurality of sets of common time varying parameter group PRG and the time varying parameter group identifier, the server 62 may distribute one of the time varying parameter group identifiers to the output apparatuses 63a to 63n, and the output apparatuses 63a to 63n may obtain the corresponding time varying parameter group PRG based on the received time varying parameter group identifier.

(20) The present invention may be the methods described in the above. Also, the present invention may be a computer program causing a computer to execute those methods and a digital signal which composed of the computer program. Further, the present invention may be a recording medium which can read the computer program or the digital signal by a computer. For example, it may be recorded in a flexible disc, a hard disk, a CD-ROM, an MO, a DVD, a DVD-ROM, a DVD-RAM, a Blu-ray Disc (BD), a semiconductor memory and the like. Also, it may be the computer program or the digital signal stored in these recording mediums. Furthermore, the present invention may transmit the computer program or the digital signal via a network represented by a telecommunication line, wireless or wire communication line and the Internet. The present invention is a computer system having a microprocessor and a memory. The memory stores the computer program and the microprocessor may operate according to the computer program. Also, it may be implemented by another independent computer system by recording and transferring the program or the digital signal recorded in the recording medium.

(21) The embodiments and the variations may be combined to each other.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The content distribution system according to the present invention has an effect that, even if, by an attacker, an individual key of an output apparatus is illegally obtained and an unauthorized output apparatus is generated using the individual key, it can traces an origin of cloning the unauthorized output apparatus. It is effective for safely distributing contents using a communication network such as the Internet and a terrestrial broadcasting such as satellite broadcasting.

1. A content output apparatus which decrypts an encrypted content based on an intermediate key group that is made up of at least one intermediate key, and outputs the decrypted content, the content output apparatus being connected, via a network, to a content distribution server which encrypts a content and distributes the encrypted content, the apparatus comprising:
a content receiving unit operable to receive the encrypted content;
an intermediate key group storage unit operable to hold the intermediate key group that is a value given for each content output apparatus or for each model of the content output apparatus;
a time varying parameter group receiving unit operable to receive, via the network, a time varying parameter group that is made up of at least one time varying parameter previously shared with the content distribution server;
a content decryption key generation unit operable to generate a content decryption key based on the received time varying parameter group and the intermediate key group the content decryption key being a common value given for each content output apparatus; and
a content decryption unit operable to decrypt the encrypted content based on the content decryption key.

2. The content output apparatus according to claim 1, further comprising:
an individual key storage unit operable to hold an individual key which is previously given to each of content output apparatuses, each of which has functions included in the content output apparatus;
an encrypted intermediate key group set receiving unit operable to receive, via the network, an encrypted intermediate key group set including encrypted intermediate key groups, each being obtained by encrypting the intermediate key group; and
an intermediate key group decryption unit operable to decrypt, based on the individual key, one of the encrypted intermediate key groups in the encrypted intermediate key group set, and store the decrypted intermediate key group into the intermediate key group storage unit.

3. The content output apparatus according to claim 2,
wherein the encrypted intermediate key group set includes a first encrypted intermediate key group and a second encrypted intermediate key group, and
the intermediate key group decryption unit decrypts, based on the individual key, the first encrypted intermediate key group in the encrypted intermediate key group set, and obtains a first intermediate key.

4. The content output apparatus according to claim 3,
wherein the intermediate key group decryption unit obtains a second intermediate key from the first intermediate key based on the time varying parameter group received by the time varying parameter group receiving unit, and
the content decryption key generation unit, based on the second intermediate key, decrypts the second encrypted intermediate key group in the encrypted intermediate key group set, and generates the content decryption key.

5. The content output apparatus according to claim 4,
wherein the first intermediate key is a value unique to each of the content output apparatuses and models of the content output apparatuses, and
the second intermediate key is a value common to all of the content output apparatuses.

6. The content output apparatus according to claim 1, further comprising:
a time varying parameter group storage unit operable to hold the received time varying parameter group; and
an intermediate key group receiving unit operable to store the received intermediate key group into the intermediate key group storage unit via the network.

7. The content output apparatus according to claim 6,
wherein the content decryption key generation unit generates the content decryption key from the intermediate key group and the time varying parameter group according to at least one previously given content decryption key generation equation, and
the content decryption key generation equation includes at least one of an addition, a subtraction, a multiplication, and a division.

8. The content output apparatus according to claim 1,
wherein the time varying parameter group further includes an intermediate key group identifier for identifying one of the intermediate key groups, and
the content decryption key generation unit i) determines one intermediate key group from among the intermediate key groups based on the intermediate key group identifier, and further ii) generates the content decryption key based on the determined intermediate key group, the time varying parameter group and the content decryption key generation equation.

9. The content output apparatus according to claim 2,
wherein the encrypted intermediate key group set receiving unit obtains an encrypted table in which the encrypted intermediate key groups are described,
the intermediate key group decryption unit decrypts the encrypted table based on the individual key, and obtains a decrypted table in which the intermediate key groups are described, and
in the decrypted table, element identifiers for identifying elements and intermediate key groups are described, the elements constituting the decrypted table and the intermediate key groups being table elements respectively corresponding to the element identifiers.

10. The content output apparatus according to claim 9,
wherein the content decryption key generation unit selects an intermediate key group that is one of the table elements based on the corresponding element identifier, and generates the content decryption key based on the intermediate key group.

11. The content output apparatus according to claim 9,
wherein the element identifiers are time varying parameters and the table elements are intermediate key groups.

12. The content output apparatus according to claim 9,
wherein the intermediate key groups are made up of an intermediate key group common to all of the content output apparatuses and an intermediate key group unique to each of the content output apparatuses.

13. The content output apparatus according to claim 1,
wherein the content decryption key generation unit calculates the content decryption key using a shift register based on the intermediate key group and the time varying parameter group.

14. The content output apparatus according to claim 13,
wherein the content decryption key generation unit performs a left shift operation using the shift register.

15. The content output apparatus according to claim 14,
wherein the intermediate key group decryption unit performs the left shift operation using the time varying parameter group and the first intermediate key so as to obtain a second intermediate key, and
the content decryption key generation unit, based on the second intermediate key, decrypts one of the second encrypted intermediate key groups in the encrypted intermediate key group set and generates the content decryption key.

16. The content output apparatus according to claim 1,
wherein the time varying parameter group is made up of at least two time varying parameters, and
each of the time varying parameters is a random number value which varies according to every predetermined term or a value generated using time information.

17. The content output apparatus according to claim 1,
wherein the time varying parameter group is a value common to all of the content output apparatuses.

18. A content distribution server which encrypts a content so as to generate an encrypted content, and distributes, via a network, the encrypted content to content output apparatuses, each of which decrypts and outputs the encrypted content, the server comprising:
a system secret parameter group storage unit operable to hold a system secret parameter group made up of at least one previously given system secret parameter;
a time varying parameter generation unit operable to generate a time varying parameter group made up of at least one time varying parameter based on the system secret parameter group;
a time varying parameter group storage unit operable to hold the time varying parameter group;
a content encryption key generation unit operable to generate a content encryption key that is an intermediate key group based on the time varying parameter group and the system secret parameter group;
a content encryption unit operable to encrypt the content based on the content encryption key; and
a content distribution unit operable to distribute the encrypted content to the content output apparatuses.

19. The content distribution server according to claim 18, further comprising:
a time varying parameter group distribution unit operable to distribute the time varying parameter group to the content output apparatuses; and
a content encryption key distribution unit operable to distribute the content encryption key to the content output apparatuses.

20. The content distribution server according to claim 18,
wherein the system secret parameter group is made up of at least three or more said system secret parameters.

21. The content distribution server according to claim 18,
wherein the intermediate key group is made up of at least two or more intermediate keys generated based on the system secret parameter group and the time varying parameter group.

22. A key issuing center that is connected to content output apparatuses and a content distribution server via a network and issues an intermediate key group for decrypting an encrypted content by each of the content output apparatuses, said each of the content output apparatuses decrypting and outputting the encrypted content and the content distribution server distributing the encrypted content to the content output apparatuses, the key issuing center comprising:
a system secret parameter group generation unit operable to generate a system secret parameter group made up of at least one system secret parameter;
a system secret parameter group transmission unit operable to transmit the system secret parameter group to the content distribution server;
an intermediate key group generation unit operable to generate a plurality of the intermediate key groups based on the system secret parameter group;
an intermediate key group encryption unit operable to encrypt one of the intermediate key groups based on an individual key given to each of the content output apparatuses; and
an encrypted intermediate key group set distribution unit operable to distribute an encrypted intermediate key group set made up of the encrypted intermediate key groups.

23. The key issuing center according to claim 22,
wherein the system secret parameter group is made up of at least three or more said system secret parameters.

24. The key issuing center according to claim 22, further comprising:
an intermediate key group distribution unit operable to distribute one of the encrypted intermediate key groups in the encrypted intermediate key group set to the content output apparatuses;
a time varying parameter group generation unit operable to generate a time varying parameter group based on the system secret parameter group; and
a time varying parameter group distribution unit operable to distribute the time varying parameter group to the content distribution server and the content output apparatuses.

25. The key issuing center according to claim 22,
wherein the intermediate key group generation unit generates coefficients of a content decryption generation equation for decrypting the content as the intermediate key group.

26. A content distribution system comprising:
content output apparatuses, each of which decrypts an encrypted content based on an intermediate key group that is made up of at least one intermediate key, and outputs the decrypted content; and
a content distribution server which encrypts a content so as to generate the encrypted content, and distributes the encrypted content to the content output apparatuses,
wherein the content output apparatuses and the content distribution server are connected to each other via a network,
the content output apparatus includes:
a content receiving unit operable to receive the encrypted content;
an intermediate key group storage unit operable to hold the intermediate key group that is a value given for each content output apparatus or for each model of the content apparatus;
a time varying parameter group receiving unit operable to receive, via the network, a time varying parameter group that is made up of at least one time varying parameter previously shared with the content distribution server;
a content decryption key generation unit operable to generate a content decryption key based on the received time varying parameter group and the intermediate key group, the content decryption key being a common value given for each content output apparatus; and
a content decryption unit operable to decrypt the encrypted content based on the content decryption key, and
the content distribution server includes:
a system secret parameter group storage unit operable to hold a system secret parameter group made up of at least one previously given system secret parameter;
a time varying parameter generation unit operable to generate a time varying parameter group made up of at least one time varying parameter;
a time varying parameter group storage unit operable to hold the time varying parameter group;
a content encryption key generation unit operable to generate a content encryption key that is an intermediate key group based on the time varying parameter group and the system secret parameter group;
a content encryption unit operable to encrypt the content based on the content encryption key; and
a content distribution unit operable to distribute the encrypted content to the content output apparatuses.

27. A program used for a plurality of content output apparatuses, each of which decrypts an encrypted content based on an intermediate key group that is made up of at least one intermediate key, and outputs the decrypted content, the content output apparatuses being connected, via a network, to a content distribution server which distributes the encrypted content, the program comprising:
receiving the encrypted content;
storing the intermediate key group that is a value given for each content output apparatus or for each model of the content output apparatus;
receiving, via the network, a time varying parameter group that is made up of at least one time varying parameter previously shared with the content distribution server;
generating a content decryption key based on the received time varying parameter group and the intermediate key group the content decryption key being a common value given for each content output apparatus; and
decrypting the encrypted content based on the content decryption key.

28. A program used for a content distribution server which encrypts a content so as to generate an encrypted content and distributes, via a network, the encrypted content to content output apparatuses, each of which decrypts and outputs the encrypted content, the program including:
storing a system secret parameter group that is made up of at least one previously given system secret parameter;
generating a time varying parameter group that is made up of at least one previously given time varying parameter;
storing the time varying parameter group;
generating a content encryption key that is an intermediate key group based on the time varying parameter group and the system secret parameter group;
encrypting the content based on the content encryption key; and
distributing the encrypted content to the content output apparatuses.

29. A program used for a key issuing center which is connected to content output apparatuses and a content distribution server via a network, and issues an intermediate key group for decrypting an encrypted content by each of the content output apparatuses, the program comprising:
generating a system secret parameter group made up of at least one system secret parameter;
transmitting the system secret parameter group to the content distribution server;
generating a plurality of the intermediate key groups based on the system secret parameter group;
encrypting one of the plurality of the intermediate key groups based on an individual key given to each of the content output apparatuses so as to generate a plurality of encrypted intermediate key groups; and
distributing, to the content output apparatuses, an encrypted intermediate key group set that is made up of a plurality of the encrypted intermediate key groups.

30. A computer readable recording medium on which a program according to claim 27 is recorded.

31. A content distribution method used for a plurality of content output apparatuses, each of which decrypts an encrypted content based on an intermediate key group that is made up of one or more intermediate keys and outputs the decrypted content, the content output apparatuses being connected, via a network, to a content distribution server which distributes the encrypted content, the method comprising:
receiving the encrypted content;
holding the intermediate key group that is a value given for each content output apparatus or for each model of the content output apparatus;
receiving the time varying parameter group that is made up of at least one time varying parameter shared previously with the server via the network;
generating a content decryption key based on the received time varying parameter group and the intermediate key group the content decryption key being a common value given for each content output apparatus; and
decrypting the encrypted content based on the content decryption key.

32. A content distribution method used for a content distribution server which encrypts a content so as to generate an encrypted content, and distributes, via a network, the encrypted content to content output apparatuses, each of which decrypts and outputs the encrypted content, the method comprising:
holding a system secret parameter group made up of at least one previously given system secret parameter;
generating a time varying parameter group made up of at least one previously given time varying parameter;
holding the time varying parameter group;
generating a content encryption key that is an intermediate key group based on the time varying parameter group and the system secret parameter group;
encrypting the content based on the content encryption key; and
distributing the encrypted content to the content output apparatuses.

33. A content distribution method used for a key issuing center which is connected to content output apparatuses and a content distribution server via a network, and issues an intermediate key group for decrypting an encrypted content by each of the content output apparatuses, the method comprising:
generating a system secret parameter group made up of at least one system secret parameter;
transmitting the system secret parameter group to the content distribution server;
generating a plurality of the intermediate key groups based on the system secret parameter group;
encrypting one of the plurality of the intermediate key groups based on an individual key given to each of the content output apparatuses; and
distributing an encrypted intermediate key group set that is made up of a plurality of the encrypted intermediate key groups to the content output apparatuses.

34. A computer readable recording medium on which a program according to claim 28 is recorded.

35. A computer readable recording medium on which a program according to claim 29 is recorded.
